(19) United States
(12) Patent Application Publication
(10) Pub. No.: US 2018/0276843 A1
(43) Pub. Date: Sep. 27, 2018

(54) OPTICAL DETECTOR

(71) Applicant: BASF SE, Ludwigshafen (DE)

(72) Inventors: Robert SEND, Karlsruhe (DE); Ingmar BRUDER, Neuleiningen (DE); Sebastian VALOUCH, Lampertheim (DE); Stephan IRLE, Siegen (DE); Erwin THIEL, Siegen (DE); Christoph LUNGENSCHMIED, Mannheim (DE); Mustapha AL HELWI, Mannheim (DE)

(73) Assignee: BASF SE, Ludwigshafen (DE)

(21) Appl. No.: 15/534,294

(22) PCT Filed: Dec. 7, 2015
(86) PCT No.: PCT/IB2015/059403

§ 371 Date: Jun. 8, 2017

(30) Foreign Application Priority Data
Dec. 9, 2014 (EP) 14196939.4

(51) Int. Cl. G06T 7/70; G01C 3/08; H04N 5/225; H04N 5/232; A63F 13/213

(52) U.S. Cl. CPC G06T 7/70; G01C 3/08; A63F 13/213; H04N 5/23212; H04N 5/2256

(57) ABSTRACT

An optical detector (110) is disclosed, comprising:
at least one optical sensor (122) adapted to detect a light beam (120) and to generate at least one sensor signal, wherein the optical sensor (122) has at least one sensor region (126), wherein the sensor signal of the optical sensor (122) is dependent on an illumination of the sensor region (126) by the light beam (120), wherein the sensor signal, given the same total power of the illumination, is dependent on a width of the light beam (120) in the sensor region (126);
at least one focus-tunable lens (128) located in at least one beam path (130) of the light beam (120), the focus-tunable lens (128) being adapted to modify a focal position of the light beam (120) in a controlled fashion;
at least one focus-modulation device (136) adapted to provide at least one focus-modulating signal (138) to the focus-tunable lens (128), thereby modulating the focal position;
at least one imaging device (140) being adapted to record an image; and
at least one evaluation device (142), the evaluation device (142) being adapted to evaluate the sensor signal and, depending on the sensor signal, to effect a recording of the image by the imaging device (140).

The present invention is based on the general ideas on optical detectors as set forth e.g. In WO 2012/110924 A1, US 2012/0206336 A1, WO 2014/097181 A1, US 2014/0291480 A1 or so far unpublished U.S. provisional applications No. 61/867,180 dated Aug. 19, 2013, 61/906,430 dated Nov. 20, 2013, and 61/914,402 dated Dec. 11, 2013, as well as unpublished German patent application number 10 2014 006 279.1 dated Mar. 6, 2014, European patent application number 14171759.5 dated Jun. 10, 2014, international patent application number PCT/EP2014/067466 dated Aug. 15, 2014 and U.S. patent application Ser. No. 14/460,540 dated Aug. 15, 2014, the full content of all of which is herewith included by reference.

### FIELD OF THE INVENTION

The invention relates to an optical detector, a detector system and a method of optical detection, specifically for determining a position of at least one object. The invention further relates to a human-machine interface for exchanging at least one item of information between a user and a machine, an entertainment device, a tracking system, a camera and various uses of the optical detector. The devices, systems, methods and uses according to the present invention specifically may be employed, for example, in various areas of daily life, gaming, traffic technology, production technology, security technology, photography such as digital photography or video photography for arts, documentation or technical purposes, medical technology or in the sciences. Additionally or alternatively, the application may be applied in the field of mapping of spaces, such as for generating maps of one or more rooms, one or more buildings or one or more streets. However, other applications are also possible.

### Prior Art

A large number of optical detectors, optical sensors and photovoltaic devices are known from the prior art. While photovoltaic devices are generally used to convert electromagnetic radiation, for example, ultraviolet, visible or infra-red light, into electrical signals or electrical energy, optical detectors are generally used for picking up image information and/or for detecting at least one optical parameter, for example, a brightness.

A large number of optical sensors which can be based generally on the use of inorganic and/or organic sensor materials are known from the prior art. Examples of such sensors are disclosed in US 2007/0176165 A1, U.S. Pat. No. 6,995,445 B2, DE 2501124 A1, DE 3225372 A1 or else in numerous other prior art documents. To an increasing extent, in particular for cost reasons and for reasons of large-area processing, sensors comprising at least one organic sensor material are being used, as described for example in US 2007/0176165 A1. In particular, so-called dye solar cells are increasingly of importance here, which are described generally, for example in WO 2009/013282 A1.

As a further example, WO 20131144177 A1 discloses quinolinium dyes having a fluorinated counter anion, an electrode layer which comprises a porous film made of oxide semiconductor fine particles sensitized with these kinds of quinolinium dyes having a fluorinated counter anion, a photoelectric conversion device which comprises such a kind of electrode layer, and a dye sensitized solar cell which comprises such a photoelectric conversion device.

A large number of detectors for detecting at least one object are known on the basis of such optical sensors. Such detectors can be embodied in diverse ways, depending on the respective purpose of use. Examples of such detectors are imaging devices, for example, cameras and/or microscopes. High-resolution confocal microscopes are known, for example, which can be used in particular in the field of medical technology and biology in order to examine biological samples with high optical resolution. Further examples of detectors for optically detecting at least one object are distance measuring devices based, for example, on propagation time methods of corresponding optical signals, for example laser pulses. Further examples of detectors for optically detecting objects are triangulation systems, by means of which distance measurements can likewise be carried out.

In US 2007/0080925 A1, a low power consumption display device is disclosed. Therein, photoactive layers are utilized that both respond to electrical energy to allow a display device to display information and that generate electrical energy in response to incident radiation. Display pixels of a single display device may be divided into displaying and generating pixels. The displaying pixels may display information and the generating pixels may generate electrical energy. The generated electrical energy may be used to provide power to drive an image.

In EP 1 667 246 A1, a sensor element capable of sensing more than one spectral band of electromagnetic radiation with the same spatial location is disclosed. The element consists of a stack of sub-elements each capable of sensing different spectral bands of electromagnetic radiation. The sub-elements each contain a non-silicon semiconductor where the non-silicon semiconductor in each sub-element is sensitive to and/or has been sensitized to be sensitive to different spectral bands of electromagnetic radiation.

In WO 2012/110924 A1 and US 2012/0206336 A1, the full content of which is herewith included by reference, a detector for optically detecting at least one object is proposed. The detector comprises at least one optical sensor. The optical sensor has at least one sensor region. The optical sensor is designed to generate at least one sensor signal in a manner dependent on an illumination of the sensor region. The sensor signal, given the same total power of the illumination, is dependent on a geometry of the illumination, in particular on a beam cross section of the illumination on the sensor area. The detector, furthermore, has at least one evaluation device. The evaluation device is designed to generate at least one item of geometrical information from the sensor signal, in particular at least one item of geometrical information about the illumination and/or the object.

US 2014/0291480 A1 and WO 2014/097181 A1, the full content of all of which is herewith included by reference, disclose a method and a detector for determining a position of at least one object, by using at least one longitudinal optical sensor and at least one transversal optical sensor. Specifically, the use of sensor stacks is disclosed, in order to determine a longitudinal position of the object with a high degree of accuracy and without ambiguity.

European patent application number EP 13171898.3, filed on Jun. 13, 2013, and international patent application number PCT/EP2014/061688, filed on Jun. 5, 2014, the full content of which is herewith included by reference, disclose an optical detector comprising an optical sensor having a substrate and at least one photosensitive layer setup disposed thereon. The photosensitive layer setup has at least one first electrode, at least one second electrode and at least one photovoltaic material sandwiched in between the first electrode and the second electrode. The photovoltaic material comprises at least one organic material. The first electrode comprises a plurality of first electrode stripes, and the second electrode comprises a plurality of second electrode stripes, wherein the first electrode stripes and the second electrode stripes intersect in such a way that a matrix of pixels is formed at intersections of the first electrode stripes and the second electrode stripes. The optical detector further comprises at least one readout device, the readout device comprising a plurality of electrical measurement devices being connected to the second electrode stripes and a switching device for subsequently connecting the first electrode stripes to the electrical measurement devices.

European patent application number EP 13171900.7, also filed on Jun. 13, 2013, and international patent application number PCT/EP2014/061691, filed on Jun. 5, 2014, the full content of which is herewith also included by reference, discloses a detector device for determining an orientation of at least one object, comprising at least two beacon devices being adapted to be at least one of attached to the object, held by the object and integrated into the object, the beacon devices each being adapted to direct light beams towards a detector, and the beacon devices having predetermined coordinates in a coordinate system of the object. The detector device further comprises at least one detector adapted to detect the light beams traveling from the beacon devices towards the detector and at least one evaluation device, the evaluation device being adapted to determine longitudinal coordinates of each of the beacon devices in a coordinate system of the detector. The evaluation device is further adapted to determine an orientation of the object in the coordinate system of the detector by using the longitudinal coordinates of the beacon devices.

European patent application number EP 13171901.5, filed on Jun. 13, 2013, and international patent application number PCT/EP2014/061695, filed on Jun. 5, 2014, the full content of all of which is herewith included by reference, discloses a detector for determining a position of at least one object. The detector comprises at least one optical sensor being adapted to detect a light beam traveling from the object ards the detector, the optical sensor having at least one matrix of pixels. The detector further comprises at least one evaluation device, the evaluation device being adapted to determine a number N of pixels of the optical sensor which are illuminated by the light beam. The evaluation device is further adapted to determine at least one longitudinal coordinate of the object by using the number N of pixels which are illuminated by the light beam.

Despite the advantages implied by the above-mentioned devices and detectors, specifically by the detectors disclosed in WO 2012/110924 A1, U.S. 61/739,173, U.S. 61/749,964, EP 13171898.3, EP 13171900.7, EP 13171901.5, PCT/EP2014/067466 and U.S. Ser. No. 14/460,540, several technical challenges remain. Thus, generally, a need exists for detectors for detecting a position of an object in space which is both reliable and may be manufactured at low cost. Specifically, a strong need exists for detectors having a high resolution, in order to generate images and/or information regarding a position of an object, which may be realized at high volume and at low cost and which, still, provide a high resolution and image quality.

### Problem to be Solved

It is, therefore, an object of the present invention to provide devices and methods facing the above-mentioned technical challenges of known devices and methods. Specifically, it is an object of the present invention to provide devices and methods which reliably may determine a position of an object in space, preferably at a low technical effort and with low requirements in terms of technical resources and cost. More specifically, it is a further object of the present invention to provide devices and methods which may allow recording an image of a number of objects, wherein all objects in the image are in focus.

### SUMMARY OF THE INVENTION

This problem is solved by an optical detector, a detector system, a method of optical detection, a human-machine interface, an entertainment device, a tracking system, a camera and various uses of the optical detector, with the features of the independent claims. Preferred embodiments which might be realized in an isolated fashion or in any arbitrary combination are listed in the dependent claims.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restriction regarding the scope of the invention and without any restriction regarding the possibility of combining the features introduced in such a way with other optional or non-optional features of the invention.

In a first aspect of the present invention, an optical detector is disclosed. The optical detector comprises:
at least one optical sensor adapted to detect a light beam and to generate at least one sensor signal, wherein the optical sensor has at least one sensor region, wherein the sensor signal of the optical sensor is dependent on an illumination of the sensor region by the light beam, wherein the sensor signal, given the same total power of the illumination, is dependent on a width of the light beam in the sensor region;
at least one focus-tunable lens located in at least one beam path of the light beam, the focus-tunable lens being adapted to modify a focal position of the light beam in a controlled fashion;
at least one focus-modulation device adapted to provide at feast one focus-modulating signal to the focus-tunable lens, thereby modulating the focal position;
at least one imaging device being adapted to record an image; and
at least one evaluation device, the evaluation device being adapted to evaluate the sensor signal and, depending on the sensor signal, to effect a recording of the image by the imaging device.

As used herein, an “optical detector” or, in the following, simply referred to as a “detector”, generally refers to a device which is capable of generating at least one detector signal and/or at least one image, in response to an illumination by one or more light sources and/or in response to optical properties of a surrounding of the detector. Thus, the detector may be an arbitrary device adapted for performing at least one of an optical measurement and imaging process.

Specifically, as will be outlined in further detail below, the optical detector may be a detector for determining a position of at least one object. As used herein, the term “position” generally refers to at least one item of information regarding a location and/or orientation of the object and/or at least one part of the object in space. Thus, the at least one item of information may imply at least one distance between at least one point of the object and the at least one detector. As will be outlined in further detail below, the distance may be a longitudinal coordinate or may contribute to determining a longitudinal coordinate of the point of the object. Additionally or alternatively, one or more other items of information regarding the location and/or orientation of the object and/or at least one part of the object may be determined. As an example, at least one transversal coordinate of the object and/or at least one part of the object may be determined. Thus, the position of the object may imply at least one longitudinal coordinate of the object and/or at least one part of the object. Additionally or alternatively, the position of the object may imply at least one transversal coordinate of the object and/or at least one part of the object. Additionally or alternatively, the position of the object may imply at least one orientation information of the object, indicating an orientation of the object in space.

As used herein, a “light beam” generally is an amount of light traveling in more or less the same direction. Specifically, the light beam may be or may comprise a bundle of light rays and/or a common wave front of light. Thus, preferably, a light beam may refer to a Gaussian light beam, as known to the skilled person. However, other light beams, such as non-Gaussian light beams, are possible. As outlined in further detail below, the light beam may be emitted and/or reflected by an object. Further, the light beam may be reflected and/or emitted by at least one beacon device which preferably may be one or more of attached or integrated into an object.

Further, whenever the present invention refers to “detecting a light beam”, “detecting a traveling light beam” or similar expressions, these terms generally refer to the process of detecting an arbitrary interaction of the light beam with the optical detector, a part of the optical detector or any other part. Thus, as an example, the optical detector and/or the optical sensor may be adapted for detecting a light spot generated by the light beam on an arbitrary surface, such as in a sensor region of the optical sensor.

As further used herein, the term “optical sensor” generally refers to a light-sensitive device for detecting a light beam and/or a portion thereof, such as for detecting an illumination and/or a light spot generated by a light beam. The optical sensor, in conjunction with the evaluation device, may be adapted, as outlined in further detail below, to determine at least one longitudinal coordinate of the object and/or of at least one part of the object, such as at least one part of the object from which the at feast one light beam travels towards the detector.

Thus, generally, the at least one optical sensor as mentioned above, being part of the optical detector, may also be referred to as at least one “longitudinal optical sensor”, as opposed to the at least one optional transversal optical sensor mentioned in further detail below, since the optical sensor generally may be adapted to determine at least one longitudinal coordinate of the object and/or of at least one part of the object. Still, in case one or more transversal optical sensors are provided, the at least one optional transversal optical sensor may fully or partially be integrated into the at least one longitudinal optical sensor or might fully or partially be embodied as a separate transversal optical sensor.

The optical detector may comprise one or more optical sensors. In case a plurality of optical sensors is comprised, the optical sensors may be identical or may be different in a manner that at least two different types of optical sensors may be comprised. As outlined in further detail below, the at least one optical sensor may comprise at least one of an inorganic optical sensor and an organic optical sensor. As used herein, an organic optical sensor generally refers to an optical sensor having at least one organic material included therein, preferably at least one organic photosensitive material. Further, optical sensors may be used including both inorganic and organic materials.

The at least one optical sensor specifically may be or may comprise at least one longitudinal optical sensor. Additionally, as outlined above and as outlined in further detail below, one or more transversal optical sensors may be part of the optical detector. For potential definitions of the terms “longitudinal optical sensor” and “transversal optical sensor”, as well as for potential embodiments of these sensors, reference may be made, as an example, to the at least one longitudinal optical sensor and/or to the at least one transversal optical sensor as shown in WO2014/097181 A1. Other setups are feasible.

The at least one optical sensor preferably contains at least one longitudinal optical sensor, i.e. an optical sensor which is adapted to determine a longitudinal position of at least one object, such as at least one z-coordinate of an object.

Preferably, the optical sensor or, in case a plurality of optical sensors is provided, at least one of the optical sensors may have a setup and/or may provide the functions of the optical sensor as disclosed in WO 2012/110924 A1 or US 2012/0206336 A1 and/or as disclosed in the context of the at least one longitudinal optical sensor disclosed in WO 2014/097181 A1 or US 2014/0291480 A1.

The at least one optical sensor and/or, in case a plurality of optical sensors is provided, one or more of the optical sensors have at least one sensor region, wherein the sensor signal of the optical sensor is dependent on an illumination of the sensor region by the light beam, wherein the sensor signal, given the same total power of the illumination, is dependent on a geometry, specifically a width, of the light beam in the sensor region. In the following, this effect generally will be referred to as the FiP-effect, since, given the same total power p of illumination, the sensor signal i is dependent on a flux F of photons, i.e. the number of photons per unit area. The evaluation device is adapted to evaluate the sensor signal, preferably to determine the width by evaluating the sensor signal.

Additionally, one or more other types of longitudinal optical sensors may be used. Thus, in the following, in case reference is made to a FiP sensor, it shall be noted that, generally, other types of longitudinal optical sensors may be used instead. Still, due to the superior properties and due to the advantages of FiP sensors, the use of at least one FiP sensor is preferred.

The FiP-effect, which is further disclosed in one or more of WO 2012/110924 A1, US 2012/0206336 A1, WO 2014/097181 A1 or US 2014/0291480 A1, specifically may be used for determining a longitudinal position of an object from which the light beam travels or propagates towards the detector. Thus, since the beam with the light beam on the sensor region, which preferably may be a non-pixelated sensor region, depends on a width, such as a diameter or radius, of the light beam which again depends on a distance between the detector and the object, the sensor signal may be used for determining a longitudinal coordinate of the object. Thus, as an example, the evaluation device may be adapted to use a predetermined relationship between a longitudinal coordinate of the object and a sensor signal in order to determine the longitudinal coordinate. The predetermined relationship may be derived by using empiric calibration measurements and/or by using known beam propagation properties, such as Gaussian beam propagation properties. For further details, reference may be made to one or more of WO 2012/110924 A1 or US 2012/0206336 A1, or the longitudinal optical sensor as disclosed in WO 2014/097181 A1 or US 2014/0291480 A1. Specifically, a simple calibration method may be performed, wherein an object emitting and/or reflecting a light beam towards the optical detector is placed, sequentially, in different longitudinal positions along a z-axis, thereby providing different spatial separations between the optical detector and the object, and a sensor signal of the optical sensor is registered for each measurement, thereby determining a unique relationship between the sensor signal and the longitudinal position of the object or a part thereof.

Preferably, in case a plurality of optical sensors is provided, such as a stack of optical sensors, at least two of the optical sensors may be adapted to provide the FiP-effect. Specifically, one or more optical sensors may be provided which exhibit the FiP-effect, wherein, preferably, the optical sensors exhibiting the FiP-effect are large-area optical sensors having a uniform sensor surface rather than being pixelated optical sensors.

Thus, by evaluating signals from optical sensors which subsequently are illuminated by the light beam, such as subsequent optical sensors of a sensor stack, and by using the above-mentioned FiP-effect, ambiguities in a beam profile may be resolved as specifically disclosed in WO 2014/097181 A1 or US 2014/0291480 A1. Thus, Gaussian light beams may provide the same beam width at a distance z before and after a focal point. By measuring the beam width along at least two positions, this ambiguity may be resolved, by determining whether the light beam is still narrowing or widening. Thus, by providing two or more optical sensors having the FiP-effect, a higher accuracy may be provided. The evaluation device may be adapted to determine the widths of the light beam in the sensor regions of the at least two optical sensors, and the evaluation device may further be adapted to generate at least one item of information on a longitudinal position of an object from which the light beam propagates towards the optical detector, by evaluating the widths.

Specifically in case the at least one optical sensor or one or more of the optical sensors provide the above-mentioned FiP-effect, the sensor signal of the optical sensor may be dependent on a modulation frequency of the light beam. As an example, the FiP-effect may function as modulation frequencies of 0.1 Hz to 10 kHz. Thus, as will be outlined in further detail below, the optical detector may further comprise at least one modulation device adapted for amplitude modulation of the light beam and/or for any other type of modulation of at least one optical property of the light beam. Thus, the modulation device may be identical to one or more of a focus-tunable lens or a focus-modulation device which are mentioned below. Additionally or alternatively, at least one additional modulation device may be provided, such as a chopper, a modulated light source or other types of modulation devices adapted for modulating an intensity of the light beam. Additionally or alternatively, an additional modulation may be provided, such as by using one or more illumination sources being adapted to emit the light beam in a modulated way.

In case a plurality of modulations is used, such as a first modulation by the modulation device and a second modulation by the focus-tunable lens, or any arbitrary combination of these two modulations, the modulations may be performed in the same frequency range or in different frequency ranges. Thus, as an example, the modulation by the focus-tunable lens may be in a first frequency range, such as in a range of 0.1 Hz to 100 Hz, whereas, additionally, the light beam itself may optionally additionally be modulated by at least one second modulation frequency, such as a frequency in a second frequency range of 100 Hz to 10 kHz, such as by the optional additional at least one modulation device Further, in case one or more modulated light sources and/or illumination sources are used, such as one or more illumination sources integrated into one or more beacon devices, these illumination sources may be modulated at different modulation frequencies, in order to distinguish between light originating from the different illumination sources. Thus, for example, more than one modulation may be used, wherein at least one first modulation generated by the focus-tunable lens is used, and a second modulation by the illumination source. By performing a frequency analysis, these different modulations may be separated.

As outlined above, the FiP-effect may be enabled and/or enhanced by an appropriate modulation. An optimal modulation may easily be identified by experiment, such as by using light beams having different modulation frequencies and by choosing a frequency having a sensor signal being easily measurable, such as an optimum sensor signal. For further details of different purposes of modulations, reference may be made to international patent application number PCT/EP2014/061691 filed on Jun. 5, 2014.

Various types of optical sensors exhibiting the above-mentioned FiP effect may be chosen. In order to determine whether an optical sensor exhibits the above-mentioned HP effect, a simple experiment may be performed in which a light beam is directed onto the optical sensor, thereby generating a light spot, and wherein the size of the light spot is changed, recording the sensor signal generated by the optical sensor. This sensor signal may be dependent on a modulation of the light beam, such as by a modulator, a modulation device or a modulating device, like e.g. by a chopper wheel, a shutter wheel, an electro-optical modulation device, and acousto-optical modulation device or the like. Specifically, the sensor signal may be dependent on a modulation frequency of the light beam. In case the sensor signal, given the same total power of the illumination, is dependent on the size of the light spot, i.e. on the width of the light beam in the sensor region, the optical sensor is suited to be used as a FiP effect optical sensor.

Specifically, this FiP effect may be observed in photo detectors, such as solar cells, more preferably in organic photodetectors, such as organic semiconductor detectors. Thus, the at least one optical sensor or, in case a plurality of optical sensors is provided, one or more of the optical sensors preferably may be or may comprise at least one organic semiconductor detector and/or at least one inorganic semiconductor detector. Thus, generally, the optical detector may comprise at least one semiconductor detector. Most preferably, the semiconductor detector or at least one of the semiconductor detectors may be an organic semiconductor detector comprising at least one organic material. Thus, as used herein, an organic semiconductor detector is an optical detector comprising at least one organic material, such as an organic dye and/or an organic semiconductor material. Besides the at least one organic material, one or more further materials may be comprised, which may be selected from organic materials or inorganic materials. Thus, the organic semiconductor detector may be designed as an all-organic semiconductor detector comprising organic materials only, or as a hybrid detector comprising one or more organic materials and one or more inorganic materials. Still, other embodiments are feasible. Thus, combinations of one or more organic semiconductor detectors and/or one or more inorganic semiconductor detectors are feasible.

As an example, the semiconductor detector may be selected from the group consisting of an organic solar cell, a dye solar cell, a dye-sensitized solar cell, a solid dye solar cell, a solid dye-sensitized solar cell. As an example, specifically in case one or more of the optical sensors provide the above-mentioned FiP-effect, the at least one optical sensor or, in case a plurality of optical sensors is provided, one or more of the optical sensors, may be or may comprise a dye-sensitized solar cell (DSC), preferably a solid dye-sensitized solar cell (sDSC). As used herein, a DSC generally refers to a setup having at least two electrodes, wherein at least one of the electrodes is at least partially transparent, wherein at least one n-semiconducting metal oxide, at feast one dye and at least one electrolyte or p-semiconducting material is embedded in between the electrodes. In an sDSC, the electrolyte or p-semiconducting material is a solid material. Generally, for potential setups of sDSCs which may also be used for one or more of the optical sensors within the present invention, reference may be made to one or more of WO 2012/110924 A1, US 2012/0206336 A1, WO 2014/097181 A1 or US 2014/0291480 A1. The above-mentioned FiP-effect, as demonstrated e.g. In WO 2012/110924 A1, specifically may be present in sDSCs. Still, other embodiments are feasible.

Thus, generally, the at least one optical sensor may comprise at least one optical sensor having a layer setup comprising at least one first electrode, at least one n-semiconducting metal oxide, at least one dye, at least one p-semiconducting organic material, preferably a solid p-semiconducting organic material, and at least one second electrode. As outlined above, at least one of the first electrode and the second electrode may be transparent. Most preferably, specifically in case a transparent optical sensor shall be provided, both the first electrode and the second electrode may be transparent.

As outlined above, the optical detector further comprises at least one focus-tunable lens located in at least one beam path of the light beam. Preferably, the at least one focus-tunable lens, which may also be denominated as a flexible lens, is located in the beam path before the at least one optical sensor or, in case a plurality of optical sensors is provided, before at least one of the optical sensors, such that the light beam, before attaining the at least one optical sensor, passes the at least one focus-tunable lens or, in case a plurality of focus-tunable lenses is provided, at least one of the focus tunable lenses.

As used herein, the term “focus-tunable lens” generally refers to an optical element being adapted to modify a focal position of a light beam passing the focus-tunable lens in a controlled fashion. The focus-tunable lens may be or may comprise one or more lens elements such as one or more lenses and/or one or more curved mirrors, with an adjustable or tunable focal length. The one or more lenses, as an example, may comprise one or more of a biconvex lens, a biconcave lens, a plano-convex lens, a plano-concave lens, a convex-concave lens, or a concave-convex lens. The one or more curved mirrors may be or may comprise one or more of a concave mirror, a convex mirror, or any other type of mirror having one or more curved reflective surfaces. Any arbitrary combination thereof is generally feasible, as the skilled person will recognize. Therein, a “focal position” generally refers to a position at which the light beam has the narrowest width. Still, the term “focal position” generally may refer to other beam parameters, such as a divergence, a Raleigh length or the like, as will be obvious to the person skilled in the art of optical design point thus, as an example, the focus-tunable lens may be or may comprise at least one lens, the focal length of which may be changed or modified in a controlled fashion, such as by an external influence light, a control signal, a voltage or a current. The change in focal position may also be achieved by an optical element comprising a switchable refractive index which, by itself, is not a focusing device but may, nevertheless, change the focal point of a fixed focus lens when placed into the light beam. As further used in this context, the term “in a controlled fashion” generally refers to the fact that the modification takes place due to an influence which may be exerted onto the focus-tunable lens, such that the actual focal position of the light beam passing the focus-tunable lens and/or the focal length of the focus-tunable lens may be adjusted to one or more desired values by exerting an external influence on to the focus-tunable lens, such as by applying a control signal to the focus-tunable lens, such as one or more of a digital control signal, an analog control signal, a control voltage or a control current. Specifically, the focus-tunable lens may be or may comprise a lens element such as a lens or a curved mirror, the focal length of which may be adjusted by applying an appropriate control signal, such as an electrical control signal.

Examples of focus-tunable lenses are widely known in the literature and are commercially available. As an example, reference may be made to the tunable lenses, preferably the electrically tunable lenses, as available by Optotune AG, CH-8953 Dietikon, Switzerland, which may be employed in the context of the present invention. Further, focus tunable lenses as commercially available from Varioptic, 69007 Lyon, France, may be used. Further reference may be made to N. Nguyen, Micro-optofluidic Lenses: A review, Biomicrofluidics, 4, p. 031501, 2010, or to Uriel Levy, and Romi Shamai, Tunable optoffuldic devices, Microfluid Nanofluid, 4, p. 97, 2008.

Various principles of focus-tunable lenses are known in the art and may be used within the present invention. Thus, firstly, the focus-tunable lens may comprise at least one transparent shapeable material, preferably a shapeable material which may change its shape and, thus, may change its optical properties and/or optical interfaces due to an external influence, such as a mechanical influence and/or an electrical influence. An actuator exerting the influence may specifically be part of the focus-tunable lens. Additionally or alternatively, the focus tunable lens may have one or more ports for providing at least one control signal to the focus tunable lens, such as one or more electrical ports. The shapeable material may specifically be selected from the group consisting of a transparent liquid and a transparent organic material, preferably a polymer, more preferably an electro-active polymer. Still, combinations are possible. Thus, as an example, the shapeable material may comprise two different types of liquids, such as a hydrophilic liquid and a lipophilic liquid. Other types of materials are feasible.

The focus-tunable lens may further comprise at least one actuator for shaping at least one interface of the shapeable material. The actuator specifically may be selected from the group consisting of a liquid actuator for controlling an amount of liquid in a lens zone of the focus-tunable lens or an electrical actuator adapted for electrically changing the shape of the interface of the shapeable material.

One embodiment of focus-tunable lenses are electrostatic focus-tunable lenses. Thus, the focus-tunable lens may comprise at least one liquid and at least two electrodes, wherein the shape of at least one interface of the liquid is changeable by applying one or both of a voltage or a current to the electrodes, preferably by electro-wetting. Additionally or alternatively, the focus tunable lens may be based on a use of one or more electroactive polymers, the shape of which may be changed by applying a voltage and/or an electric field.

As will be outlined in further detail below, one focus-tunable lens or a plurality of focus-tunable lenses may be used. Thus, the focus-tunable lens may be or may comprise a single lens element or a plurality of single lens elements. Additionally or alternatively, a plurality of lens elements may be used which are interconnected, such as in one or more modules, each module having a plurality of focus-tunable lenses. Thus, as will be outlined in further detail below, the at least one focus-tunable lens may be or may comprise at least one lens array, such as a micro-lens array, such as disclosed in C. U. Murade et al., Optics Express, Vol. 20, No. 16, 18180-18187 (2012). Other embodiments are feasible.

The tuning of the focus-tunable lens I accomplished by applying at least one focus-modulation device being adapted to provide at least one focus-modulating signal to the focus-tunable lens, thereby modulating the focal position. As used herein, the term “focus-modulation device” generally refers to an arbitrary device adapted for providing at least one focus-modulating signal to the focus-tunable lens. Specifically, the focus-modulation device may be adapted to provide at least one control signal to the focus-tunable lens, such as at least one electrical control signal, such as a digital control signal and/or an analogue control signal, such as a voltage and/or a current, wherein the focus-tunable lens is adapted to modify the focal position of the light beam and/or to adapt its focal length in accordance with the control signal. Thus, as an example, the focus-modulation device may comprise at least one signal generator adapted for providing the control signal. As an example, the focus-modulation device may be or may comprise a signal generator and/or an oscillator adapted to generate an electronic signal, more preferably a periodic electronic signal, such as a sinusoidal signal, a square signal or a triangular signal, more preferably a sinusoidal or triangular voltage and/or a sinusoidal or a triangular current. Thus, as an example, the focus-modulation device may be or may comprise an electronic signal generator and/or an electronic circuit is adapted to provide at least one electronic signal. The signal may further be a linear combination of sinusoidal functions, such as a squared sinusoidal function, or a sin(t²) function. Additionally or alternatively, the focus modulation device may be or may comprise at least one processing device, such as at least one processor and/or at least one integrated circuit, adapted to provide at least one control signal, such as a periodic control signal.

Consequently, the term “focus-modulating signal”, as used herein, generally refers to a control signal which is adapted to be read by the focus-tunable lens, and wherein the focus-tunable lens is adapted to adjust at least one focal position of the light beam and/or at least one focal length in accordance with the focus-modulating signal. For potential embodiments of the focus-modulating signal, reference may be made to the above-mentioned embodiments of the control signal, since the control signal may also be referred to as the focus-modulating signal.

The focus-modulation device may fully or partially be embodied as a separate device, separate from the at least one focus-tunable lens. Additionally or alternatively, the focus-modulation device may also fully or partially be embodied as a part of the at least one focus-tunable lens, such as by fully or partially integrating the at least one focus-modulation device into the at least one focus-tunable lens.

The focus-modulation device may, additionally or alternatively, be fully or partially integrated into the at least one evaluation device described in further detail below, such as by integrating those elements into one and the same computer and/or processor. Additionally or alternatively, the at least one focus-modulation device may, as well, be connected to the at least one evaluation device, such as by using at least one wireless or wire-bound connection. Again, alternatively, no physical connection may exist between the focus-modulation device and the at feast one evaluation device.

As outlined above, the optical detector further comprises at least one imaging device which is adapted to record an image as captured by the optical detector. Herein, the term “imaging” refers to acquiring a value of an optical quantity, in particular, an illumination, a wavelength, such as a color; a polarization; a luminescence, such as a fluorescence; or a transmission, of a scene or a part thereof in a space-resolved manner, i.e. with regard to at least one spatial coordinate, preferably to two or three spatial coordinates, which may be defined with respect to the scene or the part thereof. Thus, the image may comprise a one-, two- or three-dimensional image of the full scene or of a part of the scene, wherein the “scene” may refer to an arbitrary surrounding of the optical detector, comprising, as an example, one or more objects, wherein the image of the scene may be taken. Herein, the scene may be a scene inside a building or a room or a part thereof or may be a scene outside a building or a room. Further, the at least one image may comprise a single image or a progressive sequence of images, such as a video or video clip.

Thus, the at least one imaging device may generally refer to an arbitrary device comprising at least one light-sensitive element which may be spatially resolving and, thus, adapted to record spatially resolved optical information, in one, two, or three dimensions. Similarly, in case a relationship between the space and a temporal movement of the least one light-sensitive element within the space is known, the at least one light-sensitive element may equally be time resolving and, thus, adapted to, still, record spatially resolved optical information, in one, two, or three dimensions.

In a first embodiment, the optical sensor as described above and/or below may particularly be used in a manner that the optical sensor actually constitutes the imaging device, i.e. that the imaging device is identical with the optical sensor. Advantageously, a single sensor may, thus, be sufficient to still be able to record spatially resolved optical information.

In a second embodiment, at least one additional longitudinal optical sensor which may exhibit identical or similar properties with regard to the mentioned optical sensor may be employed as the at least one imaging device. In both embodiments, the at least one optical sensor may particularly exhibit the above-described FiP-effect as a large-area optical sensor, wherein the large-area optical sensor has a uniform sensor surface constituting the sensor region rather than being a pixelated optical sensor generally comprising a plurality of separate sensor pixels. As a result, the imaging device in these particular embodiments might only be able to provide an image with respect to the depth of the scene.

However, in order to overcome such a restriction, the imaging device may as a further embodiment, alternatively or in addition, additionally comprise at least one of the optional transversal optical sensors as mentioned above and/or below, which are adapted to record at least one transversal coordinate with respect to the image. Herein, the transversal optical sensor may, preferably, be a large-area photo detector having a uniform sensor surface constituting the sensor region and at least one pair of electrodes, wherein at least one of the electrodes may be a split electrode having at least two partial electrodes. Accordingly, the corresponding transversal sensor signal may, thus, be generated in accordance with the electrical currents through the partial electrodes, wherein the information on the transversal position may, preferably, be derived from at least one ratio of the respective currents through the partial electrodes. Thus, the imaging device in this particular embodiment which comprises at least one transversal optical sensor might provide a two-dimensional planar image or, in combination with at least one comprised or additional longitudinal optical sensor, a three-dimensional spatial image with respect to the recorded scene or the recorded part thereof.

In a further, particularly preferred embodiment, the at least one imaging device may, on the other hand, comprise one or more matrices or arrays of light-sensitive elements, wherein the light-sensitive elements may also be denominated as “pixels” (picture elements). Within this respect, a rectangular one-dimensional or a two-dimensional arrangement of pixels may especially be preferred, such as a two-dimensional square arrangement which, preferably, comprises 4×4, 16×16, 32×32, 64×64, 128×128, 256×256, 1024×1024 or more pixels. However, other arrangement with different numbers of pixels may be employed. With regard to this embodiment, the optical detector may, therefore, comprise one or more imaging devices, wherein each imaging device may have a plurality of light-sensitive pixels.

Within this regard, the optical sensor according to the present invention can preferably be provided in form of a pixelated optical sensor having an array of so-called “sensor pixels”, wherein each sensor pixel may exhibit the HP-effect. For further details reference may here be made to the above mentioned European patent application number EP 13171901.5, filed on Jun. 13, 2013, and the international patent application number PCT/EP2014/061695, filed on Jun. 5, 2014, which describe an optical sensor with a number N of sensor pixels.

Alternatively or in addition, the imaging device may comprise, in a further embodiment, at least one image sensor, preferably at least one inorganic image sensor, in particular at least one charge-coupled device (CCD) or at least one imaging device based on complementary metal oxide semiconductor (CMOS) technology. Both technologies are generally known to be suited for cameras or camera chips, both for linear arrays as well as for two-dimensional arrays. Both the CCD device and the CMOS device each comprise a matrix of pixels which are denominated here as “image pixels”, in particular in contrast to the sensor pixels which may be comprised within the pixelated optical sensor as described elsewhere. In the image sensor, each image pixel may be sensitive to at least one incident light beam, wherein, however, in contrast to the sensor signal of the optical sensor, the sensor signal of the image sensor does generally not depend on the illumination of the sensor region by the incident light beam, in particular not on the width of the light beam which impinges on the sensor region. By way of example, camera sensors using CMOS technology are often based on the application of a one-dimensional or two-dimensional matrix of so-called “active pixel sensors” (APS). An active pixel sensor is an image sensor which comprises a matrix of active pixels, wherein each pixel comprises, besides at least one photodiode, an integrated readout circuit comprising three or more transistors, such as MOS-FET transistors, which are integrated into the pixel. Active pixels allow for a pre-amplification of the signal generated by the photodiode, depending on the illumination of the respective photodiode, wherein the amplified signal may directly be read out as a voltage, as opposed to CCD technology, in which the charges of the photodiodes are transferred pixel-by-pixel through the matrix, to an external amplifier.

In a particular embodiment of the present invention, the optical sensor and the image sensor may constitute a so-called hybrid sensor, wherein the term “hybrid sensor” may refer to an assembly which simultaneously comprises one or more organic materials and one or more inorganic materials, in particular in a combination of one or more organic semiconductor detectors, preferably one or more optical sensors according to the present invention, in particular FiP sensors as described above and/or below, and one or more inorganic semiconductor detectors, preferably one or more inorganic image sensors, in particular one or more CCD devices or one or more CMOS devices as described above. This feature is in contrast with classical hybrid sensors which are known from assemblies in which different types of inorganic image sensors comprising different kinds of materials which are, in general, incompatible with regard to their methods of manufacturing may be combined. Classical hybrid sensors, thus, allow providing a compound sensor which may allow performing various tasks based on an application of different materials. In a similar manner, the hybrid sensors according to the present invention combine the advantages of inorganic image sensors with those of organic optical sensors. In particular, the assembly may refer to a spatial arrangement of the hybrid sensor wherein the optical sensor may be located in a direct vicinity of the image sensor in a manner that no further optical element may be placed between the optical sensor and the image sensor. Thus, a particular spatial arrangement may be provided which may be such that the two different types of sensors or at least one part thereof may touch each other, either directly or by providing a bond between at least two of the constituents of the hybrid device.

Herein, it may particularly be preferred that at least one of the sensor pixels of the pixelated optical sensor might electrically be connected, such as by using a well-known bonding technique, such as wire bonding, direct bonding, ball bonding, or adhesive bonding, to a top contact as provided by one or more of the image pixels as comprised within the image sensor in the vicinity of the optical sensor. Alternatively in addition, a direct contact may be used by employing a transparent contact which may be located between one or more image pixels and the at least one adjoining sensor pixel, wherein the transparent contact may, again, be directly contacted to a top contact which may act as a via leading to the connectors of the image pixel of the image sensor. However, other kinds of bonding techniques may be employed. This kind of spatial arrangement may particularly be advantageous for placing a partitioned optical sensor directly on top of an image sensor since it may easily allow providing electrical contacts, in particular, to non-marginal sensor pixels of the partitioned optical sensor, i.e. those sensor pixels which are not located at the readily accessible periphery of the partitioned optical sensor. By way of example, an electrical contact might, thus, be provided to each of the non-marginal sensor pixels of the optical sensor by using one or more of the top contacts of the adjoining image sensor while the electrical contact, such as in form of an electric wire, can directly be attached to each of the marginal sensor pixels of the optical sensor. However, other ways of providing electrical contacts may be feasible.

With regard to this or to other kinds of arrangements, the assembly of the one or more optical sensors and the at least one image sensor may be such that an incident light beam may first impinge on the one or more optical sensors before attaining the image sensor, wherein both the optical sensor and the image sensor may comprise a sensor region which may each be arranged perpendicular to the optical axis of the detector. This kind of assembly may particularly be useful in an embodiment in which the optical sensors may be fully or at least partially transparent while one image sensor, in particular the last image sensor with respect to the direction of the incident light beam, might be intransparent. Further, this kind of assembly may, especially, be useful in a case wherein the optical sensor may be employed as the longitudinal optical detector being adapted to determine a longitudinal position within the recorded scene whereas the image sensor may, alternatively or in addition, be employed as the transversal optical sensor being configured to determine at least one transversal position within the recorded scene, the transversal position being a position in at least one dimension perpendicular an optical axis of the optical detector, wherein the transversal optical sensor may be adapted to generate at least one transversal sensor signal, which may also be evaluated by the evaluation device. Particularly depending on the desired purpose of the optical detector, other spatial arrangements of the two types of sensors within the hybrid sensor may, however, be feasible. Herein, the mentioned functionalities of the two kinds of sensors may also be employed in a case wherein other spatial arrangements of the two kinds of sensors within the hybrid sensors may be realized.

Within this regard, each kind of sensor may exhibit a specific pixel resolution, wherein the term “pixel resolution” may generally refer to the number of pixels of the corresponding sensor which may be comprised within a specified area, such as within a surface area of the respective sensor of 1 mm² or 1 cm². Accordingly, the image sensor may exhibit a first pixel resolution with respect to its sensor pixels and sensor area while the pixelated optical sensor may exhibit a second pixel resolution with regard to its image pixels and sensor area. In a preferred embodiment, the first pixel resolution being assigned to the inorganic image sensor may equal or exceed the second pixel resolution being assigned to the organic optical sensor. By way of example, the hybrid sensor may be designed in a manner that the pixel resolution of the FiP device may be lower than that of the related CCD or CMOS device. Thus, as an exemplary assembly, for each sensor pixel of the optical sensor, a matrix of 4×4, 16×16, 32×32, 64×64, 128×128, 256×256, 1024×1024 or more image pixels may be comprised within the corresponding image sensor. However, other numbers of image pixels compared to sensor pixels may be feasible. Besides allowing an easier manufacturing of the hybrid device, this kind of arrangement using one matrix of image pixels per optical sensor may be advantageous with respect to the transversal resolution and/or color resolution.

As further used herein, the term “evaluation device” generally refers to an arbitrary device adapted to evaluate the sensor signal, in order to derive at least one item of information from the sensor signal. Thus, further, the term “evaluate” generally refers to the process of deriving at least one item of information from input, such as from the sensor signal. The evaluation device may be a unitary, centralized evaluation device or may be composed of a plurality of cooperating devices. As an example, the at least one evaluation device may comprise at least one processor and/or at least one integrated circuit, such as at least one application-specific integrated circuit (ASIC). The evaluation device may be a programmable device having a computer program running thereon, adapted to perform at least one evaluation algorithm. Additionally or alternatively, non-programmable devices may be used. The evaluation device may be separate from the at least one optical sensor or might fully or partially be integrated into the at least one optical sensor.

According to the present invention, the evaluation device is adapted to, first, evaluate the sensor signal and, secondly, depending on the sensor signal, to initiate a recording of the image by the imaging device. Since the recording of the image by using the imaging device depends on a value of the sensor signal, the evaluation device is required to, first, analyze the sensor signal as provided by the at least one optical sensor. Consequently, the evaluation device may, first, evaluate the sensor signal, such as by determining a width of an incident light beam impinging on the sensor region of the longitudinal optical sensor by analyzing the sensor signal as recorded by the respective optical detector, in particular, by using the above-described FiP effect. As will be explained below in more detail, the sensor signal may, within this regard, exhibit an indication, particularly one of a local maximum or a local minimum, in an event in which the focus-tunable lens may modify the focal length of the lens in a manner that the position of the focus of the incident light beam may coincide with the location of the respective longitudinal optical sensor, in particular of the corresponding sensor area of the optical sensor, within the beam path of the focus-tunable lens. According to the present invention, the evaluation device may, secondly, upon occurrence of the described or of a related event, thus, trigger the image device to perform a recording of the image. Since the described event indicates that the image of the observed object is at the position of the focus of the focus-tunable lens, the recording of the image by the imaging device may, therefore, take place at a time interval at which the object may be observable in focus.

As used herein, the term “in focus” describes the situation in which an optical element may actually be located at the focal point of the incident light beam, wherein, however, a tolerance range with respect to the focal point may be taken into account in a manner that a slight deviation of the position of the respective optical element could be tolerated under the actual practical circumstances. In order to describe this feature, the term “depth of field”, often abbreviated to “DOF”, has been introduced, particularly, in the field of photography. According to its definition, the depth of field provides a distance between the nearest object and the farthest object in the same scene which may be considered as appearing acceptably sharp in the image. Consequently, as will be explained later in more detail, when using a focus-tunable lens which is located in the beam path of the mentioned light beam, taking into account the tolerance range, as, for example, expressed by the depth of field, may result in an observation that, by temporally modifying the focus-tunable lens, the condition that the optical element may be located at the focal point of the incident light beam may be fulfilled not only in an instant but within a finite time interval which may, by way of example, be measured in milliseconds or seconds.

Accordingly, the image of the object may actually be in focus when a distance of the location of the sensor region of the imaging device from the center of the focus-tunable lens equals the focal length of the focus-tunable lens. Since, as mentioned above, the longitudinal optical sensor may, however, already be located at the position of the focus of the focus-tunable lens, the image of the object can, strictly speaking, only be recorded in focus in a case when either the longitudinal optical sensor itself constitutes the imaging device, such as by using a combined optical sensor as described elsewhere, or when more than one equivalent focal points may be available within the beam path. The latter condition may actually be fulfilled by providing one or more beam-splitting elements which can be placed within the beam path of the focus-tunable lens, wherein the beam-splitting element might, thus, allow splitting the beam after traversing the focus-tunable lens into at least two separate portions in a manner that more than one equivalent focal points might be available within each of the different portions of the light beam. As a result, the respective focal points within each of the different portions may independently be occupied by, at least, the optical sensor and the imaging device. By way of example, after traversing the focus-tunable lens a light beam may impinge on a beam splitter which may create two separate portions of the beam path, wherein the optical sensor may be located on a first branch of the beam path while the imaging device may be placed on a second branch of the beam path, wherein both the optical sensor and the imaging device may have a connection to the evaluation device. As soon as the evaluation device may detect that a sensor signal in the optical sensor might indicate that the object may be in focus in a sense as indicated above, it may trigger the imaging device in order to record at least one image of the object. Thus, this arrangement may allow recording one or more images of the object which is always in focus.

Further, a similar measurement principle may, still, be applied in a case where a hybrid sensor comprising at least one optical sensor and at least one image sensor may be employed. In this case, it may seem, due to geometrical reasons, not to be possible to, strictly speaking, simultaneously locate both constituents of the hybrid sensor, i.e. the at least one optical sensor and the at least one image sensor, within a position of the focus of the focus-tunable lens including the above mentioned tolerance range. However, since, according to the present invention, a focus-tunable lens is employed here for modifying the focal position of the light beam by using the at least one focus-modulation device in a controlled fashion, a temporal progression of the focal position of the light beam may be known in advance, in particular by using the evaluation device. As a result, after detecting that a sensor signal in the optical sensor might indicate that the object may be in focus with respect to the optical sensor, the evaluation device may wait a period of time until it may trigger the imaging device in order to record at least one image of the object. If the period of time might carefully be chosen, the controlled tuning of the focus-tunable lens may, thus, accomplish that, after the mentioned period of time, the focal position of the beam may be moved to such an extent that the object as recorded by the imaging device may now be in focus or within the corresponding tolerance range.

Alternatively, since the progression of the focal position of the light beam may be known in advance, in particular by acquisition of respective information by the evaluation device, such as by reading a calibration curve or by considering a periodic variation as induced by the at least one focus-modulation device, a deviation of the location of the longitudinal optical sensor with respect to the focal position of the light beam after traversing the focus-tunable length may be taken into account for determining the instant at which the imaging device may record the at least one image. In particular, as soon as the evaluation device may detect that the sensor signal as recorded by the optical sensor might indicate that the object may exhibit the predetermined deviation from the focus, it may trigger the imaging device in order to record the at least one image of the object, in particular at this particular instant.

However, further approaches may also be useful in determining the instant at which the at least one image of the object may preferably be recorded since the object might be in focus or within the corresponding tolerance range as described above.

Specifically, the at least one evaluation device may be adapted to detect one or both of local maxima or local minima in the sensor signal. Thus, specifically in case a periodic modulation of the focus-tunable lens takes place by the focus-modulation device, such as by periodically modulating the focal length of the at least one focus-tunable lens, the sensor signal may be or may comprise a periodic sensor signal. The evaluation device may be adapted to determine one or more of an amplitude, a phase or a position of local maxima and/or local minima in the sensor signal. As will be outlined in further detail below, a position specifically of a maximum in the sensor signal, in a signal generated by a FiP sensor, may indicate that the optical sensor generating the optical sensor generating the sensor signal is in focus, having its minimum beam diameter and, thus, the light beam having its highest photon density in the position of the sensor region of the optical sensor. In this regard, reference may be made to the disclosure of one or more of WO 2012/110924 A1, US 2012/0206336 A1, WO 2014/097181 A1 or US 2014/0291480 A1.

Thus, the evaluation device may be adapted to detect one or both of local minima or local maxima in the at least one sensor signal and may optionally be adapted to determine a position of these local minima and/or local maxima, such as by determining a one or more of a phase, such as a phase angle, or a time at which the local maxima and/or local minima occur. Additionally or alternatively, the evaluation device may be adapted to compare the local maxima or local minima to a clock signal, such as an internal clock signal. Thus, generally, the evaluation device may evaluate a phase and/or frequency of the local maxima and/or the local minima. Additionally or alternatively, the evaluation device may be adapted to detect a phase shift difference between the local maxima and/or the local minima. Various other ways of evaluating the position, the frequency, the phase or other attributes of the sensor signal and/or one or both of the local minima and/or the local maxima are possible, as the skilled person will recognize.

Since the modulation of the focus-tunable lens is generally known, such as a phase of a modulation of the focus-tunable lens, from the position of the local minima and/or the local maxima in the sensor signal, at least one item of information regarding a position of an object from which the light beam propagates towards the optical detector, such as at least one item of information on a longitudinal position of the object, may be determined. Again, this determining of the at least one item of information on the position of the object may be performed by using at least one predetermined or determinable relationship between the position of the local minima and/or maxima in the sensor signal, such as phase angles or times at which these local minima and/or maxima occur, and the item of information on the position of the object, such as the item of information on the longitudinal position of the object. The relationship may be determined empirically, such as by assuming Gaussian properties of the light beam when propagating from the object to the detector, as disclosed in one or more of the above-mentioned documents WO 2012/110924 A1, US 2012/0206336 A1, WO 2014/097181 A1 or US 2014/0291480 A1. Additionally or alternatively, the relationship may, again, be determined empirically, such as by a simple experiment in which the object is placed, subsequently, at different positions and wherein, each time, the sensor signal is measured and the local minima and/or the local maxima in the sensor signal are determined, thereby generating a relationship such as a lookup-table, a curve, an equation or any other empirical relationship indicating a relation between a position of the local minima and/or the local maxima on the one hand and the at least one item of information on the position of the object on the other hand, such as the at least one item on the longitudinal position of the object. Thus, as an example, at least one input variable may be used which is derived from the position of the local minima and/or the local maxima, and an output variable containing the at least one item of information on the position of the object may be generated thereof, such as by using one or more of an algorithm, an equation, a lookup table, a curve, a graph or the like. Again, the relationship may be generated analytically, empirically or semi-empirically.

Thus, generally, the evaluation device may be adapted to derive at least one item of information on a longitudinal position of at least one object from which the light beam propagates towards the optical detector by evaluating one or both of the local maxima or local minima. For this purpose, again, the evaluation device, as an example, may comprise one or more processors and/or one or more integrated circuits adapted for performing this step. As an example, one or more computer programs may be used for performing the step, the computer programs comprising program steps for executing the above-mentioned steps, when run on the processor.

As outlined above, the evaluation device specifically may be adapted to perform a phase-sensitive evaluation of the sensor signal. As used herein, a phase-sensitive evaluation generally refers to an evaluation of a signal which is sensitive to a shifting of the signal on a phased axis or time axis, such that a shift of the signal in time, e.g. a retarded signal and/or an accelerated signal, may be registered. Specifically, the evaluation may imply registering a phase angle and/or a time and/or any other variable indicating a phase shift when evaluating a periodic signal. Thus, as an example, a phase-sensitive evaluation of a periodic signal generally may imply registering one or more phase angles and/or times of certain features in the periodic signal, such as the phase angles of minima and/or maxima. The phase-sensitive evaluation specifically may comprise one or both of determining a position of one or both of local maxima or local minima in the sensor signal or a lock-in detection. Lock-in detection methods generally are known to the skilled person. Thus, as an example, the focus-modulating signal, which may be a periodic signal, and the sensor signal may both be fed into a lock-in amplifier. Herein, the modulation signal controlling the lens and the modulation signal used for the lock-in detection method may, preferably, be adapted in a manner that the signal to noise-ratio may be increased, in particular, in an optimal way. Further, the modulation signal may be adjusted using a feedback loop between the evaluation device and the modulation device in order to, still, improve the signal to noise-ratio. Still, other ways of evaluating the sensor signal are feasible, such as by evaluating any other type of feature in the sensor signal and/or by comparing the sensor signal with one or more other signals.

As outlined above, the evaluation device specifically may be adapted to generate at least one item of information on a longitudinal position of at feast one object from which the light beam propagates towards the optical detector by evaluating the sensor signal. For definitions of the term “longitudinal position” and potential ways of determining the longitudinal position, reference may be made to one or more of the above-mentioned documents WO 2012/110924 A1, US 2012/0206336 A1, WO 2014/097181 A1 or US 2014/0291480 A1 and the use of the FiP effect disclosed therein. Thus, the sensor signal generally depends on the width of a light spot generated by the light beam in the sensor region. Thus, whenever a focal length of the focus-tunable lens at a specific point in time as well as properties of the light beam propagating from the object towards the detector are known, the sensor signal indicates a longitudinal position of the object, such as a distance between the object and the optical detector. Thus, generally, the term longitudinal position may generally refer to a position of the object or a part thereof on an axis parallel to an optical axis of the optical detector, such as a symmetry axis of the optical detector. As an example, the at least one item of information on the longitudinal position of the object may simply refer to a distance between the object and the detector and/or may simply refer to a so-called z-coordinate of the object, wherein the z-axis is chosen parallel to the optical axis and/or wherein the optical axis is chosen as the z-axis. For further details, reference may be made to one or more of the above-mentioned documents. Thus, generally, e.g. the position of a maximum in a sensor signal in which a focal length of the focus-tunable lens is modified allows for determining the at least one item of information on the longitudinal position of the object, as will be explained in further exemplary embodiments below.

As outlined above, for determining the at least one predetermined or determinable relationship between the longitudinal position and the sensor signal, either analytical approaches or empirical approaches or even semi-empirically approaches may be used. Analytically, by assuming a Gaussian propagation of light beams, the sensor signal may be derived from optical properties of the optical detector setup, when the relationship between a width of a light spot on the sensor region and the sensor signal is known. Empirically, as outlined above, simple experiments may be performed for calibrating the setup of the optical detector, such as by placing the object at different distances from the optical detector and, for each distance, recording the sensor signal. As an example, for each distance at least one phase angle of local minima and/or local maxima may be determined for periodic sensor signals, and an empirical relationship between the at least one phase angle and the distance of the object may be determined. Other empiric calibration measurements are feasible.

As outlined above, the optical detector comprises at least one optical sensor, wherein, preferably, the at least one optical sensor or, in case a plurality of optical sensors is provided, at least one of these optical sensors may function as a longitudinal optical sensor, generating a longitudinal optical sensor signal from which the evaluation device may derive at least one item of information on a longitudinal position of the object from which the light beam propagates towards the optical detector. For potential setups of the at least one optional longitudinal optical sensor, reference may be made, e.g., to the sensor setups disclosed in WO 2012/110924 A1 or US 2012/0206336 A1, since the optical sensors disclosed therein may function as longitudinal optical sensors, such as distance sensors. By periodically modulating the focal length of the at least one focus-tunable lens, the longitudinal position such as the distance of the object from the optical detector may be derived. For further potential setups of the at least one longitudinal optical sensor, reference may be made to the longitudinal optical sensors disclosed in one or both of WO 2014/097181 A1 or US 2014/0291480 A1. Again, by periodically modulating the focal length of the at least one focus-tunable lens, the longitudinal position such as the distance of the object from the optical detector may be derived. It shall be noted, however, that other setups of the at least one longitudinal optical sensor are feasible.

Generally, the at least one optical sensor, specifically the at least one longitudinal optical sensor, may comprise at least one semiconductor detector. The optical sensor may comprise at least two electrodes and at least one photovoltaic material embedded in between the at least two electrodes. The optical sensor may comprise at least one organic semiconductor detector having at least one organic material, preferably an organic solar cell and particularly, preferably a dye solar cell or dye-sensitized solar cell, in particular a solid dye solar cell or a solid dye-sensitized solar cell. The optical sensor, specifically the longitudinal optical sensor, may comprise at least one first electrode, at least one n-semiconducting metal oxide, at least one dye, at least one p-semiconducting organic material, preferably a solid p-semiconducting organic material, and at least one second electrode. Therein, at least one of the first electrode of the second electrode may be transparent. In order to create a transparent optical sensor, even both the first electrode and the second electrode may be transparent. For further details, reference may be made to one or more of WO 2012/110924 A1, US 2012/0206336 A1, WO 2014/097181 A1 or US 2014/0291480 A1. It shall be noted, however, that other embodiments of the at least one optical sensor are feasible, even though the embodiments disclosed therein are specifically useful for the purposes of the present invention.

As outlined above, the at least one optical sensor of the optical detector may be or may comprise or may function as at least one longitudinal optical sensor, adapted for generating a longitudinal optical sensor signal from which the evaluation device may derive at least one item of information on a longitudinal position of the object from which the light beam propagates towards the detector. Additionally, however, the optical detector may further be adapted for deriving at least one item of information on a transversal position of the object. For potential definitions of the term “transversal position” as well as for potential ways of measuring this transversal position, reference may be made to one or more of WO 2014/097181 A1 or US 2014/0291480 A1. Thus, as an example, a transversal position may be a position of the object or a part thereof in a plane perpendicular to the above-mentioned axis parallel to the optical axis of the optical detector and/or a plane perpendicular to the optical axis of the detector itself. As an example, this plane may be referred to as the x-y-plane. In other words, a Cartesian coordinate system may be used, with the optical axis as the z-axis or with an axis parallel to the optical axis as the z-axis, and with x- and y-axes perpendicular to the z-axis. Still, other coordinate systems may be used, such as polar coordinate systems, with the above-mentioned z-axis and a radius and a polar angle as further coordinates, wherein the radius and the polar angle may be referred to as the transversal coordinates.

Thus, generally, the optical detector may further comprise at least one transversal optical sensor, the transversal optical sensor being adapted to determine a transversal position of the light beam, the transversal position being a position in at least one dimension perpendicular to an optical axis of the detector, the transversal optical sensor being adapted to generate at least one transversal sensor signal. The evaluation device may further be adapted to generate at least one item of information on a transversal position of the object by evaluating the transversal sensor signal.

Many ways of generating a transversal sensor signal are feasible. As an example, for determining the transversal position of the object, the imaging device, such as imaging device comprising an image sensor, preferably a CCD device or a CMOS device, as described above and/or below or an additional imaging device of this kind may be used, and the transversal position may simply be determined by evaluating the image as generated by the imaging device or the additional imaging device. Additionally or alternatively, however, other types of transversal optical sensors may be used which, as an example, may be adapted to directly generate a sensor signal from which the transversal position of the object may be derived.

For potential exemplary embodiments of the at least one optional transversal optical sensor and the evaluation of one or more transversal optical sensor signals generated by this at least one optional transversal optical sensor, reference may, again, be made to one or more of WO 2014/097181 A1 or US 2014/0291480 A1. The setups of the transversal optical sensors disclosed therein may also be used in the optical detector according to the present invention.

Thus, as disclosed in one or more of WO 2014/097181 A1 or US 2014/0291480 A1, the at least one transversal optical sensor may be a photo detector having at least one first electrode, at least one second electrode and at least one photovoltaic material, wherein the photovoltaic material is embedded in between the first electrode and the second electrode, wherein the photovoltaic material is adapted to generate electric charges in response to an illumination of the photovoltaic material with light, wherein the second electrode is a split electrode having at least two partial electrodes, wherein the transversal optical sensor has a sensor region, wherein the at least one transversal sensor signal indicates a position of the light beam in the sensor region. Therein, electrical currents through the partial electrodes may be dependent on a position of the light beam in the sensor region, wherein the transversal optical sensor is adapted to generate the transversal sensor signal in accordance with the electrical currents through the partial electrodes. The detector, specifically the evaluation device, may be adapted to derive the information on the transversal position of the object from at least one ratio of the currents through the partial electrodes. For further details and exemplary embodiments of this type of evaluation of sensor signals, reference may be made to WO 2014/097181 A1 or US 2014/0291480 A1.

Specifically, the at least one transversal optical sensor may be or may comprise at least one dye-sensitized solar cell, as also disclosed in WO 2014/097181 A1 or US 2014/0291480 A1. The first electrode, at least partially, may be made of at least one transparent conductive oxide, wherein the second electrode, at least partially, is made of an electrically conductive polymer, preferably a transparent electrically conductive polymer. Still, other embodiments are feasible.

As outlined above, the optical detector may comprise one or more optical sensors, wherein, preferably, at least one of the optical sensors fulfills the above-mentioned purposes of the longitudinal optical sensor, generating a sensor signal from which the at least one evaluation device may derive at least one item of information on a longitudinal position of the object from which the light beam propagates towards the detector. Additionally, one or more transversal optical sensors may be provided. The at least one optional transversal optical sensor may be separate from the at least one longitudinal optical sensor or may fully or partially be integrated into the at least one longitudinal optical sensor. Various setups are feasible.

In case a plurality of optical sensors is used, the optical sensors may be placed in various ways. As an example, the optical sensors may be placed in one and the same beam path of the light beam. Additionally or alternatively, two or more optical sensors may be placed in different branches of the setup, thereby being placed in different partial beam paths, such as by using beam-splitting elements.

Specifically, in case a plurality of optical sensors is used, two or more of the optical sensors may be arranged as a stack of optical sensors. Thus, generally, the at least one optical sensor may comprise a stack of at least two optical sensors, as disclosed e.g. In WO 2014/097181 A1 or US 2014/0291480 A1. At least one of the optical sensors of the stack may be an at least partially transparent optical sensor.

As will be outlined in further detail below, the optical detector may comprise one or more additional elements besides the elements disclosed above. Thus, as an example, the optical detector may comprise one or more housings encasing one or more of the above-mentioned components or one or more of the components disclosed in further detail below.

Further, the optical detector may comprise at least one transfer device, wherein the transfer device is designed to feed light emerging from the object to the transversal optical sensor and the longitudinal optical sensor. As used herein, consequently, the term “transfer device” generally refers to an arbitrary device or combination of devices adapted for guiding and/or feeding the light beam onto or into the optical detector and/or the at least one optical sensor, preferably by influencing one or more of a beam shape, a beam width or a widening angle of the light beam in a well-defined fashion, such as a lens or a curved mirror do. Consequently, the transfer device may be or may comprise one or more of: a lens, a focusing mirror, a defocusing mirror, a reflector, a prism, an optical filter, a diaphragm. Other embodiments are feasible. Further exemplary embodiments of potential transfer devices will be disclosed in detail below. The at least one focus-tunable lens may be separate from the at least one transfer device or, preferably, might fully or partially be integrated into the at least one transfer device or may be part of the at least one transfer device.

Tunable optical elements such as focus-tunable lenses provide the additional advantage of being capable of correcting the fact that objects at different distances have different focal points. Focus-tunable lens arrays, as an example, are disclosed in US 2014/0132724 A1. Other embodiments, however, are feasible. Further, for potential examples of liquid micro-lens arrays, reference may be made to C. U. Murade et al., Optics Express, Vol. 20, No. 16, 18180-18187 (2012). Again, other embodiments are feasible. Further, for potential examples of microprisms arrays, such as arrayed electrowetting microprisms, reference may be made to J. Heikenfeld et al., Optics & Photonics News, January 2009, 20-26. Again, other embodiments of microprisms may be used.

As outlined above or as will be outlined in further detail below, the sensor signal of the at least one optical sensor, given the same total power of the illumination, is dependent on a width of the light beam in the sensor region. Thus, the at least one optical sensor comprises at least one sensor having the above-explained FiP effect. It shall be noted, however, that, in addition to the at least one FiP-sensor, other types of optical sensors may be used.

The sensor signal preferably may be an electrical signal, such as an electrical current and/or an electric voltage. The sensor signal may be a continuous or discontinuous signal. Further, the sensor signal may be an analogue signal or a digital signal. Further, the optical sensor, by itself and/or in conjunction with other components of the optical detector, may be adapted to process or preprocess the detector signal, such as by filtering and/or averaging, in order to provide a processed detector signal. Thus, as an example, a bandpass filter may be used in order to transmit only detector signals of a specific frequency range. Other types of preprocessing are feasible. In the following, when referring to the detector signal, no difference will be made between the case in which the raw detector signal is used and the case in which a preprocessed detector signal is used for further evaluation.

As will be outlined in further detail below, the evaluation device may comprise at least one data processing device, such as at least one microcontroller or processor. Thus, as an example, the at least one evaluation device may comprise at least one data processing device having a software code stored thereon comprising a number of computer commands. Additionally or alternatively, the evaluation device may comprise one or more electronic components, such as one or more frequency mixing devices and/or one or more filters, such as one or more bandpass filters and/or one or more low-pass filters. Thus, as an example, the evaluation device may comprise at least one Fourier analyzer and/or at least one lock-in amplifier or, preferably, a set of lock-in amplifiers, for performing the frequency analysis. Thus, as an example, in case a set of modulation frequencies is provided, the evaluation device may comprise a separate lock-in amplifier for each modulation frequency of the set of modulation frequencies or may comprise one or more lock-in amplifiers adapted for performing a frequency analysis for two or more of the modulation frequencies, such as sequentially or simultaneously. Lock-in amplifiers of this type generally are known in the art.

The evaluation device can be connected to or may comprise at least one further data processing device that may be used for one or more of displaying, visualizing, analyzing, distributing, communicating or further processing of information, such as information obtained by the optical sensor and/or by the evaluation device. The data processing device, as an example, may be connected or incorporate at least one of a display, a projector, a monitor, an LCD, a TFT, an LED pattern, or a further visualization device. It may further be connected or incorporate at least one of a communication device or communication interface, an audio device, a loudspeaker, a connector or a port, capable of sending encrypted or unencrypted information using one or more of email, text messages, telephone, bluetooth, Wi-Fi, infrared or internet interfaces, ports or connections. The data processing device, as an example, may use communication protocols of protocol families or suites to exchange information with the evaluation device or further devices, wherein the communication protocol specifically may be one more of: TCP, IP, UDP, FTP, HTTP, IMAP, POP3, ICMP, IIOP, RMI, DCOM, SOAP, DDE, NNTP, PPP, TLS, E6, NTP, SSL, SFTP, HTTPs, Telnet, SMTP, RTPS, ACL, SCO, L2CAP, RIP, or a further protocol. The protocol families or suites specifically may be one or more of TCP/IP, IPX/SPX, X.25, AX.25, OSI, AppleTalk or a further protocol family or suite. The data processing device may further be connected or incorporate at least one of a processor, a graphics processor, a CPU, an Open Multimedia Applications Platform (OMAP™), an integrated circuit, a system on a chip such as products from the Apple A series or the Samsung S3C2 series, a microcontroller or microprocessor, one or more memory blocks such as ROM, RAM, EEPROM, or flash memory, timing sources such as oscillators or phase-locked loops, counter-timers, real-time timers, or power-on reset generators, voltage regulators, power management circuits, or DMA controllers. Individual units may further be connected by buses such as AMBA buses.

The evaluation device and/or the data processing device may be connected by or have further external interfaces or ports such as one or more of serial or parallel interfaces or ports, USB, Centronics Port, FireWire, HDM1, Ethernet, Bluetooth, RFID, Wi-Fi, USART, or SPI, or analog interfaces or ports such as one or more of ADCs or DACs, or a standardized interfaces or ports to further devices such as a 2D-camera device using an RGB-interface such as CameraLink. The evaluation device and/or the data processing device may further be connected by one or more of interprocessor interfaces or ports, FPGA-FPGA-interfaces, or serial or parallel interfaces ports. The evaluation device and the data processing device may further be connected to one or more of an optical disc drive, a CD-RW drive, a DVD+RW drive, a flash drive, a memory card, a disk drive, a hard disk drive, a solid state disk or a solid state hard disk.

The evaluation device and/or the data processing device may be connected by or have one or more further external connectors such as one or more of phone connectors, RCA connectors, VGA connectors, hermaphrodite connectors, USB connectors, HDMI connectors, 8P8C connectors, BCN connectors, IEC 60320 C14 connectors, optical fiber connectors, D-subminiature connectors, RF connectors, coaxial connectors, SCART connectors, XLR connectors, and/or may incorporate at least one suitable socket for one or more of these connectors.

The modulator device, as outlined above, may be adapted for periodically modulating the at least two pixels with the different modulation frequencies. The evaluation device specifically may be adapted for performing the frequency analysis by demodulating the sensor signal with the different modulation frequencies.

As outlined above, in the optical detector according to the present invention, the evaluation device may be adapted for dividing at least one item of information on a longitudinal position of the object from the at least one sensor signal of the at least one optical sensor being a HP sensor, since the sensor signal of the at least one optical sensor depends on a width of the light spot generated by the light beam in the sensor region of the optical sensor. Thus, generally, the evaluation device, using a known or determinable relationship between a longitudinal coordinate of an object from which the light beam propagates towards the detector and one or both of a width of the light beam at the position of the optical sensor illuminated by the light beam, may be adapted to determine a longitudinal coordinate of the object and/or to determine at least one further item of information regarding a longitudinal position of the object. Again, the predetermined or determinable relationship may be determined in various ways, such as by using an analytical approach, such as an approach using the assumption of Gaussian light beams, or by using a simple empirical calibration approach, such as by placing the object at various distances from the optical detector and determining one or both of the number of pixels of the optical sensor illuminated by the light beam or the width of the light beam or light spot generated by the light beam at the position of the optical sensor.

The at least one optical sensor may comprise at least one large-area optical sensor being adapted to detect a plurality of portions of the light beam passing through a plurality of the pixels.

The optical detector may contain a single beam path or may contain, as outlined above, a plurality of at least two different partial beam paths. In the latter case, the optical detector specifically may comprise at least one beam-splitting element adapted for dividing a beam path of the light beam into at least two partial beam paths. In case a plurality of partial beam paths is provided, the at least one optical sensor may be located in one or more of the partial beam paths.

As outlined above, the optical detector, besides the at least one longitudinal optical sensor, the at least one focus-tunable lens, the focus-modulation device, the at least one imaging device, and the at least one evaluation device, may comprise one or more additional elements. Thus, as an example, as already mentioned above, the optical detector may comprise at least one transversal optical sensor and/or or at least one beam-splitting device which will be described below in more detail.

The evaluation device may further be adapted to determine depth information for the image pixels by evaluating the signal components. Thus, for a specific image pixel or group of image pixels of the image, an information regarding a longitudinal position of an object from which a light beam or a partial light beam propagates towards the detector and reaches the respective image pixel may be generated, such as by using the above-mentioned means of evaluating the sensor signal of the at least one optical sensor, such as by using the FiP effect. Thus, for all pixels or for some of the pixels, depth information may be generated. The evaluation device may be adapted to combine the depth information of the image pixels with the image in order to generate at least one three-dimensional image, since a two-dimensional image captured by the imaging device and the additional depth information generated for some or even all of the image pixels may sum up to a three-dimensional image information.

Possible embodiments of a single device incorporating one or more optical detectors according to the present invention, the evaluation device or the data processing device, such as incorporating one or more of the optical sensor, optical systems, evaluation device, communication device, data processing device, interfaces, system on a chip, display devices, or further electronic devices, are: mobile phones, personal computers, tablet PCs, televisions, game consoles or further entertainment devices. In a further embodiment, the 3D-camera functionality which will be outlined in further detail below may be integrated in devices that are available with conventional 2D-digital cameras, without a noticeable difference in the housing or appearance of the device, where the noticeable difference for the user may only be the functionality of obtaining and or processing 3D information.

Specifically, an embodiment incorporating the optical detector and/or a part thereof such as the evaluation device and/or the data processing device may be: a mobile phone incorporating a display device, a data processing device, the optical sensor, optionally the sensor optics, and the evaluation device, for the functionality of a 3D camera. The optical detector according to the present invention specifically may be suitable for integration in entertainment devices and/or communication devices such as a mobile phone.

A further embodiment of the present invention may be an incorporation of the optical detector or a part thereof such as the evaluation device and/or the data processing device in a device for use in automotive, for use in autonomous driving or for use in car safety systems such as Daimler's Intelligent Drive system, wherein, as an example, a device incorporating one or more of the optical sensors, optionally one or more optical systems, the evaluation device, optionally a communication device, optionally a data processing device, optionally one or more interfaces, optionally a system on a chip, optionally one or more display devices, or optionally further electronic devices may be part of a vehicle, a car, a truck, a train, a bicycle, an airplane, a ship, a motorcycle. In automotive applications, the integration of the device into the automotive design may necessitate the integration of the optical sensor, optionally optics, or device at minimal visibility from the exterior or interior. The optical detector or a part thereof such as the evaluation device and/or the data processing device may be especially suitable for such integration into automotive design.

The above-mentioned concept of using at least one focus-tunable lens, specifically an oscillating lens having a flexible focal length, in order to modulate the light beam or a part thereof, such as for frequency modulation, provides a plurality of advantages. Thus, generally, using an oscillating flexible focal length for frequency modulation in combination typically increases the signal intensity of the sensor signals of FiP sensors by approximately 50%.

The at least one focus-tunable lens may be or may comprise a single lens or may comprise a plurality of focus-tunable lenses, such as a focus-tunable lens array. The focal lengths of these focus-tunable lenses may oscillate periodically, for the whole array or for selected areas of the array, e.g. such that the focus is changed from a minimum to a maximum focal length and back. By changing the amplitude and offset of the focus different focus levels can be analyzed. For example, an object in the front can be analyzed in detail using a short focus of the corresponding area of micro-lenses, while an object in the back can be simultaneously analyzed. To distinguish the different focus levels, the micro-lenses can oscillate at different frequencies, which make a separation according to these frequencies possible, such as by using Fast Fourier Transform (FFT) or other means of frequency selection. While the focus oscillates, the signal of the FiP-sensor may show local minima or maxima, when an object is in focus within the respective optical sensor.

Thus, the concept of the present invention may be used to simplify the setup of the optical detector and/or a camera comprising the optical detector. In particular, the at least one FiP-sensor can inherently determine whether an object is in focus or out of focus. When changing the focus position and/or the focal length of the focus-tunable lens, a FiP-sensor may show a local maximum and/or minimum in the sensor signal such as in the FiP-current, when an object from which the light beam emerges is in focus. This concept can be used to construct an optical detector and/or a camera that shows all objects in focus and that can, preferably in a simultaneous manner, determine depth.

Since, according to the present invention, an imaging device may be used, such as a CCD device and/or a CMOS device, the pixels of the imaging device such as the CMOS-pixels which may be arranged below the FiP-pixel may record a picture at the focal length, where the FiP-curve shows a local minimum or local maximum. Thus, a simple scheme may be obtained, in order to record an image that has all objects in focus.

The focal length at which a FiP-pixel detects an object in focus may be used to calculate a relative or absolute depth of the corresponding object. In connection with image analysis and/or filters, a 3D-image may be calculated.

The optical detector according to this basic principle of the present invention may be further developed by various embodiments which may be used in isolation or in any feasible combination.

As outlined in further detail above, the evaluation device preferably may be adapted for performing the frequency analysis by demodulating the sensor signal with different modulation frequencies. For this purpose, the evaluation device may contain one or more demodulation devices, such as one or more frequency mixing devices, one or more frequency filters such as one or more low-pass filters or one or more lock-in amplifiers and/or Fourier-analyzers. The evaluation device preferably may be adapted to perform a discrete or continuous Fourier analysis over a predetermined and/or adjustable range of frequencies.

As outlined above, the evaluation device preferably is adapted to assign each of the signal components to one or more pixels of the matrix. The evaluation device may further be adapted to determine which pixels of the matrix are illuminated by the light beam by evaluating the signal components. Thus, since each signal component may correspond to a specific pixel via a unique correlation, an evaluation of the spectral components may lead to an evaluation of the illumination of the pixels. As an example, the evaluation device may be adapted to compare the signal components with at least one threshold in order to determine the illuminated pixels. The at least one threshold may be a fixed threshold or predetermined threshold or may be a variable or adjustable threshold. As an example, a predetermined threshold above typical noise of the signal components may be chosen, and, in case a signal component of a respective pixel exceeds the threshold, an illumination of the pixel may be determined. The at least one threshold may be a uniform threshold for all signal components or may be an individual threshold for the respective signal component. Thus, in case different signal components are prone to show different degrees of noise, an individual threshold may be chosen in order to take account of these individual noises.

The evaluation device may further be adapted to identify at least one transversal position of the light beam and/or an orientation of the light beam, such as an orientation with regard to an optical axis of the detector, by identifying a transversal position of pixels of the matrix illuminated by the light beam. Thus, as an example, a center of the light beam on the matrix of pixels may be identified by identifying the at least one pixel having the highest illumination by evaluating the signal components. The at least one pixel having the highest illumination may be located at a specific position of the matrix which again may then be identified as the transversal position of the light beam. In this regard, generally, reference may be made to the principle of determining a transversal position of the light beam as disclosed in European patent application number EP 13171901.5, even though other options are feasible.

Generally, as will be used in the following, several directions of the detector may be defined. Thus, a position and/or orientation of an object may be defined in a coordinate system, which, preferably, may be a coordinate system of the detector. Thus, the detector may constitute a coordinate system in which an optical axis of the detector forms the z-axis and in which, additionally, an x-axis and a y-axis may be provided which are perpendicular to the z-axis and which are perpendicular to each other. As an example, the detector and/or a part of the detector may rest at a specific point in this coordinate system, such as at the origin of this coordinate system. In this coordinate system, a direction parallel or antiparallel to the z-axis may be regarded as a longitudinal direction, and a coordinate along the z-axis may be considered a longitudinal coordinate. An arbitrary direction perpendicular to the longitudinal direction may be considered a transversal direction, and an x- and/or y-coordinate may be considered a transversal coordinate.

Alternatively, other types of coordinate systems may be used. Thus, as an example, a polar coordinate system may be used in which the optical axis forms a z-axis and in which a distance from the z-axis and a polar angle may be used as additional coordinates. Again, a direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

The center of the light beam on the matrix of pixels, which may be a central spot or a central area of the light beam on the matrix of pixels, may be used in various ways. Thus, at least one transversal coordinate for the center of the light beam may be determined, which, in the following, will also be referred to as the xy-coordinate of the center of the light beam.

Further, the position of the center of the light beam may allow for obtaining information regarding a transversal position and/or a relative direction of an object from which the light beam propagates towards the detector. Thus, the transversal position of the pixels of the matrix illuminated by the light beam is determined by determining one or more pixels having the highest illumination by the light beam. For this purpose, known imaging properties of the detector may be used. As an example, a light beam propagating from the object with the detector may directly impinge on a specific area, and from the location of this area or specifically from the position of the center of the light beam, a transversal position and/or a direction of the object may be derived. Optionally, the detector may comprise at least one transfer device, such as at least one lens or lens system, having optical properties. Since, typically, the optical properties of the transfer device are known, such as by using known imaging equations and/or geometric relationships known from ray optics or matrix optics, the position of the center of the light beam on the matrix of pixels may also be used for deriving information on a transversal position of the object in case one or more transfer devices are used. Thus, generally, the evaluation device may be adapted to identify one or more of a transversal position of an object from which the light beam propagates towards the detector and a relative direction of the object from which the light beam propagates towards the detector, by evaluating at least one of the transversal position of the light beam and the orientation of the light beam. In this regard, as an example, reference may also be made to one or more of the transversal optical sensors as disclosed in one or more of European patent application number EP 13171901.5, U.S. provisional application No. 61/739,173 or U.S. provisional application No. 61/749,964. Still, other options are feasible.

The evaluation device may further be adapted to derive one or more other items of information relating to the light beam and/or relating to a position of an object from which the light beam propagates towards the detector by further evaluating the results of the spectral analysis, specifically by evaluating the signal components. Thus, as an example, the evaluating device may be adapted to derive one or more items of information selected from the group consisting of: a position of an object from which the light beam propagates towards the detector; a transversal position of the light beam; a width of the light beam; a color of the light beam and/or spectral properties of the light beam; a longitudinal coordinate of the object from which the light beam propagates towards the detector. Examples of these items of information and deriving these items of information will be given in further detail below.

Thus, as an example, the evaluation device may be adapted to determine a width of the light beam by evaluating the signal components. Generally, as used herein, the term “width of the light beam” refers to an arbitrary measure of a transversal extension of a spot of illumination generated by the light beam on the matrix of pixels, specifically in a plane perpendicular to a local direction of propagation of the light beam, such as the above-mentioned z-axis. Thus, as an example, the width of the light beam may be specified by providing one or more of an area of the light spot, a diameter of the light spot, an equivalent diameter of the light spot, a radius of the light spot or an equivalent radius of the light spot. As an example, the so-called beam waist may be specified in order to determine the width of the light beam at the position of the optical sensor, as will be outlined in further detail below. Specifically, the evaluation device may be adapted to identify the signal components assigned to pixels being illuminated by the light beam and to determine the width of the light beam at the position of the optical sensor from known geometric properties of the arrangement of the pixels. Thus, specifically, in case the pixels of the matrix are located at known positions of the matrix, which typically is the case, the signal components of the respective pixels as derived by the frequency analysis may be transformed into a spatial distribution of illumination of the optical sensor by the light beam, thereby being able to derive at least one item of information regarding the width of the light beam at the position of the optical sensor.

In case the width of the light beam is known, the width may be used for deriving one or more items of information regarding the position of the object from which the light beam travels towards the detector. Thus, the evaluation device, using a known or determinable relationship between the width of the light beam and the distance between an object from which the light beam propagates towards the detector, may be adapted to determine a longitudinal coordinate of the object. For the general principle of deriving a longitudinal of an object by evaluating a width of a light beam, reference may be made to one or more of WO 20121110924 A1, EP 13171901.5, U.S. provisional application No. 61/739,173 or U.S. provisional application No. 61/749,964.

Thus, as an example, the evaluation device may be adapted to compare, for each of the pixels, the signal component of the respective pixel to at least one threshold in order to determine whether the pixel is an illuminated pixel or not. This at least one threshold may be an individual threshold for each of the pixels or may be a threshold which is a uniform threshold for the whole matrix. As will be outlined above, the threshold may be predetermined and/or fixed. Alternatively, the at least one threshold may be variable. Thus, the at least one threshold may be determined individually for each measurement or groups of measurements. Thus, at least one algorithm may be provided adapted to determine the threshold.

The evaluation device generally may be adapted to determine at least one pixel having the highest illumination out of the pixels by comparing the signals of the pixels. Thus, the detector generally may be adapted to determine one or more pixels and/or an area or region of the matrix having the highest intensity of the illumination by the light beam. As an example, in this way, a center of illumination by the light beam may be determined.

The highest illumination and/or the information about the at least one area or region of highest illumination may be used in various ways. Thus, as outlined above, the at least one above-mentioned threshold may be a variable threshold. As an example, the evaluation device may be adapted to choose the above-mentioned at least one threshold as a fraction of the signal of the at least one pixel having the highest illumination. Thus, the evaluation device may be adapted to choose the threshold by multiplying the signal of the at least one pixel having the highest illumination with a factor of 1/e². As will be outlined in further detail below, this option is particularly preferred in case Gaussian propagation properties are assumed for the at least one light beam, since the threshold 1/e² generally determines the borders of a light spot having a beam radius or beam waist w generated by a Gaussian light beam on the optical sensor.

The evaluation device may be adapted to determine the longitudinal coordinate of the object by using a predetermined relationship between the width of the light beam or, which is equivalent, the number N of the pixels which are illuminated by the light beam, and the longitudinal coordinate of the object. Thus, generally, the diameter of the light beam, due to propagation properties generally known to the skilled person, changes with propagation, such as with a longitudinal coordinate of the propagation. The relationship between the number of illuminated pixels and the longitudinal coordinate of the object may be an empirically determined relationship and/or may be analytically determined.

Thus, as an example, a calibration process may be used for determining the relationship between the width of the light beam and/or the number of illuminated pixels and the longitudinal coordinate. Additionally or alternatively, as mentioned above, the predetermined relationship may be based on the assumption of the light beam being a Gaussian light beam. The light beam may be a monochromatic light beam having a precisely one wavelength λ or may be a light beam having a plurality of wavelengths or a wavelength spectrum, wherein, as an example, a central wavelength of the spectrum and/or a wavelength of a characteristic peak of the spectrum may be chosen as the wavelength λ of the light beam.

As an example of an analytically determined relationship, the predetermined relationship, which may be derived by assuming Gaussian properties of the light beam, may be:

$$N ∼ π \cdot {w}_{0}^{2} \cdot ( 1 + {( \frac{z}{{z}_{0}} )}^{2} ) , \qquad ( 1 )$$

wherein z is the longitudinal coordinate,
wherein w₀ is a minimum beam radius of the light beam when propagating in space,
wherein z₀ is a Rayleigh-length of the light beam with z₀=π·w₀²/λ, λ being the wavelength of the light beam.

This relationship may generally be derived from the general equation of an intensity I of a Gaussian light beam traveling along a z-axis of a coordinate system, with r being a coordinate perpendicular to the z-axis and E being the electric field of the light beam:

I(r,z)=|E(r,z)²=I₀·(w₀/w(z))²·e^{-2r2}/w(z)² (2)

The beam radius w of the transversal profile of the Gaussian light beam generally representing a Gaussian curve is defined, for a specific z-value, as a specific distance from the z-axis at which the amplitude E has dropped to a value of 1/e (approx. 36%) and at which the intensity I has dropped to 1/e². The minimum beam radius, which, in the Gaussian equation given above (which may also occur at other z-values, such as when performing a z-coordinate transformation), occurs at coordinate z=0, is denoted by w₀. Depending on the z-coordinate, the beam radius generally follows the following equation when light beam propagates along the z-axis:

$$w ( z ) = {w}_{0} \cdot \sqrt{1 + {( \frac{z}{{z}_{0}} )}^{2}} \qquad ( 3 )$$

With the number N of illuminated pixels being proportional to the illuminated area A of the optical sensor:

N˜A (4)

or, in case a plurality of optical sensors i=1, . . . , n is used, with the number Nᵢ of illuminated pixels for each optical sensor being proportional to the illuminated area Aᵢ of the respective optical sensor

Nᵢ˜Aᵢ (4′)

and the general area of a circle having a radius w:

A=π·w², (5)

the following relationship between the number of illuminated pixels and the z-coordinate may be derived:

$$\begin{matrix}N ∼ π \cdot {w}_{0}^{2} \cdot ( 1 + {( \frac{z}{{z}_{0}} )}^{2} ) & ( 6 ) \\ or & \\ {N}_{i} ∼ π \cdot {w}_{0}^{2} \cdot ( 1 + {( \frac{z}{{z}_{0}} )}^{2} ) , & ( {6}^{′} )\end{matrix}$$

respectively, with z₀=π·w₀²/λ, as mentioned above. Thus, with N or Nᵢ, respectively, being the number of pixels within a circle being illuminated at an intensity o I≥I₀/e², as an example, N or Nᵢ may be determined by simple counting of pixels and/or other methods, such as a histogram analysis. In other words, a well-defined relationship between the z-coordinate and the number of illuminated pixels N or Nᵢ, respectively, may be used for determining the longitudinal coordinate z of the object and/or of at feast one point of the object, such as at least one longitudinal coordinate of at least one beacon device being one of integrated into the object and/or attached to the object.

In the equations given above, such as in equation (1), it is assumed that the light beam has a focus at position z=0. It shall be noted, however, that a coordinate transformation of thez-coordinate is possible, such as by adding and/or subtracting a specific value. Thus, as an example, the position of the focus typically is dependent on the distance of the object from the detector and/or on other properties of the light beam. Thus, by determining the focus and/or the position of the focus, a position of the object, specifically a longitudinal coordinate of the object, may be determined, such as by using an empirical and/or an analytical relationship between a position of the focus and a longitudinal coordinate of the object and/or the beacon device.

Further, imaging properties of the at least one optional transfer device, such as the at least one optional lens, may be taken into account. Thus, as an example, in case beam properties of the light beam being directed from the object towards the detector are known, such as in case emission properties of an illuminating device contained in a beacon device are known, by using appropriate Gaussian transfer matrices representing a propagation from the object to the transfer device, representing imaging of the transfer device and representing beam propagation from the transfer device to the at least one optical sensor, a correlation between a beam waist and a position of the object and/or the beacon device may easily be determined analytically. Additionally or alternatively, a correlation may empirically be determined by appropriate calibration measurements.

As outlined above, the matrix of pixels preferably may be a two-dimensional matrix. However, other embodiments are feasible, such as one-dimensional matrices. More preferably, as outlined above, the matrix of pixels is a rectangular matrix, in particular a square matrix.

As outlined above, the information derived by the frequency analysis may further be used to derive other types of information regarding the object and/or the light beam. As a further example of information which may be derived additionally or alternatively to transversal and/or longitudinal position information, color and/or spectral properties of the object and/or the light beam may be named.

As outlined above, one of the advantages of the present invention resides in the fact that a fine pixelation of the optical sensor may be avoided. Instead, the pixelated imaging device may be used, thereby, in fact, transferring the pixelation from the actual optical sensor to the imaging device. Specifically, the at least one optical sensor may be or may comprise at least one large-area optical sensor being adapted to detect a plurality of portions of the light beam passing through a plurality of the pixels. Thus, the at least one optical sensor may provide a single, non-segmented unitary sensor region adapted to provide a unitary sensor signal, wherein the sensor region is adapted to detect all portions of the light beam passing the imaging device, at least for light beams entering the detector and passing the parallel to the optical axis. As an example, the unitary sensor region may have a sensitive area of at least 25 mm², preferably of at least 100 mm² and more preferably of at least 400 mm². Still, other embodiments are feasible, such as embodiments having two or more sensor regions. Further, in case two or more optical sensors are used, the optical sensors do not necessarily have to be identical. Thus, one or more large-area optical sensors may be combined with one or more pixelated optical sensors, such as with one or more camera chips, e.g. one or more CCD- or CMOS-chips, as will be outlined in further detail below.

The at least one optical sensor or, in case a plurality of optical sensors is provided, at least one of the optical sensors preferably may be fully or partially transparent. Thus, generally, the at least one optical sensor may comprise at least one at least partially transparent optical sensor such that the light beam at least partially may pass through the parent optical sensor. As used herein, the term “at least partially transparent” may both refer to the option that the entire optical sensor is transparent or a part (such as a sensitive region) of the optical sensor is transparent and/or to the option that the optical sensor or at least a transparent part of the optical sensor may transmit the light beam in an attenuated or non-attenuated fashion. Thus, as an example, the transparent optical sensor may have a transparency of at least 10%, preferably at least 20%, at least 40%, at least 50% or at least 70%. The transparency may depend on the wavelength of the light beam, and the given transparencies may be valid for at least one wavelength in at least one of the infra-red spectral range, the visible spectral range and the ultraviolet spectral range. Generally, as used herein, the infrared spectral range refers to a range of 780 nm to 1 mm, preferably to a range of 780 nm to 50 μm, more preferably to a range of 780 nm to 3.0 μm. The visible spectral range refers to a range of 380 nm to 780 nm. Therein, the blue spectral range, including the violet spectral range, may be defined as 380 nm to 490 nm, wherein the pure blue spectral range may be defined as 430 to 490 nm. The green spectral range, including the yellow spectral range, may be defined as 490 nm to 600 nm, wherein the pure green spectral range may be defined as 490 nm to 470 nm. The red spectral range, including the orange spectral range, may be defined as 600 nm to 780 nm, wherein the pure red spectral range may be defined as 640 to 780 nm. The ultraviolet spectral range may be defined as 1 nm to 380 nm, preferably 50 nm to 380 nm, more preferably 200 nm to 380 nm.

In order to provide a sensory effect, generally, the optical sensor typically has to provide some sort of interaction between the light beam and the optical sensor which typically results in a loss of transparency. The transparency of the optical sensor may be dependent on a wavelength of the light beam, resulting in a spectral profile of a sensitivity, an absorption, or a transparency of the optical sensor. As outlined above, in case a plurality of optical sensors is provided, the spectral properties of the optical sensors do not necessarily have to be identical. Thus, one of the optical sensors may provide a strong absorption (such as one or more of an absorbance peak, an absorptivity peak or an absorption peak) in the red spectral region, another one of the optical sensors may provide a strong absorption in the green spectral region, and another one may provide a strong absorption in the blue spectral region. Other embodiments are feasible.

As outlined above, in case a plurality of optical sensors is provided, the optical sensors may form a stack. Thus, the at least one optical sensor comprises a stack of at least two optical sensors. At least one of the optical sensors of the stack may be an at least partially transparent optical sensor. Thus, preferably, the stack of optical sensors may comprise at least one at least partially transparent optical sensor and at least one further optical sensor which may be transparent or intransparent. Preferably, at least two transparent optical sensors are provided. Specifically, an optical sensor on a side furthest away from the focus-tunable lens may also be an intransparent optical sensor, such as an opaque sensor, wherein organic or inorganic optical sensors may be used, such as inorganic semiconductor sensors like CCD or CMOS chips.

As outlined above, the at least one optical sensor does not necessarily have to be a pixelated optical sensor. Thus, by using the general idea of performing the frequency analysis, a pixelation may be omitted. Still, specifically in case a plurality of optical sensors is provided, one or more pixelated optical sensors may be used. Thus, specifically in case a stack of optical sensors is used, at least one of the optical sensors of the stack may be a pixelated optical sensor having a plurality of light-sensitive pixels. As an example, the pixelated optical sensor may be a pixelated organic and/or inorganic optical sensor. Most preferably, specifically due to their commercial availability, the pixelated optical sensor may be an inorganic pixelated optical sensor, preferably a CCD chip or a CMOS chip. Thus, as an example, the stack may comprise one or more transparent large-area non-pixelated optical sensors, such as one or more DSCs and more preferably sDSCs (as will be outlined in further detail below), and at least one inorganic pixelated optical sensor, such as a CCD chip or a CMOS chip. As an example, the at least one inorganic pixelated optical sensor may be located on a side of the stack furthest away from the focus-tunable lens. Specifically, the pixelated optical sensor may be a camera chip and, more preferably, a full-color camera chip. Generally, the pixelated optical sensor may be color-sensitive, i.e. may be a pixelated optical sensor adapted to distinguish between color components of the light beam, such as by providing at least two different types of pixels, more preferably at least three different types of pixels, having a different color sensitivity. Thus, as an example, the pixelated optical sensor may be a full-color imaging device.

As further outlined above, the optical detector may contain one or more further devices, specifically one or more further optical devices such as one or more additional lenses and/or one or more reflecting devices. Thus, most preferably, the optical detector may comprise a setup, such as a setup arranged in a tubular fashion, the setup having the at least one focus-tunable lens and the at least one optical sensor, as well as, optionally, the at least one imaging device. As outlined above, the at least one optical sensor preferably may comprise a stack of at least two optical sensors, located behind the focus-tunable lens such that a light beam having passed the focus-tunable lens subsequently passes the one or more optical sensors. Preferably, before passing the focus-tunable lens the light beam may pass one or more optical devices such as one or more lenses, preferably one or more optical devices adapted for influencing a beam shape and/or a beam widening or narrowing in a well-defined fashion. Additionally or alternatively, one or more optical devices such as one or more lenses may be placed in between the focus-tunable lens and the at least one optical sensor.

The one or more optical devices generally may be referred to as a transfer device, since one of the purposes of the transfer device may reside in a well-defined transfer of the light beam into the optical detector. As used herein, consequently, the term “transfer device” generally refers to an arbitrary device or combination of devices adapted for guiding and/or feeding the light beam onto the optical detector and/or the at least one optical sensor, preferably by influencing one or more of a beam shape, a beam width or a widening angle of the light beam in a well-defined fashion, such as a lens or a curved mirror do. The at least one focus-tunable lens, as outlined above, or, in case a plurality of focus-tunable lenses is provided, one or more of the focus-tunable lenses, may be part of the at least one transfer device.

Thus, generally, the optical detector may further comprise at least one transfer device adapted for feeding light into the optical detector. The transfer device may be adapted to focus and/or collimate light onto the optical sensor. The transfer device specifically may comprise one or more devices selected from the group consisting of: a lens, a focusing mirror, a defocusing mirror, a reflector, a prism, an optical filter, a diaphragm. Other embodiments are feasible.

A further aspect of the present invention may refer to the option of image recognition, pattern recognition and individually determining z-coordinates of different regions of an image captured by the optical detector. Thus, generally, as outlined above, the optical detector may be adapted to capture at least one image, such as a 2D-image. For this purpose, as outlined above, the optical detector may comprise at least one imaging device such as at least one pixelated optical sensor. As an example, the at least one pixelated optical sensor may comprise at least one CCD sensor and/or at least one CMOS sensor. By using this at least one imaging device, the optical detector may be adapted to capture at least one regular two-dimensional image of a scene and/or at least one object. The at least one image may be or may comprise at least one monochrome image and/or at least one multi-chrome image and/or at least one full-color image. Further, the at least one image may be or may comprise a single image or may comprise a series of images.

Further, as outlined above, the optical detector may comprise at least one distance sensor adapted for determining a distance of at least one object from the optical detector, also referred to as a z-coordinate. Thus, specifically, the above-mentioned FiP-effect may be used. By using a combination of regular 2D-image capturing and the possibility of determining z-coordinates, 3D-imaging is feasible.

In order to individually evaluate one or more objects and/or components contained within a scene captured within the at least one image, the at least one image may be subdivided into two or more regions, wherein the two or more regions or at least one of the two or more regions may be evaluated individually. For this purpose, a frequency selective separation of the signals corresponding to the at least two regions may be performed.

Thus, generally, as outlined above, the optical detector, preferably the at least one evaluation device, may be adapted to individually determine z-coordinates for each of the regions or for at least one of the regions, such as for a region within the image which is recognized as a partial image, such as the image of an object. For determining the at least one z-coordinate, the FiP-effect may be used, as outlined in one or more of the above-mentioned prior art documents referring to the FiP-effect. Thus, the optical detector may comprise at least one FiP-sensor, i.e. at least one optical sensor having at least one sensor region, wherein the sensor signal of the optical sensor is dependent on an illumination of the sensor region by the light beam, wherein the sensor signal, given the same total power of the illumination, is dependent on a width of the light beam in the sensor region. An individual FiP-sensor may be used or, preferably, a stack of FiP-sensors, i.e. a stack of optical sensors having the named properties. The evaluation device of the optical detector may be adapted to determine the z-coordinates for at least one of the regions or for each of the regions, by individually evaluating the sensor signal in a frequency-selective way.

In order to make use of at least one FiP-sensor within the optical detector, various setups may be used for combining the at least one FiP-sensor and the at least one imaging device such as the at least one pixelated sensor, preferably the at least one CCD or CMOS sensor. Thus, generally, the named elements may be arranged in one and the same beam path of the optical detector or may be distributed over two or more partial beam paths. As outlined above, optionally, the optical detector may contain at least one beam-splitting element adapted for dividing a beam path of the light beam into at least two partial beam paths. Thereby, the at least one imaging device for capturing the 2D image and the at least one FiP-sensor may be arranged in different partial beam paths. Thus, the at least one optical sensor having the at least one sensor region, the sensor signal of the optical sensor being dependent on the illumination of the sensor region by the light beam, the sensor signal, given the same total power of the illumination, being dependent on the width of the light beam in the sensor region, (i.e. the at least one FiP-sensor) may be arranged in a first partial beam path of the beam paths, and at least one pixelated optical sensor for capturing the at least one image (i.e. the at least one imaging device), preferably the at least one inorganic pixelated optical sensor and more preferably the at least one of a CCD sensor and/or CMOS sensor, may be arranged in a second partial beam path of the beam paths.

As outlined above, the at least one light beam may fully or partially originate from the object itself and/or from at least one additional illumination source, such as an artificial illumination source and/or a natural illumination source. Thus, the object may be illuminated with at least one primary light beam, and the actual light beam propagating towards the optical detector may be or may comprise a secondary light beam generated by reflection, such as elastic and/or inelastic reflection, of the primary light beam at the object and/or by scattering. Non-limiting examples of objects which are detectable by reflections are reflections of sunlight, artificial light in eyes, on surfaces, etc. Non-limiting examples of objects from which the at least one light beam originates fully or partially from the object itself are engine exhausts in cars or planes. As outlined above, eye reflections might be especially useful for eye-trackers.

Further, as outlined above, the optical detector comprises at least one modulator device. The optical detector, however, additionally or alternatively may make use of a given modulation of the light beam. Thus, in many instances, the light beam already exhibits a given modulation. The modulation, as an example, may originate from a movement of the object, such as a periodic modulation, and/or from a modulation of a light source or illumination source generating the light beam. Thus, non-limiting examples for moving objects adapted to generate modulated light such as by reflection and/or scattering are objects that are modulated by themselves, such as rotors of wind turbines or planes. Non-limiting examples of illumination sources adapted to generate modulated light are fluorescent lamps or reflections of fluorescent lamps.

The optical detector may be adapted to detect given modulations of the at least one light beam. As an example, the optical detector may be adapted to determine at least one object or at least one part of an object within an image or a scene captured by the optical detector that emits or reflects modulated light, such as light having at least one modulation frequency. If this is the case, the optical detector may be adapted to make use of this given modulation, without additionally modulating the already modulated light. As an example, the optical detector may be adapted to determine if at least one object within an image or a scene captured by the optical detector emits or reflects modulated light. The optical detector, specifically the evaluation device, may further be adapted to determine and/or track the position and/or orientation of said object by using the modulation frequency. Thus, as an example, the detector may be adapted to avoid modulation for the object, such as by switching the modulation device to an “open” position. The evaluation device could then track the frequency of the lamp.

As outlined above, the optical detector generally may comprise at least one imaging device and/or may be adapted to capture at least one image, such as at least one image of a scene within a field of view of the optical detector. By using one or more image evaluation algorithms, such as generally known pattern detection algorithms and/or software image evaluation means generally known to the skilled person, the optical detector may be adapted to detect at least one object in the at least one image. Thus, as an example, in traffic technology, the detector and, more specifically, the evaluation device, may be adapted to search for specific predefined patterns within an image, such as one or more of the following: the contour of a car; the contour of another vehicle; the contour of a pedestrian; street signs; signals; landmarks for navigation. The detector may also be used in combination with global or local positioning systems. Similarly, for biometrical purposes such as for the purpose of recognition and/or tracking of persons, the detector and, more specifically, the evaluation device, may be adapted for searching a contour of a face, eyes, earlobes, lips, noses, fingers, hands, fingertips, or profiles thereof. Other embodiments are feasible.

In case one or more objects are detected, the optical detector might be adapted to track the object in a series of images, such as an ongoing movie or film of the scene. Thus, generally, the optical detector, specifically the evaluation device, may be adapted to track and/or follow the at least one object within a series of images, such as a series of subsequent images.

The optical detector according to the present invention may further be embodied to acquire three-dimensional images. Thus, specifically, a simultaneous acquisition of images in different planes perpendicular to an optical axis may be performed, i.e. an acquisition of images in different focal planes. Thus, specifically, the optical detector may be embodied as a light-field camera adapted for acquiring images in multiple focal planes, such as simultaneously. The term light-field, as used herein, generally refers to the spatial light propagation of light inside the camera. Contrarily, in commercially available plenoptic or light-field cameras, micro-lenses may be placed on top of an optical detector. These micro-lenses allow for recording a direction of light beams, and, thus, for recording pictures in which a focus may be changed a posteriori. However, the resolution of a camera with micro-lenses is generally reduced by approximately a factor of ten as compared to conventional cameras. A post-processing of the images is required in order to calculate pictures which are focused on various distances. Another disadvantage of current light-field cameras is the necessity of using a large number of micro-lenses which typically have to be manufactured on top of an imaging chip such as a CMOS chip.

By using the optical detector according to the present invention, a greatly simplified light-field camera may be produced, without the necessity of using micro-lenses. Specifically, a single lens or lens system may be used. The evaluation device may be adapted for intrinsic depth-calculation and simple and intrinsic creation of a picture that is focused on a plurality of levels or even on all levels.

These advantages may be achieved by using a multiplicity of the optical sensors. Thus, as outlined above, the optical detector may comprise at least one stack of optical sensors. The optical sensors of the stack or at least several of the optical sensors of the stack preferably are at least partially transparent. Thus, as an example, pixelated optical sensors or large area optical sensors may be used within the stack. As an example for potential embodiments of optical sensors, reference may be made to the organic optical sensors, specifically to the organic solar cells and, more specifically, to the DSC optical sensors or sDSC optical sensors as disclosed above or as disclosed in further detail below. Thus, as an example, the stack may comprise a plurality of FiP sensors as disclosed e.g. In WO 2012/110924 A1, US 2012/0206336 A1, WO 2014/097181 A1 or US 2014/0291480 A1 or in any other of the FiP-related documents discussed above, i.e. a plurality of optical sensors with photon density-dependent photocurrents for depth detection. Thus, specifically, the stack may be a stack of transparent dye-sensitized organic solar cells. As an example, the stack may comprise at least two, preferably at least three, more preferably at least four, at least five, at least six or even more optical sensors, such as 2-30 optical sensors, preferably 4-20 optical sensors. Other embodiments are feasible. By using the stack of optical sensors, the optical detector, specifically the at least one evaluation device, may be adapted to acquire a three-dimensional image of a scene within a field of view of the optical detector, such as by acquiring images at different focal depths, preferably simultaneously, wherein the different focal depths generally may be defined by a position of the optical sensors of the stack along an optical axis of the optical detector. Even though a pixelation of the optical sensors generally may be present, a pixelation is, however, generally not required. Thus, as an example, a stack of organic solar cells, such as a stack of sDSCs, may be used, without the necessity of subdividing the organic solar cells into pixels.

In general, a depth map may be recorded by using signals produced by the stack of optical sensors and, additionally, by recording a two-dimensional image by using the at least one optional imaging device. A plurality of two-dimensional images at different distances from the transfer device, such as from the lens, may be recorded. Thus, a depth map may be recorded by a stack of solar cells, such as a stack of organic solar cells, and by further recording a two-dimensional image by using the imaging device such as the at least one optional CCD chip and/or CMOS chip. The two-dimensional image may then be matched with the signals of the stack in order to obtain a three-dimensional image. By evaluating sensor signals of the optical sensors, such as by demodulating the sensor signals and/or by performing a frequency analysis as discussed above, two-dimensional pictures may be derived from each optical sensor signal. Thereby, a two-dimensional image for each of the optical sensors may be reconstructed. Using a stack of optical sensors, such as a stack of transparent solar cells, therefore allows for recording two-dimensional images acquired at different positions along an optical axis of the optical detector, such as at different focal positions. The acquisition of the plurality of two-dimensional optical images may be performed simultaneously and/or instantaneously.

Consequently, the optical detector including the at least one focus-tunable lens and the at least one optical sensor, such as the stack of optical sensors, may be adapted to determine at least one, preferably at least two or more beam parameters for at least one light beam, preferably for two beams or more than two light beams, and may be adapted to store these beam parameters for further use. Further, the optical detector, specifically the evaluation device, may be adapted for calculating images or partial images of a scene captured by the optical detector by using these beam parameters, such as by using the above-mentioned vector representation.

Thus, generally, the optical detector may comprise a stack of optical sensors, wherein the optical sensors of the stack have differing spectral properties. Specifically, the stack may comprise at least one first optical sensor having a first spectral sensitivity and at least one second optical sensor having a second spectral sensitivity, wherein the first spectral sensitivity and the second spectral sensitivity are different. The stack, as an example, may comprise optical sensors having differing spectral properties in an alternating sequence. The optical detector may be adapted to acquire a multicolor three-dimensional image, preferably a full-color three-dimensional image, by evaluating sensor signals of the optical sensors having differing spectral properties.

This option of color resolution provides a large number of advantages over known color sensitive camera setups. Thus, by using optical sensors in a stack, the optical sensors having differing spectral sensitivities, the full sensor area of each sensor may be used for detection, as compared to a pixelated full-color camera such as full-color CCD or CMOS chips. Thereby, the resolution of the images may significantly be increased, since typical pixelated full-color camera chips may only use one third or one fourth or even less of the chip surface for imaging, due to the fact that colored pixels have to be provided in a neighboring arrangement.

The at least two optional optical sensors having differing spectral sensitivities may contain different types of dyes, specifically when using organic solar cells, more specifically sDSCs. Therein, stacks containing two or more types of optical sensors, each type having a uniform spectral sensitivity, may be used. Thus, the stack may contain at least one optical sensor of a first type, having a first spectral sensitivity, and at least one optical sensor of a second type, having a second spectral sensitivity. Further, the stack may optionally contain a third type and optionally even a fourth type of optical sensors having third and fourth spectral sensitivities, respectively. The stack may contain optical sensors of the first and second type in an alternating fashion, optical sensors of the first, second and third type in an alternating fashion or even sensors of the first, second, third and fourth type in an alternating fashion.

Thus, a color detection or even an acquisition of full-color images may be possible with optical sensors of a first type and a second type only, such as in an alternating fashion. Thus, as an example, the stack may contain organic solar cells, specifically sDSCs, of a first type, having a first absorbing dye, and organic solar cells, specifically sDSCs, of a second type, having a second absorbing dye. The organic solar cells of the first and second type may be arranged in an alternating fashion within the stack. The dyes specifically may be broadly absorbing, such as by providing an absorption spectrum having at least one absorption peak and the broad absorption covering a range of at least 30 nm, preferably of at least 100 nm, of at least 200 nm or of at least 300 nm, such as having a width of 30-200 nm and/or a width of 60-300 nm and or a width of 100-400 nm.

Thus, two broadly absorbing dyes may be sufficient for color detection. Using two broadly absorbing dyes with different absorption profiles in a transparent or semi-transparent solar cell, different wavelengths will cause different sensor signals such as different currents, due to the complex wavelength dependency of the photon-to-current efficiency (PCE). The color can be determined by comparing the currents of two solar cells with different dyes.

Thus, generally, the optical detector having the plurality of optical sensors such as a stack of optical sensors with at least two optical sensors having different spectral sensitivities, may be adapted to determine at least one color and/or at least one item of color information by comparing sensor signals of the at least two optical sensors having different spectral sensitivities. As an example, an algorithm may be used for determining the color of color information from the sensor signals. Additionally or alternatively, other ways of evaluating the sensor signals may be used, such as a lookup tables. As an example, a look-up table can be created in which, for each pair of sensor signals, such as for each pair of currents, a unique color is listed. Additionally or alternatively, other evaluation schemes may be used, such as by forming a quotient of the optical sensor signals and deriving a color, a color information or color coordinate thereof.

By using a stack of optical sensors having differing spectral sensitivities, such as a stack of pairs of optical sensors having two different spectral sensitivities, a variety of measurements may be taken. Thus, as an example, by using the stack, a recording of a three-dimensional multicolor or even full-color image is feasible, and/or a recording of an image in several focal planes. Further, depth images can be calculated using depth-from-defocus algorithms.

By using two types of optical sensors having differing spectral sensitivities, a missing color information may be extrapolated between surrounding color points. A smoother function can be obtained by taking more than only surrounding points into account. This may also be used for reducing measurement errors, while computational costs for post-processing increase.

Color information in-plane may be obtained from sensor signals of two neighboring optical sensors of the stack, neighboring optical sensors having different spectral sensitivity, such as different colors, more specifically different types of dyes. As outlined above, the color information may be generated by an evaluation algorithm evaluating the sensor signals of the optical sensors having different wavelength sensitivities, such as by using one or more look-up tables. Further, a smoothing of the color information may be performed, such as in a post-processing step, by comparing colors of neighboring areas. The color information in z-direction, i.e. along the optical axis, can also be obtained by comparing neighboring optical sensors and the stack, such as neighboring solar cells in the stack. Smoothing of the color information can be done using color information from several optical sensors.

The optical detector according to the present invention, comprising the at least one focus-tunable lens, the optical sensor and the at least one imaging device may further be combined with one or more other types of sensors or detectors. Thus, the optical detector may further comprise at least one additional detector. The at least one additional detector may be adapted for detecting at least one parameter, such as at least one of: a parameter of a surrounding environment, such as a temperature and/or a brightness of a surrounding environment; a parameter regarding a position and/or orientation of the detector; a parameter specifying a state of the object to be detected, such as a position of the object, e.g. an absolute position of the object and/or an orientation of the object in space. Thus, generally, the principles of the present invention may be combined with other measurement principles in order to gain additional information and/or in order to verify measurement results or reduce measurement errors or noise.

Specifically, the optical detector according to the present invention may further comprise at least one time-of-flight (ToF) detector adapted for detecting at least one distance between the at least one object and the optical detector by performing at least one time-of-flight measurement. As used herein, a time-of-flight measurement generally refers to a measurement based on a time a signal needs for propagating between two objects or from one object to a second object and back. In the present case, the signal specifically may be one or more of an acoustic signal or an electromagnetic signal such as a light signal. A time-of-flight detector consequently refers to a detector adapted for performing a time-of-flight measurement. Time-of-flight measurements are well-known in various fields of technology such as in commercially available distance measurement devices or in commercially available flow meters, such as ultrasonic flow meters. Time-of-flight detectors even may be embodied as time-of-flight cameras. These types of cameras are commercially available as range-imaging camera systems, capable of resolving distances between objects based on the known speed of light.

Presently available ToF detectors generally are based on the use of a pulsed signal, optionally in combination with one or more light sensors such as CMOS-sensors. A sensor signal produced by the light sensor may be integrated. The integration may start at two different points in time. The distance may be calculated from the relative signal intensity between the two integration results.

Further, as outlined above, ToF cameras are known and may generally be used, also in the context of the present invention. These ToF cameras may contain pixelated light sensors. However, since each pixel generally has to allow for performing two integrations, the pixel construction generally is more complex and the resolutions of commercially available ToF cameras is rather low (typically 200×200 pixels). Distances below −40 cm and above several meters typically are difficult or impossible to detect. Furthermore, the periodicity of the pulses leads to ambiguous distances, as only the relative shift of the pulses within one period is measured.

ToF detectors, as standalone devices, typically suffer from a variety of shortcomings and technical challenges. Thus, in general, ToF detectors and, more specifically, ToF cameras suffer from rain and other transparent objects in the light path, since the pulses might be reflected too early, objects behind the raindrop are hidden, or in partial reflections the integration will lead to erroneous results. Further, in order to avoid errors in the measurements and in order to allow for a clear distinction of the pulses, low light conditions are preferred for ToF-measurements. Bright light such as bright sunlight can make a ToF-measurement impossible. Further, the energy consumption of typical ToF cameras is rather high, since pulses must be bright enough to be back-reflected and still be detectable by the camera. The brightness of the pulses, however, may be harmful for eyes or other sensors or may cause measurement errors when two or more ToF measurements interfere with each other. In summary, current ToF detectors and, specifically, current ToF-cameras suffer from several disadvantages such as low resolution, ambiguities in the distance measurement, limited range of use, limited light conditions, sensitivity towards transparent objects in the light path, sensitivity towards weather conditions and high energy consumption. These technical challenges generally lower the aptitude of present ToF cameras for daily applications such as for safety applications in cars, cameras for daily use or human-machine-interfaces, specifically for use in gaming applications.

In combination with the detector according to the present invention, providing at least one focus-tunable lens, the at least one optical sensor and the at least one imaging device, as well as the above-mentioned principles of evaluating the sensor signal, such as by frequency analysis, the advantages and capabilities of both systems may be combined in a fruitful way. Thus, the optical detector, i.e. the combination of the at least one focus-tunable lens, the at least one optical sensor as well as the at least one imaging device, may provide advantages at bright light conditions, while the ToF detector generally provides better results at low-light conditions. A combined device, i.e, an optical detector according to the present invention further including at least one ToF detector, therefore provides increased tolerance with regard to light conditions as compared to both single systems. This is especially important for safety applications, such as in cars or other vehicles.

Specifically, the optical detector may be designed to use at least one ToF measurement for correcting at least one measurement performed by using the optical detector of the present invention and vice versa. Further, the ambiguity of a ToF measurement may be resolved by using the optical detector according to the present invention. A FiP measurement specifically may be performed whenever an analysis of ToF measurements results in a likelihood of ambiguity. Additionally or alternatively, FiP measurements may be performed continuously in order to extend the working range of the ToF detector into regions which are usually excluded due to the ambiguity of ToF measurements. Additionally or alternatively, the FiP detector may cover a broader or an additional range to allow for a broader distance measurement region. The FiP detector, specifically the FiP camera, may further be used for determining one or more important regions for measurements to reduce energy consumption or to protect eyes. Additionally or alternatively, the FiP detector may be used for determining a rough depth map of one or more objects within a scene captured by the optical detector, wherein the rough depth map may be refined in important regions by one or more ToF measurements. Further, the FiP detector may be used to adjust the ToF detector, such as the ToF camera, to the required distance region. Thereby, a pulse length and/or a frequency of the ToF measurements may be pre-set, such as for removing or reducing the likelihood of ambiguities in the ToF measurements. Thus, generally, the FiP detector may be used for providing an autofocus for the ToF detector, such as for the ToF camera.

As outlined above, a rough depth map may be recorded by the FiP detector, such as the FiP camera. Further, the rough depth map, containing depth information or z-information regarding one or more objects within a scene captured by the optical detector, may be refined by using one or more ToF measurements. The ToF measurements specifically may be performed only in important regions. Additionally or alternatively, the rough depth map may be used to adjust the ToF detector, specifically the ToF camera.

Further, the use of the FiP detector in combination with the at least one ToF detector may solve the above-mentioned problem of the sensitivity of ToF detectors towards the nature of the object to be detected or towards obstacles or media within the light path between the detector and the object to be detected, such as the sensitivity towards rain or weather conditions. A combined FiP/ToF measurement may be used to extract the important information from ToF signals, or measure complex objects with several transparent or semi-transparent layers. Thus, objects made of glass, crystals, liquid structures, phase transitions, liquid motions, etc. may be observed. Further, the combination of a FiP detector and at least one ToF detector will still work in rainy weather, and the overall optical detector will generally be less dependent from weather conditions. As an example, measurement results provided by the FiP detector may be used to remove the errors provoked by rain from ToF measurement results, which specifically renders this combination useful for safety applications such as in cars or other vehicles.

The implementation of at least one ToF detector into the optical detector according to the present invention may be realized in various ways. Thus, the at least one FiP detector and the at least one ToF detector may be arranged in a sequence, within the same light path. Additionally or alternatively, separate light paths or split light paths for the FiP detector and the ToF detector may be used. Therein, as an example, light paths may be separated by one or more beam-splitting elements, such as one or more of the beam-splitting elements listed above and listed in further detail below. As an example, a separation of beam paths by wavelength-selective elements may be performed. Thus, e.g., the ToF detector may make use of infrared light, whereas the FiP detector may make use of light of a different wavelength. In this example, the infrared light for the ToF detector may be separated off by using a wavelength-selective beam-splitting element such as a hot mirror. Additionally or alternatively, light beams used for the FiP measurement and light beams used for the ToF measurement may be separated by one or more beam-splitting elements, such as one or more semitransparent mirrors, beam splitter cubes, polarization beam splitters or combinations thereof. Further, the at least one FiP detector and the at least one ToF detector may be placed next to each other in the same device, using distinct optical pathways. Various other setups are feasible.

As outlined above, the optical detector according to the present invention as well as one or more of the other devices as proposed within the present invention may be combined with one or more other types of measurement devices. Thus, as a non-limiting example, the optical detector, as an example, may further comprise at least one distance sensor other than the above-mentioned ToF detector, in addition or as alternatives to the at least one optional ToF detector. The distance sensor, for instance, may be based on the above-mentioned FiP-effect. Consequently, the optical detector may further comprise at least one active distance sensor. As used herein, an “active distance sensor” is a sensor having at least one active optical sensor and at least one active illumination source, wherein the active distance sensor is adapted to determine a distance between an object and the active distance sensor. The active distance sensor comprises at least one active optical sensor adapted to generate a sensor signal when illuminated by a light beam propagating from the object to the active optical sensor, wherein the sensor signal, given the same total power of the illumination, is dependent on a geometry of the illumination, in particular on a beam cross section of the illumination on the sensor area. The active distance sensor further comprises at least one active illumination source for illuminating the object. Thus, the active illumination source may illuminate the object, and illumination light or a primary light beam generated by the illumination source may be reflected or scattered by the object or parts thereof, thereby generating a light beam propagating towards the optical sensor of the active distance sensor.

For possible setups of the at least one active optical sensor of the active distance sensor, reference may be made to one or more of WO 2012/110924 A1 or WO2014/097181 A1, the full content of which is herewith included by reference. The at least one longitudinal optical sensor disclosed in one or both of these documents may also be used for the optional active distance sensor which may be included into the optical detector according to the present invention.

As outlined above, the active distance sensor and the remaining components of the optical detector may be separate components or may come alternatively, fully or partially integrated. Consequently, the at least one active optical sensor of the active distance sensor may fully or partially be separate from the at least one optical sensor or might fully or partially be identical to the at least one optical sensor of the optical detector. Similarly, the at least one active illumination source may fully or partially be separate from the illumination source of the optical detector or may fully or partially be identical.

The at least one active distance sensor may further comprise at least one active evaluation device which may fully or partially be identical to the evaluation device of the optical detector or which may be a separate device. The at least one active evaluation device may be adapted to evaluate the at least one sensor signal of the at least one active optical sensor and to determine a distance between the object and the active distance sensor. For this evaluation, a predetermined or determinable relationship between the at least one sensor signal and the distance may be used, such as a predetermined relationship determined by empirical measurements and/or a predetermined relationship fully or partially based on a theoretical dependency of the sensor signal on the distance. For potential embodiments of this evaluation, reference may be made to one or more of WO 20121110924 A1 or WO2014/097181 A1, the full content of which is herewith included by reference.

The at least one active illumination source may be a modulated illumination source or a continuous illumination source. For potential embodiments of this active illumination source, reference may be made to the options disclosed above in the context of the illumination source. Specifically, the at least one active optical sensor may be adapted such that the sensor signal generated by this at least one active optical sensor is dependent on a modulation frequency of the light beam.

The at least one active illumination source may illuminate the at least one object in an on-axis fashion, such that the illumination light propagates towards the object on an optical axis of the optical detector and/or the active distance sensor. Additionally or alternatively, the at least one illumination source may be adapted to illuminate the at least one object in an off-axis fashion, such that the illumination light propagating towards the object and the light beam propagating from the object to the active distance sensor are oriented in a non-parallel fashion.

The active illumination source may be a homogeneous illumination source or may be a patterned or structured illumination source. Thus, as an example, the at least one active illumination source may be adapted to illuminate a scene or a part of a scene captured by the optical detector with homogeneous light and/or with patterned light. Thus, as an example, one or more light patterns may be projected into the scene and/or into a part of the scene, whereby a contrast of detection of the at least one object may be increased. As an example, line patterns or point patterns, such as rectangular line patterns and/or a rectangular matrix of light points may be projected into the scene or into a part of the scene. For generating light patterns, the at least one active illumination source by itself may be adapted to generate patterned light and/or one or more light-patterning devices may be used, such as filters, gratings, mirrors or other types of light-patterning devices. Additionally or alternatively, other types of patterning devices may be used.

The combination of the optical detector according to the present invention, also referred to as the FiP detector, having the at least one focus-tunable lens and the at least one optical FiP sensor, as well as, optionally, the at least one imaging device, with the at least one optional active distance sensor provides a plurality of advantages. Thus, a combination with a structured active distance sensor, such as an active distance sensor having at least one patterned or structured active illumination source, may render the overall system more reliable. As an example, when the above-mentioned principle of the optical detector, using the optical sensor, the modulation of the pixels, should fail to work properly, such as due to low contrast of the scene captured by the optical detector, the active distance sensor may be used. Contrarily, when the active distance sensor fails to work properly, such as due to reflections of the at least one active illumination source on transparent objects due to fog or rain, the basic principle of the optical detector using the modulation of pixels may still resolve objects with proper contrast. Consequently, as for the time-of-flight detector, the active distance sensor may improve reliability and stability of measurements generated by the optical detector.

As outlined above, the optical detector may comprise one or more beam-splitting elements adapted for splitting a beam path of the optical detector into two or more partial beam paths. Various types of beam-splitting elements may be used, such as prisms, gratings, semi-transparent mirrors, beam splitter cubes, a reflective spatial light modulator, or combinations thereof. Other possibilities are feasible.

The beam-splitting element may be adapted to divide the light beam into at least two portions having identical intensities or having different intensities. In the latter case, the partial light beams and their intensities may be adapted to their respective purposes. Thus, in each of the partial beam paths, one or more optical elements, such as one or more optical sensors may be located. By using at least one beam-splitting element adapted for dividing the light beam into at least two portions having identical or different intensities, the intensities of the partial light beams may be adapted to the specific requirements of the at least two optical sensors.

The beam-splitting element specifically may be adapted to divide the light beam into a first portion traveling along a first partial beam path and at least one second portion traveling along at least one second partial beam path, wherein the first portion has a lower intensity than the second portion. The optical detector may contain at least one imaging device, preferably an inorganic imaging device, more preferably a CCD chip and/or a CMOS chip. Since, typically, imaging devices require lower light intensities as compared to other optical sensors, e.g. as compared to the at least one longitudinal optical sensor, such as the at least one FiP sensor, the at least one imaging device specifically may be located in the first partial beam path. The first portion, as an example, may have an intensity of lower than one half the intensity of the second portion. Other embodiments are feasible.

The intensities of the at least two portions may be adjusted in various ways, such as by adjusting a transmissivity and/or reflectivity of the beam-splitting element, by adjusting a surface area of the beam-splitting element or by other ways. The beam-splitting element generally may be or may comprise a beam-splitting element which is indifferent regarding a potential polarization of the light beam. Still, however, the at least one beam-splitting element also may be or may comprise at least one polarization-selective beam-splitting element. Various types of polarization-selective beam-splitting elements are generally known in the art. Thus, as an example, the polarization-selective beam-splitting element may be or may comprise a polarization beam splitter cube. Polarization-selective beam-splitting elements generally are favorable in that a ratio of the intensities of the partial light beams may be adjusted by adjusting a polarization of the light beam entering the polarization-selective beam-splitting element.

The optical detector may be adapted to at least partially back-reflect one or more partial light beams traveling along the partial beam paths towards the beam-splitting element. Thus, as an example, the optical detector may comprise one or more reflective elements adapted to at least partially back-reflect a partial light beam towards the beam-splitting element. The at least one reflective element may be or may comprise at least one mirror. Additionally or alternatively, other types of reflective elements may be used, such as reflective prisms and/or the at least one spatial light modulator which, specifically, may be a reflective spatial light modulator and which may be arranged to at least partially back-reflect a partial light beam towards the beam-splitting element. The beam-splitting element may be adapted to at least partially recombine the back-reflected partial light beams in order to form at least one common light beam. The optical detector may be adapted to feed the re-united common light beam into at least one optical sensor, preferably into at least one longitudinal optical sensor, specifically at least one FiP sensor, more preferably into a stack of optical sensors such as a stack of FiP sensors.

In a further aspect of the present invention, a detector system for determining a position of at least one object is disclosed. The detector system comprises at least one optical detector according to the present invention, such as according to one or more of the embodiments disclosed above or disclosed in further detail below. The detector system further comprises at least one beacon device adapted to direct at least one light beam towards the optical detector, wherein the beacon device is at least one of attachable to the object, holdable by the object and integratable into the object.

As used herein, a “detector system” generally refers to a device or arrangement of devices interacting to provide at least one detector function, preferably at least one optical detector function, such as at least one optical measurement function and/or at least one imaging off-camera function. The detector system may comprise at least one optical detector, as outlined above, and may further comprise one or more additional devices. The detector system may be integrated into a single, unitary device or may be embodied as an arrangement of a plurality of devices interacting in order to provide the detector function.

The detector system further comprises at least one beacon device adapted to direct at least one light beam towards the detector. As used herein and as will be disclosed in further detail below, a “beacon device” generally refers to an arbitrary device adapted to direct at least one light beam towards the detector. The beacon device may fully or partially be embodied as an active beacon device, comprising at least one illumination source for generating the light beam. Additionally or alternatively, the beacon device may fully or partially be embodied as a passive beacon device comprising at least one reflective element adapted to reflect a primary light beam generated independently from the beacon device towards the detector.

The beacon device is at least one of attachable to the object, holdable by the object and integratable into the object. Thus, the beacon device may be attached to the object by an arbitrary attachment means, such as one or more connecting elements. Additionally or alternatively, the object may be adapted to hold the beacon device, such as by one or more appropriate holding means. Additionally or alternatively, again, the beacon device may fully or partially be integrated into the object and, thus, may form part of the object or even may form the object.

Generally, with regard to potential embodiments of the beacon device, reference may be made to one or more of U.S. provisional applications 61/739,173, filed on Dec. 19, 2012, 61/749,964, filed on Jan. 8, 2013, and 61/867,169 filed on August 2013 and/or to European patent application number EP 13171901.5, or international patent application number PCT/IB2013/061095 or U.S. patent application Ser. No. 14/132,570, both filed on Dec. 18, 2013. Still, other embodiments are feasible.

As outlined above, the beacon device may fully or partially be embodied as an active beacon device and may comprise at least one illumination source. Thus, as an example, the beacon device may comprise a generally arbitrary illumination source, such as an illumination source selected from the group consisting of a light-emitting diode (LED), a light bulb, an incandescent lamp and a fluorescent lamp. Other embodiments are feasible.

Additionally or alternatively, as outlined above, the beacon device may fully or partially be embodied as a passive beacon device and may comprise at least one reflective device adapted to reflect a primary light beam generated by an illumination source independent from the object. Thus, in addition or alternatively to generating the light beam, the beacon device may be adapted to reflect a primary light beam towards the detector.

In case an additional illumination source is used by the optical detector, the at least one illumination source may be part of the optical detector. Additionally or alternatively, other types of illumination sources may be used. The illumination source may be adapted to fully or partially illuminate a scene. Further, the illumination source may be adapted to provide one or more primary light beams which are fully or partially reflected by the at least one beacon device. Further, the illumination source may be adapted to provide one or more primary light beams which are fixed in space and/or to provide one or more primary light beams which are movable, such as one or more primary light beams which scan through a specific region in space. Thus, as an example, one or more illumination sources may be provided which are movable and/or which comprise one or more movable mirrors to adjust or modify a position and/or orientation of the at least one primary light beam in space, such as by scanning the at least one primary light beam through a specific scene captured by the optical detector. In case one or more movable mirrors are used, the movable mirror may also comprise one or more spatial light modulators, such as one or more micro-mirrors.

The detector system may comprise one, two, three or more beacon devices. Thus, generally, in case the object is a rigid object which, at least on a microscope scale, does not change its shape, preferably, at least two beacon devices may be used. In case the object is fully or partially flexible or is adapted to fully or partially change its shape, preferably, three or more beacon devices may be used. Generally, the number of beacon devices may be adapted to the degree of flexibility of the object. Preferably, the detector system comprises at least three beacon devices.

The object itself may be part of the detector system or may be independent from the detector system. Thus, generally, the detector system may further comprise the at least one object. One or more objects may be used. The object may be a rigid object and/or a flexible object.

The object generally may be a living or non-living object. The detector system even may comprise the at least one object, the object thereby forming part of the detector system. Preferably, however, the object may move independently from the detector, in at least one spatial dimension.

The object generally may be an arbitrary object. In one embodiment, the object may be a rigid object. Other embodiments are feasible, such as embodiments in which the object is a non-rigid object or an object which may change its shape.

As will be outlined in further detail below, the present invention may specifically be used for tracking positions and/or motions of a person, such as for the purpose of controlling machines, gaming or simulation of sports. In this or other embodiments, specifically, the object may be selected from the group consisting of: an article of sports equipment, preferably an article selected from the group consisting of a racket, a club, a bat; an article of clothing; a hat; a shoe.

The optional transfer device can, as explained above, be designed to feed light propagating from the object to the optical detector. As explained above, this feeding can optionally be effected by means of imaging or else by means of non-imaging properties of the transfer device. In particular the transfer device can also be designed to collect the electromagnetic radiation before the latter is fed to the optical sensor. The optional transfer device can also be wholly or partly a constituent part of at least one optional illumination source, for example by the illumination source being designed to provide a light beam having defined optical properties, for example having a defined or precisely known beam profile, for example at least one Gaussian beam, in particular at least one laser beam having a known beam profile.

For potential embodiments of the optional illumination source, reference may be made to WO 2012/110924 A1. Still, other embodiments are feasible. Light emerging from the object can originate in the object itself, but can also optionally have a different origin and propagate from this origin to the object and subsequently toward the optical sensor. The latter case can be effected, for example, by at least one illumination source being used. This illumination source can, for example, be or comprise an ambient illumination source and/or may be or may comprise an artificial illumination source. By way of example, the detector itself can comprise at least one illumination source, for example at least one laser and/or at least one incandescent lamp and/or at least one semiconductor illumination source, for example, at least one light-emitting diode, in particular an organic and/or inorganic light-emitting diode. On account of their generally defined beam profiles and other properties of handleability, the use of one or a plurality of lasers as illumination source or as part thereof, is particularly preferred. The illumination source itself can be a constituent part of the detector or else be formed independently of the optical detector. The illumination source can be integrated in particular into the optical detector, for example a housing of the detector. Alternatively or additionally, at least one illumination source can also be integrated into the at least one beacon device or into one or more of the beacon devices and/or into the object or connected or spatially coupled to the object.

The light emerging from the one or more beacon devices can accordingly, alternatively or additionally from the option that said light originates in the respective beacon device itself, emerge from the illumination source and/or be excited by the illumination source. By way of example, the electromagnetic light emerging from the beacon device can be emitted by the beacon device itself and/or be reflected by the beacon device and/or be scattered by the beacon device before it is fed to the detector. In this case, emission and/or scattering of the electromagnetic radiation can be effected without spectral influencing of the electromagnetic radiation or with such influencing. Thus, by way of example, a wavelength shift can also occur during scattering, for example according to Stokes or Raman. Furthermore, emission of light can be excited, for example, by a primary illumination source, for example by the object or a partial region of the object being excited to generate luminescence, in particular phosphorescence and/or fluorescence. Other emission processes are also possible, in principle. If a reflection occurs, then the object can have, for example, at least one reflective region, in particular at least one reflective surface. Said reflective surface can be a part of the object itself, but can also be, for example, a reflector which is connected or spatially coupled to the object, for example a reflector plaque connected to the object. If at least one reflector is used, then it can in turn also be regarded as part of the detector which is connected to the object, for example, independently of other constituent parts of the optical detector.

The beacon devices and/or the at least one optional illumination source may be embodied independently from each other and generally may emit light in at least one of: the ultraviolet spectral range, preferably in the range of 200 nm to 380 nm; the visible spectral range (380 nm to 780 nm); the infrared spectral range, preferably in the range of 780 nm to 3.0 micrometers. Most preferably, the at least one illumination source is adapted to emit light in the visible spectral range, preferably in the range of 500 nm to 780 nm, most preferably at 650 nm to 750 nm or at 690 nm to 700 nm.

The feeding of the light beam to the optical sensor can be effected in particular in such a way that a light spot, for example having a round, oval or differently configured cross section, is produced on the optional sensor area of the optical sensor. By way of example, the detector can have a visual range, in particular a solid angle range and/or spatial range, within which objects cart be detected. Preferably, the optional transfer device is designed in such a way that the light spot, for example in the case of an object arranged within a visual range of the detector, is arranged completely on a sensor region and/or on a sensor area of the optical sensor. By way of example, a sensor area can be chosen to have a corresponding size in order to ensure this condition.

The evaluation device can comprise in particular at least one data processing device, in particular an electronic data processing device, which can be designed to generate at least one item of information on the position of the object. Thus, the evaluation device may be designed to use one or more of: the number of illuminated pixels of the optical sensor; a beam width of the light beam on one or more of the optical sensors, specifically on one or more of the optical sensors having the above-mentioned FiP-effect; a number of illuminated pixels of a pixelated optical sensor such as a CCD or a CMOS chip. The evaluation device may be designed to use one or more of these types of information as one or more input variables and to generate the at least one item of information on the position of the object by processing these input variables. The processing can be done in parallel, subsequently or even in a combined manner. The evaluation device may use an arbitrary process for generating these items of information, such as by calculation and/or using at least one stored and/or known relationship. The relationship can be a predetermined analytical relationship or can be determined or determinable empirically, analytically or else semi-empirically. Particularly preferably, the relationship comprises at least one calibration curve, at least one set of calibration curves, at least one function or a combination of the possibilities mentioned. One or a plurality of calibration curves can be stored, for example, in the form of a set of values and the associated function values thereof, for example in a data storage device and/or a table. Alternatively or additionally, however, the at least one calibration curve can also be stored, for example, in parameterized form and/or as a functional equation.

By way of example, the evaluation device can be designed in terms of programming for the purpose of determining the items of information. The evaluation device can comprise in particular at least one computer, for example at least one microcomputer. Furthermore, the evaluation device can comprise one or a plurality of volatile or nonvolatile data memories. As an alternative or in addition to a data processing device, in particular at least one computer, the evaluation device can comprise one or a plurality of further electronic components which are designed for determining the items of information, for example an electronic table and in particular at least one look-up table and/or at least one application-specific integrated circuit (ASIC).

In a further aspect of the present invention, a human-machine interface for exchanging at least one item of information between a user and a machine is disclosed. The human-machine interface comprises at least one optical detector and/or at least one detector system according to the present invention, such as according to one or more of the embodiments disclosed above or disclosed in further detail below.

In case the human-machine interface comprises at least one detector system according to the present invention, the at least one beacon device of the detector system may be adapted to be at least one of directly or indirectly attached to the user and held by the user. The human-machine interface may designed to determine at least one position of the user by means of the detector system and is designed to assign to the position at least one item of information.

As used herein, the term “human-machine interface” generally refers to an arbitrary device or combination of devices adapted for exchanging at least one item of information, specifically at least one item of electronic information, between a user and a machine such as a machine having at least one data processing device. The exchange of information may be performed in a unidirectional fashion and/or in a bidirectional fashion. Specifically, the human-machine interface may be adapted to allow for a user to provide one or more commands to the machine in a machine-readable fashion.

In a further aspect of the invention, an entertainment device for carrying out at least one entertainment function is disclosed. The entertainment device comprises at least one human-machine interface according to the present invention, such as disclosed in one or more of the embodiments disclosed above or disclosed in further detail below. The entertainment device is designed to enable at least one item of information to be input by a player by means of the human-machine interface, wherein the entertainment device is designed to vary the entertainment function in accordance with the information.

As used herein, an “entertainment device” is a device which may serve the purpose of leisure and/or entertainment of one or more users, in the following also referred to as one or more players. As an example, the entertainment device may serve the purpose of gaming, preferably computer gaming. Additionally or alternatively, the entertainment device may also be used for other purposes, such as for exercising, sports, physical therapy or motion tracking in general. Thus, the entertainment device may be implemented into a computer, a computer network or a computer system or may comprise a computer, a computer network or a computer system which runs one or more gaming software programs.

The entertainment device comprises at least one human-machine interface according to the present invention, such as according to one or more of the embodiments disclosed above and/or according to one or more of the embodiments disclosed below. The entertainment device is designed to enable at least one item of information to be input by a player by means of the human-machine interface. The at least one item of information may be transmitted to and/or may be used by a controller and/or a computer of the entertainment device.

The at least one item of information preferably may comprise at least one command adapted for influencing the course of a game. Thus, as an example, the at least one item of information may include at least one item of information on at least one orientation of the player and/or of one or more body parts of the player, thereby allowing for the player to simulate a specific position and/or orientation and/or action required for gaming. As an example, one or more of the following movements may be simulated and communicated to a controller and/or a computer of the entertainment device: dancing; running; jumping; swinging of a racket; swinging of a bat; swinging of a club; pointing of an object towards another object, such as pointing of a toy gun towards a target.

The entertainment device as a part or as a whole, preferably a controller and/or a computer of the entertainment device, is designed to vary the entertainment function in accordance with the information. Thus, as outlined above, a course of a game might be influenced in accordance with the at least one item of information. Thus, the entertainment device might include one or more controllers which might be separate from the evaluation device of the at least one detector and/or which might be fully or partially identical to the at least one evaluation device or which might even include the at least one evaluation device. Preferably, the at least one controller might include one or more data processing devices, such as one or more computers and/or microcontrollers.

In a further aspect of the present invention, a tracking system for tracking a position of at least one movable object is disclosed. The tracking system comprises at least one optical detector and/or at least one detector system according to the present invention, such as disclosed in one or more of the embodiments given above or given in further detail below. The tracking system further comprises at least one track controller, wherein the track controller is adapted to track a series of positions of the object at specific points in time.

As used herein, a “tracking system” is a device which is adapted to gather information on a series of past positions of the at least one object and/or at least one part of the object. Additionally, the tracking system may be adapted to provide information on at least one predicted future position and/or orientation of the at least one object or the at least one part of the object. The tracking system may have at least one track controller, which may fully or partially be embodied as an electronic device, preferably as at least one data processing device, more preferably as at least one computer or microcontroller. Again, the at least one track controller may fully or partially comprise the at least one evaluation device and/or may be part of the at least one evaluation device and/or may fully or partially be identical to the at least one evaluation device.

The tracking system comprises at least one optical detector according to the present invention, such as at least one detector as disclosed in one or more of the embodiments listed above and/or as disclosed in one or more of the embodiments below. The tracking system further comprises at least one track controller. The track controller is adapted to track a series of positions of the object at specific points in time, such as by recording groups of data or data pairs, each group of data or data pair comprising at least one position information and at least one time information.

Besides the at least one optical detector and the at least one evaluation device and the optional at least one beacon device, the tracking system may further comprise the object itself or a part of the object, such as at least one control element comprising the beacon devices or at least one beacon device, wherein the control element is directly or indirectly attachable to or integratable into the object to be tracked.

The tracking system may be adapted to initiate one or more actions of the tracking system itself and/or of one or more separate devices. For the latter purpose, the tracking system, preferably the track controller, may have one or more wireless and/or wire-bound interfaces and/or other types of control connections for initiating at least one action. Preferably, the at least one track controller may be adapted to initiate at least one action in accordance with at least one actual position of the object. As an example, the action may be selected from the group consisting of: a prediction of a future position of the object; pointing at least one device towards the object; pointing at least one device towards the detector; illuminating the object; illuminating the detector.

As an example of application of a tracking system, the tracking system may be used for continuously pointing at least one first object to at least one second object even though the first object and/or the second object might move. Potential examples, again, may be found in industrial applications, such as in robotics and/or for continuously working on an article even though the article is moving, such as during manufacturing in a manufacturing line or assembly line. Additionally or alternatively, the tracking system might be used for illumination purposes, such as for continuously illuminating the object by continuously pointing an illumination source to the object even though the object might be moving. Further applications might be found in communication systems, such as in order to continuously transmit information to a moving object by pointing a transmitter towards the moving object.

In a further aspect of the present invention, a camera for imaging at least one object is disclosed. The camera comprises at least one optical detector according to the present invention, such as disclosed in one or more of the embodiments given above or given in further detail below.

Thus, specifically, the present application may be applied in the field of photography. Thus, the detector may be part of a photographic device, specifically of a digital camera. Specifically, the detector may be used for 3D photography, specifically for digital 3D photography. Thus, the detector may form a digital 3D camera or may be part of a digital 3D camera. As used herein, the term “photography” generally refers to the technology of acquiring image information of at least one object. As further used herein, a “camera” generally is a device adapted for performing photography. As further used herein, the term “digital photography” generally refers to the technology of acquiring image information of at least one object by using a plurality of light-sensitive elements adapted to generate electrical signals indicating an intensity and/or color of illumination, preferably digital electrical signals. As further used herein, the term “3D photography” generally refers to the technology of acquiring image information of at least one object in three spatial dimensions. Accordingly, a 3D camera is a device adapted for performing 3D photography. The camera generally may be adapted for acquiring a single image, such as a single 3D image, or may be adapted for acquiring a plurality of images, such as a sequence of images. Thus, the camera may also be a video camera adapted for video applications, such as for acquiring digital video sequences.

Thus, generally, the present invention further refers to a camera, specifically a digital camera, more specifically a 3D camera or digital 3D camera, for imaging at least one object. As outlined above, the term imaging, as used herein, generally refers to acquiring image information of at least one object. The camera comprises at least one optical detector according to the present invention. The camera, as outlined above, may be adapted for acquiring a single image or for acquiring a plurality of images, such as image sequence, preferably for acquiring digital video sequences. Thus, as an example, the camera may be or may comprise a video camera. In the latter case, the camera preferably comprises a data memory for storing the image sequence.

The optical detector or the camera including the optical detector, having the at least one optical sensor, specifically the above-mentioned FiP sensor, may further be combined with one or more additional sensors. Thus, at least one camera having the at least one optical sensor, specifically the at least one above-mentioned FiP sensor, may be combined with at least one further camera, which may be a conventional camera and/or e.g. a stereo camera. Further, one, two or more cameras having the at least one optical sensor, specifically the at least one above-mentioned FiP sensor, may be combined with one, two or more digital cameras. As an example, one or two or more two-dimensional digital cameras may be used for calculating the depth from stereo information and from the depth information gained by the optical detector according to the present invention.

Specifically in the field of automotive technology, in case a camera fails, the optical detector according to the present invention may still be present for measuring a longitudinal coordinate of an object, such as for measuring a distance of an object in the field of view. Thus, by using the optical detector according to the present invention in the field of automotive technology, a failsafe function may be implemented. Specifically for automotive applications, the optical detector according to the present invention provides the advantage of data reduction. Thus, as compared to camera data of conventional digital cameras, data obtained by using the optical detector according to the present invention, i.e. an optical detector having the at least one optical sensor, specifically the at least one FiP sensor, may provide data having a significantly lower volume. Specifically in the field of automotive technology, a reduced amount of data is favorable, since automotive data networks generally provide lower capabilities in terms of data transmission rate.

The optical detector according to the present invention may further comprise one or more light sources. Thus, the optical detector may comprise one or more light sources for illuminating the at least one object, such that e.g. illuminated light is reflected by the object. The light source may be a continuous light source or maybe discontinuously emitting light source such as a pulsed light source. The light source may be a uniform light source or may be a non-uniform light source or a patterned light source. Thus, as an example, in order for the optical detector to measure the at least one longitudinal coordinate, such as to measure the depth of at least one object, a contrast in the illumination or in the scene captured by the optical detector is advantageous. In case no contrast is present by natural illumination, the optical detector may be adapted, via the at least one optional light source, to fully or partially illuminate the scene and/or at least one object within the scene, preferably with patterned light. Thus, as an example, the light source may project a pattern into a scene, onto a wall or onto at least one object, in order to create an increased contrast within an image captured by the optical detector.

The at least one optional light source may generally emit light in one or more of the visible spectral range, the infrared spectral range or the ultraviolet spectral range. Preferably, the at least one light source emits light at least in the infrared spectral range.

The optical detector may also be adapted to automatically illuminate the scene. Thus, the optical detector, such as the evaluation device, may be adapted to automatically control the illumination of the scene captured by the optical detector or a part thereof. Thus, as an example, the optical detector may be adapted to recognize in case large areas provide low contrast, thereby making it difficult to measure the longitudinal coordinates, such as depth, within these areas. In these cases, as an example, the optical detector may be adapted to automatically illuminate these areas with patterned light, such as by projecting one or more patterns into these areas.

As used within the present invention, the expression “position” generally refers to at least one item of information regarding one or more of an absolute position and an orientation of one or more points of the object. Thus, specifically, the position may be determined in a coordinate system of the detector, such as in a Cartesian coordinate system. Additionally or alternatively, however, other types of coordinate systems may be used, such as polar coordinate systems and/or spherical coordinate systems.

In a further aspect of the present invention, a method of optical detection is disclosed, specifically a method for determining a position of at least one object. The method comprises the following steps, which may be performed in the given order or in a different order. Further, two or more or even all of the method steps may be performed simultaneously and/or overlapping in time. Further, one, two or more or even all of the method steps may be performed repeatedly. The method may further comprise additional method steps. The method comprises the following method steps:
detecting at least one light beam by using at least one optical sensor and generating at least one sensor signal, wherein the optical sensor has at least one sensor region, wherein the sensor signal of the optical sensor is dependent on an illumination of the sensor region by the light beam, wherein the sensor signal, given the same total power of the illumination, is dependent on a width of the light beam in the sensor region;
modifying a focal position of the light beam in a controlled fashion by using at least one focus-tunable lens located in a beam path of the light beam;
providing at least one focus-modulating signal to the focus-tunable lens by using at least one focus-modulation device, thereby modulating the focal position;
recording at least one image by using at least one imaging device; and
evaluating the sensor signal by using at least one evaluation device and, depending on the sensor signal, effecting a recording of the image by the imaging device.

The method preferably may be performed by using the optical detector according to the present invention, such as disclosed in one or more of the embodiments given above or given in further detail below. Thus, with regard to definitions and potential embodiments of the method, reference may be made to the optical detector. Still, other embodiments are feasible.

Thus, providing the focus-modulating signal specifically may comprise providing a periodic focus-modulating signal, preferably a sinusoidal signal.

Evaluating the sensor signal specifically may comprise detecting one or both of local maxima or local minima in the sensor signal. Evaluating the sensor signal further may further comprise providing at least one item of information on a longitudinal position of at least one object from which the light beam propagates towards the optical detector by evaluating one or both of the local maxima or local minima.

Evaluating the sensor signal may further comprise performing a phase-sensitive evaluation of the sensor signal. The phase-sensitive evaluation may comprise one or both of determining a position of one or both of local maxima or local minima in the sensor signal or a lock-in detection.

Evaluating the sensor signal may further comprise generating at least one item of information on a longitudinal position of at least one object from which the light beam propagates towards the optical detector by evaluating the sensor signal. The generating of the at least one item of information on the longitudinal position of the at least one object specifically may make use of a predetermined or determinable relationship between the longitudinal position and the sensor signal.

The method may further comprise generating at least one transversal sensor signal by using at least one optional transversal optical sensor, wherein the transversal optical sensor may be adapted to determine one or more of a transversal position of the light beam, a transversal position of an object from which the light beam propagates towards the optical detector or a transversal position of a light spot generated by the light beam, the transversal position being a position in at least one dimension perpendicular to an optical axis of the detector. The method may further comprise generating at least one item of information on a transversal position of the object by evaluating the transversal sensor signal.

Evaluating the sensor signal may further comprise assigning each signal component to a respective pixel in accordance with its modulation frequency. The evaluating of the sensor signal may comprise performing the frequency analysis by demodulating the sensor signal with the different modulation frequencies. The evaluating of the sensor signal may further comprise determining which pixels of the matrix are illuminated by the light beam by evaluating the signal components. The evaluating of the sensor signal may comprise identifying at least one of a transversal position of the light beam, a transversal position of the light spot or an orientation of the light beam, by identifying a transversal position of pixels of the matrix illuminated by the light beam. The evaluating of the sensor signal may further comprise determining a width of the light beam by evaluating the signal components. The evaluating of the sensor signal may further comprise identifying the signal components assigned to pixels being illuminated by the light beam and determining the width of the light beam at the position of the optical sensor from known geometric properties of the arrangement of the pixels. The evaluating of the sensor signal may further comprise determining a longitudinal coordinate of the object, by using a known or determinable relationship between a longitudinal coordinate of the object from which the light beam propagates towards the detector and one or both of a width of the light beam at the position of the optical sensor or a number of pixels of the optical sensor illuminated by the light beam.

The method further comprises acquiring at least one image of a scene captured by the optical detector by using at least one imaging device. Therein, the method may further comprise assigning the pixels of the optical sensor to the image. The method may further comprise determining a depth information for the image pixels by evaluating the signal components.

The method may further comprise combining the depth information of the image pixels with the image in order to generate at least one three-dimensional image.

For further details of the above-mentioned method steps, reference may be made to the description of the optical detector according to one or more of the embodiments listed above or listed in further detail below, since the functions of the optical detector may correspond to the method steps.

In a further aspect of the present invention, a use of the optical detector according to the present invention, such as disclosed in one or more of the embodiments discussed above and/or as disclosed in one or more of the embodiments given in further detail below, is disclosed, for a purpose of use, selected from the group consisting of: a position measurement in traffic technology; an entertainment application; a security application; a human-machine interface application; a tracking application; a photography application; a mapping application for generating maps of at least one space, such as at least one space selected from the group of a room, a building and a street; a mobile application; a webcam; a computer peripheral device; a gaming application; an audio application; a camera or video application; a security application; a surveillance application; an automotive application; a transport application; a medical application; an agricultural application; an application connected to breeding plants or animals; a crop protection application; a sports application; a machine vision application; a vehicle application; an airplane application; a ship application; a spacecraft application; a building application; a construction application; a cartography application; a manufacturing application; a quality control application; a use in combination with at least one time-of-flight detector. Additionally or alternatively, applications in local and/or global positioning systems may be named, especially landmark-based positioning and/or indoor and/or outdoor navigation, specifically for use in cars or other vehicles (such as trains, motorcycles, bicycles, trucks for cargo transportation), robots or for use by pedestrians. Further, indoor positioning systems may be named as potential applications, such as for household applications and/or for robots used in manufacturing technology. Further, the optical detector according to the present invention may be used in automatic door openers, such as in so-called smart sliding doors, such as a smart sliding door disclosed in Jie-Ci Yang et al., Sensors 2013, 13(5), 5923-5936; doi:10.3390/s130505923. At least one optical detector according to the present invention may be used for detecting when a person or an object approaches the door, and the door may automatically open.

Further applications, as outlined above, may be global positioning systems, local positioning systems, indoor navigation systems or the like. Thus, the devices according to the present invention, i.e. one or more of the optical detector, the detector system, the human-machine interface, the entertainment device, the tracking system or the camera, specifically may be part of a local or global positioning system. Additionally or alternatively, the devices may be part of a visible light communication system. Other uses are feasible.

The devices according to the present invention, i.e. one or more of the optical detector, the detector system, the human-machine interface, the entertainment device, the tracking system or the camera, further specifically may be used in combination with a local or global positioning system, such as for indoor or outdoor navigation. As an example, one or more devices according to the present invention may be combined with software/database-combinations such as Google Maps® or Google Street View®. Devices according to the present invention may further be used to analyze the distance to objects in the surrounding, the position of which can be found in the database. From the distance to the position of the known object, the local or global position of the user may be calculated.

Thus, the optical detector, the detector system, the human-machine interface, the entertainment device, the tracking system or the camera according to the present invention (in the following simply referred to as “the devices according to the present invention” or—without restricting the present invention to the potential use of the FiP effect—“FiP-devices”) may be used for a plurality of application purposes, such as one or more of the purposes disclosed in further detail in the following.

Thus, firstly, FiP-devices may be used in mobile phones, tablet computers, laptops, smart panels or other stationary or mobile computer or communication applications. Thus, FiP-devices may be combined with at least one active light source, such as a fight source emitting light in the visible range or infrared spectral range, in order to enhance performance. Thus, as an example, FiP-devices may be used as cameras and/or sensors, such as in combination with mobile software for scanning environment, objects and living beings. FiP-devices may even be combined with 2D cameras, such as conventional cameras, in order to increase imaging effects. FiP-devices may further be used for surveillance and/or for recording purposes or as input devices to control mobile devices, especially in combination with gesture recognition. Thus, specifically, FiP-devices acting as human-machine interfaces, also referred to as FiP input devices, may be used in mobile applications, such as for controlling other electronic devices or components via the mobile device, such as the mobile phone. As an example, the mobile application including at least one FiP-device may be used for controlling a television set, a game console, a music player or music device or other entertainment devices.

Further, FiP-devices may be used in webcams or other peripheral devices for computing applications. Thus, as an example, FiP-devices may be used in combination with software for imaging, recording, surveillance, scanning or motion detection. As outlined in the context of the human-machine interface and/or the entertainment device, FiP-devices are particularly useful for giving commands by facial expressions and/or body expressions. FiP-devices can be combined with other input generating devices like e.g. mouse, keyboard, touchpad, etc. Further, FiP-devices may be used in applications for gaming, such as by using a webcam. Further, FiP-devices may be used in virtual training applications and/or video conferences

Further, FiP-devices may be used in mobile audio devices, television devices and gaming devices, as partially explained above. Specifically, FiP-devices may be used as controls or control devices for electronic devices, entertainment devices or the like. Further, FiP-devices may be used for eye detection or eye tracking, such as in 2D- and 3D-display techniques, especially with transparent displays for augmented reality applications.

Further, FiP-devices may be used in or as digital cameras such as DSC cameras and/or in or as reflex cameras such as SLR cameras. For these applications, reference may be made to the use of FiP-devices in mobile applications such as mobile phones, as disclosed above.

Further, FiP-devices may be used for security and surveillance applications. Thus, as an example, FiP-sensors in general can be combined with one or more digital and/or analog electronics that will give a signal if an object is within or outside a predetermined area (e.g. for surveillance applications in banks or museums). Specifically, FiP-devices may be used for optical encryption. FiP-based detection can be combined with other detection devices to complement wavelengths, such as with IR, x-ray, UV-VIS, radar or ultrasound detectors. FiP-devices may further be combined with an active infrared light source to allow detection in low light surroundings. FiP-devices such as RP-based sensors are generally advantageous as compared to active detector systems, specifically since FiP-devices avoid actively sending signals which may be detected by third parties, as is the case e.g. In radar applications, ultrasound applications, LIDAR or similar active detector device is. Thus, generally, FiP-devices may be used for an unrecognized and undetectable tracking of moving objects. Additionally, FiP-devices generally are less prone to manipulations and irritations as compared to conventional devices.

Further, given the ease and accuracy of 3D detection by using FiP-devices, FiP-devices generally may be used for facial, body and person recognition and identification. Therein, FiP-devices may be combined with other detection means for identification or personalization purposes such as passwords, finger prints, iris detection, voice recognition or other means. Thus, generally, FiP-devices may be used in security devices and other personalized applications.

Further, FiP-devices may be used as 3D-barcode readers for product identification.

In addition to the security and surveillance applications mentioned above, FiP-devices generally can be used for surveillance and monitoring of spaces and areas. Thus, FiP-devices may be used for surveying and monitoring spaces and areas and, as an example, for triggering or executing alarms in case prohibited areas are violated. Thus, generally, FiP-devices may be used for surveillance purposes in building surveillance or museums, optionally in combination with other types of sensors, such as in combination with motion or heat sensors, in combination with image intensifiers or image enhancement devices and/or photomultipliers.

Further, FiP-devices may advantageously be applied in camera applications such as video and camcorder applications. Thus, FiP-devices may be used for motion capture and 3D-movie recording. Therein, FiP-devices generally provide a large number of advantages over conventional optical devices. Thus, FiP-devices generally require a lower complexity with regard to optical components. Thus, as an example, the number of lenses may be reduced as compared to conventional optical devices, such as by providing FiP-devices having one lens only. Due to the reduced complexity, very compact devices are possible, such as for mobile use. Conventional optical systems having two or more lenses with high quality generally are voluminous, such as due to the general need for voluminous beam-splitters. Further, FiP-devices generally may be used for focus/autofocus devices, such as autofocus cameras. Further, FiP-devices may also be used in optical microscopy, especially in confocal microscopy.

Further, FiP-devices are applicable in the technical field of automotive technology and transport technology. Thus, as an example, FiP-devices may be used as distance and surveillance sensors, such as for adaptive cruise control, emergency brake assist, lane departure warning, surround view, blind spot detection, rear cross traffic alert, and other automotive and traffic applications. Further, FiP-sensors can also be used for velocity and/or acceleration measurements, such as by analyzing a first and second time-derivative of position information gained by using the FiP-sensor. This feature generally may be applicable in automotive technology, transportation technology or general traffic technology. Applications in other fields of technology are feasible.

In these or other applications, generally, HP-devices may be used as standalone devices or in combination with other sensor devices, such as in combination with radar and/or ultrasonic devices. Specifically, FiP-devices may be used for autonomous driving and safety issues. Further, in these applications, FiP-devices may be used in combination with infrared sensors, radar sensors, which are sonic sensors, two-dimensional cameras or other types of sensors. In these applications, the generally passive nature of typical FP-devices is advantageous. Thus, since FiP-devices generally do not require emitting signals, the risk of interference of active sensor signals with other signal sources may be avoided. FiP-devices specifically may be used in combination with recognition software, such as standard image recognition software. Thus, signals and data as provide by FiP-devices typically are readily processable and, therefore, generally require lower calculation power than established stereovision systems such as LIDAR. Given the low space demand, FiP-devices such as cameras using the FiP-effect may be placed at virtually any place in a vehicle, such as on a window screen, on a front hood, on bumpers, on lights, on mirrors or other places the like. Various detectors based on the FiP-effect can be combined, such as in order to allow autonomously driving vehicles or in order to increase the performance of active safety concepts. Thus, various FiP-based sensors may be combined with other FiP-based sensors and/or conventional sensors, such as in the windows like rear window, side window or front window, on the bumpers or on the lights.

A combination of a HP-sensor with one or more rain detection sensors is also possible. This is due to the fact that FiP-devices generally are advantageous over conventional sensor techniques such as radar, specifically during, heavy rain. A combination of at least one FiP-device with at least one conventional sensing technique such as radar may allow for a software to pick the right combination of signals according to the weather conditions.

Further, FiP-devices generally may be used as break assist and/or parking assist and/or for speed measurements. Speed measurements can be integrated in the vehicle or may be used outside the vehicle, such as in order to measure the speed of other cars in traffic control. Further, FiP-devices may be used for detecting free parking spaces in parking lots.

Further, FiP-devices may be used is the fields of medical systems and sports. Thus, in the field of medical technology, surgery robotics, e.g. for use in endoscopes, may be named, since, as outlined above, FiP-devices may require a low volume only and may be integrated into other devices. Specifically, FiP-devices having one lens, at most, may be used for capturing 3D information in medical devices such as in endoscopes. Further, FiP-devices may be combined with an appropriate monitoring software, in order to enable tracking and analysis of movements. These applications are specifically valuable e.g. In medical treatments and long-distance diagnosis and tele-medicine.

Further, FiP-devices may be applied in the field of sports and exercising, such as for training, remote instructions or competition purposes. Specifically, FiP-devices may be applied in the field of dancing, aerobic, football, soccer, basketball, baseball, cricket, hockey, track and field, swimming, polo, handball, volleyball, rugby, sumo, judo, fencing, boxing etc. FiP-devices can be used to detect the position of a ball, a bat, a sword, motions, etc., both in sports and in games, such as to monitor the game, support the referee or for judgment, specifically automatic judgment, of specific situations in sports, such as for judging whether a point or a goal actually was made.

FiP-devices further may be used in rehabilitation and physiotherapy, in order to encourage training and/or in order to survey and correct movements. Therein, the FiP-devices may also be applied for distance diagnostics.

Further, FiP-devices may be applied in the field of machine vision. Thus, one or more FiP-devices may be used e.g. as a passive controlling unit for autonomous driving and or working of robots. In combination with moving robots, FiP-devices may allow for autonomous movement and/or autonomous detection of failures in parts. FiP-devices may also be used for manufacturing and safety surveillance, such as in order to avoid accidents including but not limited to collisions between robots, production parts and living beings. Given the passive nature of FiP-devices, FiP-devices may be advantageous over active devices and/or may be used complementary to existing solutions like radar, ultrasound, 2D cameras, IR detection etc. One particular advantage of FiP-devices is the low likelihood of signal interference. Therefore multiple sensors can work at the same time in the same environment, without the risk of signal interference. Thus, FiP-devices generally may be useful in highly automated production environments like e.g. but not limited to automotive, mining, steel, etc. FiP-devices can also be used for quality control in production, e.g. In combination with other sensors like 2-D imaging, radar, ultrasound, IR etc., such as for quality control or other purposes. Further, FiP-devices may be used for assessment of surface quality, such as for surveying the surface evenness of a product or the adherence to specified dimensions, from the range of micrometers to the range of meters. Other quality control applications are feasible.

In particular, FiP devices may be used in industrial quality control for identifying a property related to a manufacturing, packaging and distribution of products, in particular products which comprise a non-solid phase, particularly a fluid, such as a liquid, an emulsion, a gas, an aerosol, or a mixture thereof. These kinds products, which may, generally, be present in the chemistry, pharmaceutical, cosmetics, food and beverage industry as well as in other industrial areas, usually require a solid receptacle, which may be denoted as container, case, or bottle, wherein the receptacle may, preferably, be full or at least partially transparent. For sake of simplicity, in the following the term “bottle” may be used as a particular frequent example without intending any actual restriction, such as to the shape or the material of the receptacle. Consequently, the bottle which comprises the corresponding product may be characterized by a number of optical parameters which may be used for quality control, preferably by employing the optical detector or a system comprising the optical detector according to the present invention. Within this regard, the optical detector may, especially, be used for detecting one or more of the following optical parameters, which may comprise a filling level of the product within the bottle, a shape of the bottle, and a property of a label which may be attached to the bottle, in particular for comprising respective product information.

According to the state of the art, industrial quality control of this kind may usually be performed by using industrial cameras and subsequent image analysis in order to assess one or more of the mentioned optical parameters by recording and evaluating the respective image, whereby, since the answer as usually required by industrial quality control is a logic statement which may only attain the values TRUE (i.e. quality sufficient) or FALSE (i.e. quality insufficient), most of the acquired complex information with regard to the optical parameters may, in general, be discarded. By way of example, industrial cameras may be required for recording an image of a bottle, wherein the image may be assessed in the subsequent image analysis in order to detect a filling label, any possible deformation of the shape of the bottle and any errors and/or omissions comprised on the corresponding label as attached onto the bottle. In particular, since the deviations are usually rather small, different recorded images of the same product are all highly similar. Consequently, an image analysis which may employ simple tools, such as color levels or greyscales, is, generally, not sufficient. Further, conventional large-area image sensors yield little information, in particular due to their linear independence from the power of an incident light beam.

In contrast to this, the optical detector according to the present invention already comprises a setup with one or more optical sensors which exhibit a known dependency from the power of the incident light beam, which may, especially, result in a larger influence onto an image of the product with respect to the above mentioned optical parameters, such as the filling level of the product within the bottle, the shape of the bottle, and the at least one property of the label attached to the bottle. In particular, the optical sensors may, therefore, be adapted to directly condense complex information as comprised within the image of the product into one or more sensor signals, such as easily accessible current signals, thus avoiding the existing necessity of performing a sophisticated image analysis. Moreover, as already described above, the object of the present invention, which particularly refers to providing an autofocus device, wherein the sensor signal, such as a local maximum or minimum in the sensor current within a respective time interval, may indicate that the product under investigation is actually in focus, may further support the evaluation of the above mentioned optical parameters from the image of the corresponding product. Even in case an autofocus device may be used in cameras known from the state of the art, a lens system may, generally, only cover a limited range of distances, since the focus usually remains unchanged during the measurement. The measurement concept according to the present invention which is based on the use of a focus-tunable lens, however, may cover a much broader range, since varying the focus over a large range may be possible by employing the measurement concept as described herein. Furthermore, a use of specifically adapted transfer devices, illumination sources, such as devices configured for providing symmetry breaking and/or modulated illumination, modulation devices and/or sensor stacks may further enhance the reliability of the acquired information during the quality control.

Further, FiP-devices may be used in the polls, airplanes, ships, spacecrafts and other traffic applications. Thus, besides the applications mentioned above in the context of traffic applications, passive tracking systems for aircrafts, vehicles and the like may be named. Detection devices based on the FiP-effect for monitoring the speed and/or the direction of moving objects are feasible. Specifically, the tracking of fast moving objects on land, sea and in the air including space may be named. The at least one FiP-detector specifically may be mounted on a still-standing and/or on a moving device. An output signal of the at least one FP-device can be combined e.g. with a guiding mechanism for autonomous or guided movement of another object. Thus, applications for avoiding collisions or for enabling collisions between the tracked and the steered object are feasible. FiP-devices generally are useful and advantageous due to the low calculation power required, the instant response and due to the passive nature of the detection system which generally is more difficult to detect and to disturb as compared to active systems, like e.g. radar. FiP-devices are particularly useful but not limited to e.g. speed control and air traffic control devices.

FiP-devices generally may be used in passive applications. Passive applications include guidance for ships in harbors or in dangerous areas, and for aircrafts at landing or starting, wherein, fixed, known active targets may be used for precise guidance. The same can be used for vehicles driving in dangerous but well defined routes, such as mining vehicles.

Further, as outlined above, FiP-devices may be used in the field of gaming. Thus, FiP-devices can be passive for use with multiple objects of the same or of different size, color, shape, etc., such as for movement detection in combination with software that incorporates the movement into its content. In particular, applications are feasible in implementing movements into graphical output. Further, applications of FiP-devices for giving commands are feasible, such as by using one or more FiP-devices for gesture or facial recognition. FiP-devices may be combined with an active system in order to work under e.g. low light conditions or in other situations in which enhancement of the surrounding conditions is required. Additionally or alternatively, a combination of one or more FiP-devices with one or more IR or VIS light sources is possible, such as with a detection device based on the FiP effect. A combination of a FiP-based detector with special devices is also possible, which can be distinguished easily by the system and its software, e.g. and not limited to, a special color, shape, relative position to other devices, speed of movement, light, frequency used to modulate light sources on the device, surface properties, material used, reflection properties, transparency degree, absorption characteristics, etc. The device can, amongst other possibilities, resemble a stick, a racquet, a club, a gun, a knife, a wheel, a ring, a steering wheel, a bottle, a ball, a glass, a vase, a spoon, a fork, a cube, a dice, a figure, a puppet, a teddy, a beaker, a pedal, a switch, a glove, jewelry, a musical instrument or an auxiliary device for playing a musical instrument, such as a plectrum, a drumstick or the like. Other options are feasible.

Further, FiP-devices generally may be used in the field of building, construction and cartography. Thus, generally, FiP-based devices may be used in order to measure and/or monitor environmental areas, e.g. countryside or buildings. Therein, one or more FiP-devices may be combined with other methods and devices or can be used solely in order to monitor progress and accuracy of building projects, changing objects, houses, etc. FiP-devices can be used for generating three-dimensional models of scanned environments, in order to construct maps of rooms, streets, houses, communities or landscapes, both from ground or from air. Potential fields of application may be construction, interior architecture; indoor furniture placement; cartography, real estate management, land surveying or the like.

FiP-based devices can further be used for scanning of objects, such as in combination with CAD or similar software, such as for additive manufacturing and/or 3D printing. Therein, use may be made of the high dimensional accuracy of FiP-devices, e.g. In x-, y- or z-direction or in any arbitrary combination of these directions, such as simultaneously. Further, FiP-devices may be used in inspections and maintenance, such as pipeline inspection gauges.

As outlined above, FiP-devices may further be used in manufacturing, quality control or identification applications, such as in product identification or size identification (such as for finding an optimal place or package, for reducing waste etc.). Further, FiP-devices may be used in logistics applications. Thus, FiP-devices may be used for optimized loading or packing containers or vehicles. Further, FiP-devices may be used for monitoring or controlling of surface damages in the field of manufacturing, for monitoring or controlling rental objects such as rental vehicles, and/or for insurance applications, such as for assessment of damages. Further, FiP-devices may be used for identifying a size of material, object or tools, such as for optimal material handling, especially in combination with robots. Further, FiP-devices may be used for process control in production, e.g. for observing filling level of tanks. Further, FiP-devices may be used for maintenance of production assets like, but not limited to, tanks, pipes, reactors, tools etc. Further, FiP-devices may be used for analyzing 3D-quality marks. Further, FiP-devices may be used in manufacturing tailor-made goods such as tooth inlays, dental braces, prosthesis, clothes or the like. FiP-devices may also be combined with one or more 3D-printers for rapid prototyping, 3D-copying or the like. Further, FiP-devices may be used for detecting the shape of one or more articles, such as for anti-product piracy and for anti-counterfeiting purposes.

As outlined above, the at least one optical sensor or, in case a plurality of optical sensors is provided, at least one of the optical sensors may be an organic optical sensor comprising a photosensitive layer setup having at least two electrodes and at least one photovoltaic material embedded in between these electrodes. In the following, examples of a preferred setup of the photosensitive layer setup will be given, specifically with regard to materials which may be used within this photosensitive layer setup. The photosensitive layer setup preferably is a photosensitive layer setup of a solar cell, more preferably an organic solar cell and/or a dye-sensitized solar cell (DSC), more preferably a solid dye-sensitized solar cell (sDSC). Other embodiments, however, are feasible.

Preferably, the photosensitive layer setup comprises at least one photovoltaic material, such as at least one photovoltaic layer setup comprising at least two layers, sandwiched between the first electrode and the second electrode. Preferably, the photosensitive layer setup and the photovoltaic material comprise at least one layer of an n-semiconducting metal oxide, at least one dye and at least one p-semiconducting organic material. As an example, the photovoltaic material may comprise a layer setup having at least one dense layer of an n-semiconducting metal oxide such as titanium dioxide, at least one nano-porous layer of an n-semiconducting metal oxide contacting the dense layer of the n-semiconducting metal oxide, such as at least one nano-porous layer of titanium dioxide, at least one dye sensitizing the nano-porous layer of the n-semiconducting metal oxide, preferably an organic dye, and at least one layer of at least one p-semiconducting organic material, contacting the dye and/or the nano-porous layer of the n-semiconducting metal oxide.

The dense layer of the n-semiconducting metal oxide, as will be explained in further detail below, may form at least one barrier layer in between the first electrode and the at least one layer of the nano-porous n-semiconducting metal oxide. It shall be noted, however, that other embodiments are feasible, such as embodiments having other types of buffer layers.

The at least two electrodes comprise at least one first electrode and at least one second electrode. The first electrode may be one of an anode or a cathode, preferably an anode. The second electrode may be the other one of an anode or a cathode, preferably a cathode. The first electrode preferably contacts the at least one layer of the n-semiconducting metal oxide, and the second electrode preferably contacts the at least one layer of the p-semiconducting organic material. The first electrode may be a bottom electrode, contacting a substrate, and the second electrode may be a top electrode facing away from the substrate. Alternatively, the second electrode may be a bottom electrode, contacting the substrate, and the first electrode may be the top electrode facing away from the substrate. Preferably, one or both of the first electrode and the second electrode are transparent.

In the following, some options regarding the first electrode, the second electrode and the photovoltaic material, preferably the layer setup comprising two or more photovoltaic materials, will be disclosed. It shall be noted, however, that other embodiments are feasible.

a) Substrate, First Electrode and n-Semiconductive Metal Oxide

Generally, for preferred embodiments of the first electrode and the n-semiconductive metal oxide, reference may be made to WO 2012/110924 A1, U.S. provisional application No. 61/739,173 or U.S. provisional application No. 61/708,058, the full content of all of which is herewith included by reference. Other embodiments are feasible.

In the following, it shall be assumed that the first electrode is the bottom electrode directly or indirectly contacting the substrate. It shall be noted, however, that other setups are feasible, with the first electrode being the top electrode.

The n-semiconductive metal oxide which may be used in the photosensitive layer setup, such as in at least one dense film (also referred to as a solid film) of the n-semiconductive metal oxide and/or in at least one nano-porous film (also referred to as a nano-particulate film) of the n-semiconductive metal oxide, may be a single metal oxide or a mixture of different oxides. It is also possible to use mixed oxides. The n-semiconductive metal oxide may especially be porous and/or be used in the form of a nanoparticulate oxide, nanoparticles in this context being understood to mean particles which have an average particle size of less than 0.1 micrometer. A nanoparticulate oxide is typically applied to a conductive substrate (i.e. a carrier with a conductive layer as the first electrode) by a sintering process as a thin porous film with large surface area.

Preferably, the optical sensor uses at least one transparent substrate. However, setups using one or more intransparent substrates are feasible.

The substrate may be rigid or else flexible. Suitable substrates (also referred to hereinafter as carriers) are, as well as metal foils, in particular plastic sheets or films and especially glass sheets or glass films. Particularly suitable electrode materials, especially for the first electrode according to the above-described, preferred structure, are conductive materials, for example transparent conductive oxides (TCOs), for example fluorine- and/or indium-doped tin oxide (FTO or ITO) and/or aluminum-doped zinc oxide (AZO), carbon nanotubes or metal films. Alternatively or additionally, it would, however, also be possible to use thin metal films which still have a sufficient transparency. In case an intransparent first electrode is desired and used, thick metal films may be used.

The substrate can be covered or coated with these conductive materials. Since generally, only a single substrate is required in the structure proposed, the formation of flexible cells is also possible. This enables a multitude of end uses which would be achievable only with difficulty, if at all, with rigid substrates, for example use in bank cards, garments, etc.

The first electrode, especially the TCO layer, may additionally be covered or coated with a solid or dense metal oxide buffer layer (for example of thickness 10 to 200 nm), in order to prevent direct contact of the p-type semiconductor with the TCO layer (see Peng et al, Coord. Chem. Rev. 248, 1479 (2004)). The use of solid p-semiconducting electrolytes, in the case of which contact of the electrolyte with the first electrode is greatly reduced compared to liquid or gel-form electrolytes, however, makes this buffer layer unnecessary in many cases, such that it is possible in many cases to dispense with this layer, which also has a current-limiting effect and can also worsen the contact of the n-semiconducting metal oxide with the first electrode. This enhances the efficiency of the components. On the other hand, such a buffer layer can in turn be utilized in a controlled manner in order to match the current component of the dye solar cell to the current component of the organic solar cell. In addition, in the case of cells in which the buffer layer has been dispensed with, especially in solid cells, problems frequently occur with unwanted recombinations of charge carriers. In this respect, buffer layers are advantageous in many cases, specifically in solid cells.

As is well known, thin layers or films of metal oxides are generally inexpensive solid semiconductor materials (n-type semiconductors), but the absorption thereof, due to large bandgaps, is typically not within the visible region of the electromagnetic spectrum, but rather usually in the ultraviolet spectral region. For use in solar cells, the metal oxides therefore generally, as is the case in the dye solar cells, have to be combined with a dye as a photosensitizer, which absorbs in the wavelength range of sunlight, i.e. at 300 to 2000 nm, and, in the electronically excited state, injects electrons into the conduction band of the semiconductor. With the aid of a solid p-type semiconductor used additionally in the cell as an electrolyte, which is in turn reduced at the counter electrode, electrons can be recycled to the sensitizer, such that it is regenerated.

Of particular interest for use in organic solar cells are the semiconductors zinc oxide, tin dioxide, titanium dioxide or mixtures of these metal oxides. The metal oxides can be used in the form of microcrystalline or nanocrystalline porous layers. These layers have a large surface area which is coated with the dye as a sensitizer, such that a high absorption of sunlight is achieved. Metal oxide layers which are structured, for example nanorods, give advantages such as higher electron mobilities, improved pore filling by the dye, improved surface sensitization by the dye or increased surface areas.

The metal oxide semiconductors can be used alone or in the form of mixtures. It is also possible to coat a metal oxide with one or more other metal oxides. In addition, the metal oxides may also be applied as a coating to another semiconductor, for example GaP, ZnP or ZnS.

Particularly preferred semiconductors are zinc oxide and titanium dioxide in the anatase polymorph, which is preferably used in nanocrystalline form.

In addition, the sensitizers can advantageously be combined with all n-type semiconductors which typically find use in these solar cells. Preferred examples include metal oxides used in ceramics, such as titanium dioxide, zinc oxide, tin(IV) oxide, tungsten(VI) oxide, tantalum(V) oxide, niobium(V) oxide, cesium oxide, strontium titanate, zinc stannate, complex oxides of the perovskite type, for example barium titanate, and binary and ternary iron oxides, which may also be present in nanocrystalline or amorphous form.

Due to the strong absorption that customary organic dyes and ruthenium, phthalocyanines and porphyrins have, even thin layers or films of the n-semiconducting metal oxide are sufficient to absorb the required amount of dye. Thin metal oxide films in turn have the advantage that the probability of unwanted recombination processes falls and that the internal resistance of the dye subcell is reduced. For the n-semiconducting metal oxide, it is possible with preference to use layer thicknesses of 100 nm up to 20 micrometers, more preferably in the range between 500 nm and approx. 3 micrometers.

b) Dye

In the context of the present invention, as usual in particular for DSCs, the terms “dye”, “sensitizer dye” and “sensitizer” are used essentially synonymously without any restriction of possible configurations. Numerous dyes which are usable in the context of the present invention are known from the prior art, and so, for possible material examples, reference may also be made to the above description of the prior art regarding dye solar cells. As a preferred example, one or more of the dyes disclosed in WO 2012/110924 A1, U.S. provisional application No. 61/739,173 or U.S. provisional application No. 61/708,058 may be used, the full content of all of which is herewith included by reference. Additionally or alternatively, one or more of the dyes as disclosed in WO 2007/054470 A1 and/or WO 2013/144177 A1 and/or WO 2012/085803 A1 may be used, the full content of which is included by reference, too.

Dye-sensitized solar cells based on titanium dioxide as a semiconductor material are described, for example, in U.S. Pat. No. 4,927,721, Nature 353, p. 737-740 (1991) and U.S. Pat. No. 5,350,644, and also Nature 395, p. 583-585 (1998) and EP-A-1 176 646. The dyes described in these documents can in principle also be used advantageously in the context of the present invention. These dye solar cells preferably comprise monomolecular films of transition metal complexes, especially ruthenium complexes, which are bonded to the titanium dioxide layer via acid groups as sensitizers.

Many sensitizers which have been proposed include metal-free organic dyes, which are likewise also usable in the context of the present invention. High efficiencies of more than 4%, especially in solid dye solar cells, can be achieved, for example, with indoline dyes (see, for example, Schmidt-Mende et al, Adv. Mater. 2005, 17, 813). U.S. Pat. No. 6,359,211 describes the use, also implementable in the context of the present invention, of cyanine, oxazine, thiazine and acridine dyes which have carboxyl groups bonded via an alkylene radical for fixing to the titanium dioxide semiconductor.

Preferred sensitizer dyes in the dye solar cell proposed are the perylene derivatives, terrylene derivatives and quaterrylene derivatives described in DE 10 2005 053 995 A1 or WO 2007/054470 A1. Further, as outlined above, one or more of the dyes as disclosed in WO 2012/085803 A1 may be used. Additionally or alternatively, one or more of the dyes as disclosed in WO 2013/144177 A1 may be used. The full content of WO 2013/144177 A1 and of EP 12162526.3 is herewith included by reference. Specifically, dye D-5 and/or dye R-3 may be used, which is also referred to as ID1338:

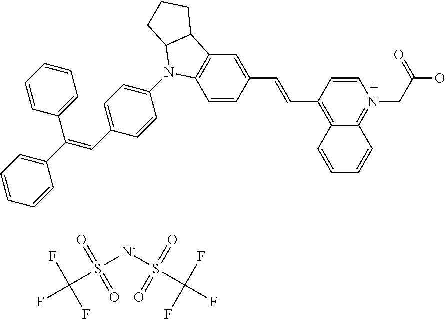

Preparation and properties of the Dye D-5 and dye R-3 are disclosed in WO 2013/144177 A1.

The use of these dyes, which is also possible in the context of the present invention, leads to photovoltaic elements with high efficiencies and simultaneously high stabilities.

Further, additionally or alternatively, the following dye may be used, which also is disclosed in WO 2013/144177 A1, which is referred to as ID1456:

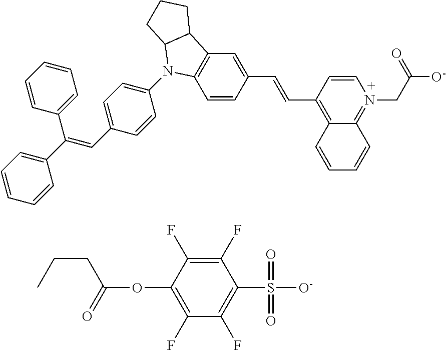

Further, one or both of the following rylene dyes may be used in the devices according to the present invention, specifically in the at least one optical sensor:

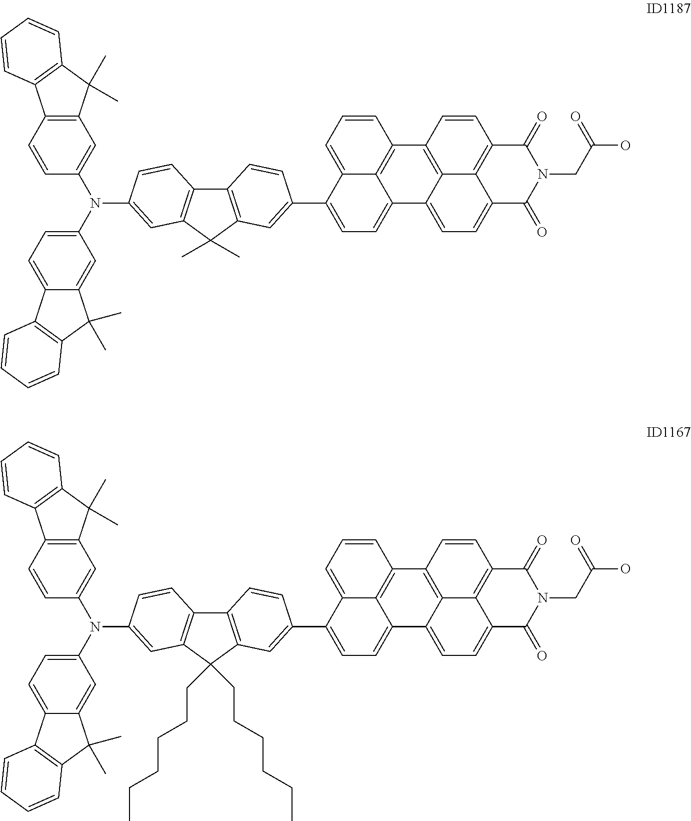 [SMILES: CC1(C)c2ccccc2-c2ccc(N(c3ccc4c(c3)C(C)(C)c3ccccc3-4)c3ccc4c(c3)C(C)(C)c3cc(-c5ccc6c7ccc8c9c(ccc(c%10cccc5c%106)c97)C(=O)N(CC(=O)O)C8=O)ccc3-4)cc21 ; CCCCCCC1(CCCCCC)c2cc(-c3ccc4c5ccc6c7c(ccc(c8cccc3c84)c75)C(=O)N(CC(=O)O)C6=O)ccc2-c2ccc(N(c3ccc4c(c3)C(C)(C)c3ccccc3-4)c3ccc4c(c3)C(C)(C)c3ccccc3-4)cc21]

These dyes ID1187 and ID1167 fall within the scope of the rylene dyes as disclosed in WO 2007/054470 A1, and may be synthesized using the general synthesis routes as disclosed therein, as the skilled person will recognize.

The rylenes exhibit strong absorption in the wavelength range of sunlight and can, depending on the length of the conjugated system, cover a range from about 400 nm (perylene derivatives I from DE 10 2005 053 995 A1) up to about 900 nm (quaterrylene derivatives I from DE 10 2005 053 995 A1). Rylene derivatives I based on tenylene absorb, according to the composition thereof, in the solid state adsorbed onto titanium dioxide, within a range from about 400 to 800 nm. In order to achieve very substantial utilization of the incident sunlight from the visible into the near infrared region, it is advantageous to use mixtures of different rylene derivatives I. Occasionally, it may also be advisable also to use different rylene homologs.

The rylene derivatives I can be fixed easily and in a permanent manner to the n-semiconducting metal oxide film. The bonding is effected via the anhydride function (x1) or the carboxyl groups —COOH or —COO— formed in situ, or via the acid groups A present in the imide or condensate radicals ((x2) or (x3)). The rylene derivatives I described in DE 10 2005 053 995 A1 have good suitability for use in dye-sensitized solar cells in the context of the present invention.

It is particularly preferred when the dyes, at one end of the molecule, have an anchor group which enables the fixing thereof to the n-type semiconductor film. At the other end of the molecule, the dyes preferably comprise electron donors Y which facilitate the regeneration of the dye after the electron release to the n-type semiconductor, and also prevent recombination with electrons already released to the semiconductor.

For further details regarding the possible selection of a suitable dye, it is possible, for example, again to refer to DE 10 2005 053 995 A1. By way of example, it is possible especially to use ruthenium complexes, porphyrins, other organic sensitizers, and preferably rylenes.

The dyes can be fixed onto or into the n-semiconducting metal oxide film, such as the nano-porous n-semiconducting metal oxide layer, in a simple manner. For example, the n-semiconducting metal oxide films can be contacted in the freshly sintered (still warm) state over a sufficient period (for example about 0.5 to 24 h) with a solution or suspension of the dye in a suitable organic solvent. This can be accomplished, for example, by immersing the metal oxide-coated substrate into the solution of the dye.

If combinations of different dyes are to be used, they may, for example, be applied successively from one or more solutions or suspensions which comprise one or more of the dyes. It is also possible to use two dyes which are separated by a layer of, for example, CuSCN (on this subject see, for example, Tennakone, K. J., Phys. Chem. B. 2003, 107, 13758). The most convenient method can be determined comparatively easily in the individual case.

In the selection of the dye and of the size of the oxide particles of the n-semiconducting metal oxide, the organic solar cell should be configured such that a maximum amount of light is absorbed. The oxide layers should be structured such that the solid p-type semiconductor can efficiently fill the pores. For instance, smaller particles have greater surface areas and are therefore capable of adsorbing a greater amount of dyes. On the other hand, larger particles generally have larger pores which enable better penetration through the p-conductor.

c) p-Semiconducting Organic Material

As described above, the at least one photosensitive layer setup, such as the photosensitive layer setup of the DSC or sDSC, can comprise in particular at least one p-semiconducting organic material, preferably at least one solid p-semiconducting material, which is also designated hereinafter as p-type semiconductor or p-type conductor. Hereinafter, a description is given of a series of preferred examples of such organic p-type semiconductors which can be used individually or else in any desired combination, for example in a combination of a plurality of layers with a respective p-type semiconductor, and/or in a combination of a plurality of p-type semiconductors in one layer.

In order to prevent recombination of the electrons in the n-semiconducting metal oxide with the solid p-conductor, it is possible to use, between the n-semiconducting metal oxide and the p-type semiconductor, at least one passivating layer which has a passivating material. This layer should be very thin and should as far as possible cover only the as yet uncovered sites of the n-semiconducting metal oxide. The passivation material may, under some circumstances, also be applied to the metal oxide before the dye. Preferred passivation materials are especially one or more of the following substances: Al₂O₃; silanes, for example CH₃SiCl₃; Al³⁺; 4-tert-butylpyridine (TBP); MgO; GBA (4-guanidinobutyric acid) and similar derivatives; alkyl acids; hexadecylmalonic acid (HDMA).

As described above, preferably one or more solid organic p-type semiconductors are used—alone or else in combination with one or more further p-type semiconductors which are organic or inorganic in nature. In the context of the present invention, a p-type semiconductor is generally understood to mean a material, especially an organic material, which is capable of conducting holes, that is to say positive charge carriers. More particularly, it may be an organic material with an extensive π-electron system which can be oxidized stably at least once, for example to form what is called a free-radical cation. For example, the p-type semiconductor may comprise at least one organic matrix material which has the properties mentioned. Furthermore, the p-type semiconductor can optionally comprise one or a plurality of dopants which intensify the p-semiconducting properties. A significant parameter influencing the selection of the p-type semiconductor is the hole mobility, since this partly determines the hole diffusion length (cf. Kumara, G., Langmuir, 2002, 18, 10493-10495). A comparison of charge carrier mobilities in different Spiro compounds can be found, for example, in T. Saragi, Adv. Funct. Mater. 2006, 16, 966-974.

Preferably, in the context of the present invention, organic semiconductors are used (i.e. one or more of low molecular weight, oligomeric or polymeric semiconductors or mixtures of such semiconductors). Particular preference is given to p-type semiconductors which can be processed from a liquid phase. Examples here are p-type semiconductors based on polymers such as polythiophene and polyarylamines, or on amorphous, reversibly oxidizable, nonpolymeric organic compounds, such as the spirobifluorenes mentioned at the outset (cf., for example, US 2006/0049397 and the spiro compounds disclosed therein as p-type semiconductors, which are also usable in the context of the present invention). Preference is also given to using low molecular weight organic semiconductors, such as the low molecular weight p-type semiconducting materials as disclosed in WO 2012/110924 A1, preferably spiro-MeOTAD, and/or one or more of the p-type semiconducting materials disclosed in Leijtens et al., ACS Nano, VOL. 6, NO. 2, 1455-1462 (2012). Additionally or alternatively, one or more of the p-type semiconducting materials as disclosed in WO 2010/094636 A1 may be used, the full content of which is herewith included by reference. In addition, reference may also be made to the remarks regarding the p-semiconducting materials and dopants from the above description of the prior art.

The p-type semiconductor is preferably producible or produced by applying at least one p-conducting organic material to at least one carrier element, wherein the application is effected for example by deposition from a liquid phase comprising the at least one p-conducting organic material. The deposition can in this case once again be effected, in principle, by any desired deposition process, for example by spin-coating, doctor blading, knife-coating, printing or combinations of the stated and/or other deposition methods.

The organic p-type semiconductor may especially comprise at least one Spiro compound such as spiro-MeOTAD and/or at least one compound with the structural formula:

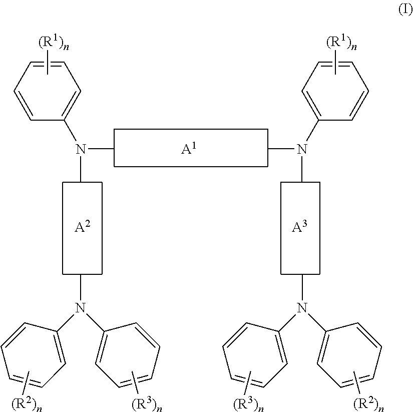

In which
A¹, A², A³ are each independently optionally substituted aryl groups or heteroaryl groups,
R¹, R², R³ are each independently selected from the group consisting of the substituents —R, —OR, —NR₂, -A⁴-OR and -A⁴-NR₂,
where R is selected from the group consisting of alkyl, aryl and heteroaryl,
and
where A⁴ is an aryl group or heteroaryl group, and
where n at each instance in formula I is independently a value of 0, 1, 2 or 3,
with the proviso that the sum of the individual n values is at least 2 and at least two of the R¹, R² and R³ radicals are —OR and/or —NR₂.

Preferably, A² and A³ are the same; accordingly, the compound of the formula (I) preferably has the following structure (Ia)

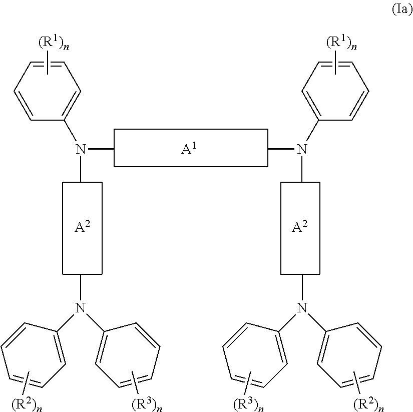

More particularly, as explained above, the p-type semiconductor may thus have at least one low molecular weight organic p-type semiconductor. A low molecular weight material is generally understood to mean a material which is present in monomeric, nonpolymerized or nonoligomerized form. The term “low molecular weight” as used in the present context preferably means that the p-type semiconductor has molecular weights in the range from 100 to 25 000 g/mol. Preferably, the low molecular weight substances have molecular weights of 500 to 2000 g/mol.

In general, in the context of the present invention, p-semiconducting properties are understood to mean the property of materials, especially of organic molecules, to form holes and to transport these holes and/or to pass them on to adjacent molecules. More particularly, stable oxidation of these molecules should be possible. In addition, the low molecular weight organic p-type semiconductors mentioned may especially have an extensive π-electron system. More particularly, the at least one low molecular weight p-type semiconductor may be processable from a solution. The low molecular weight p-type semiconductor may especially comprise at least one triphenylamine. It is particularly preferred when the low molecular weight organic p-type semiconductor comprises at least one Spiro compound. A Spiro compound is understood to mean polycyclic organic compounds whose rings are joined only at one atom, which is also referred to as the spiro atom. More particularly, the Spiro atom may be spa-hybridized, such that the constituents of the Spiro compound connected to one another via the Spiro atom are, for example, arranged in different planes with respect to one another.

More preferably, the Spiro compound has a structure of the following formula:

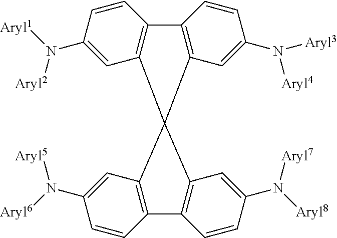

where the aryl¹, aryl², aryl³, aryl⁴, aryl⁵, aryl⁶, aryl⁷ and aryl⁸ radicals are each independently selected from substituted aryl radicals and heteroaryl radicals, especially from substituted phenyl radicals, where the aryl radicals and heteroaryl radicals, preferably the phenyl radicals, are each independently substituted, preferably in each case by one or more substituents selected from the group consisting of —O-alkyl, —OH, —F, —CI, —Br and —I, where alkyl is preferably methyl, ethyl, propyl or isopropyl. More preferably, the phenyl radicals are each independently substituted, in each case by one or more substituents selected from the group consisting of —O-Me, —OH, —F, —CI, —Br and —I.

Further preferably, the Spiro compound is a compound of the following formula:

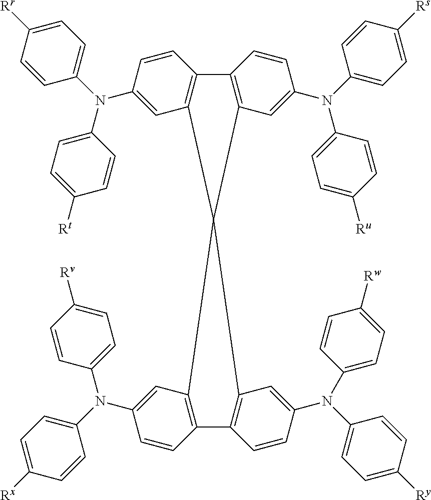

where R^{r}, R^{s}, R^{t}, R^{u}, R^{v}, R^{w}, R^{x} and R^{y} are each independently selected from the group consisting of —O-alkyl, —OH, —F, —CI, —Br and —I, where alkyl is preferably methyl, ethyl, propyl or isopropyl. More preferably, R^{r}, R^{s}, R^{t}, R^{u}, R^{v}, R^{w}, R^{x} and R^{y} are each independently selected from the group consisting of —O-Me, —OH, —F, —Cl, —Br and —I, preferably as disclosed in US 2014/0066656 A1.

More particularly, the p-type semiconductor may comprise spiro-MeOTAD or consist of spiro-MeOTAD, i.e. a compound of the formula below, commercially available from Merck KGaA, Darmstadt, Germany:

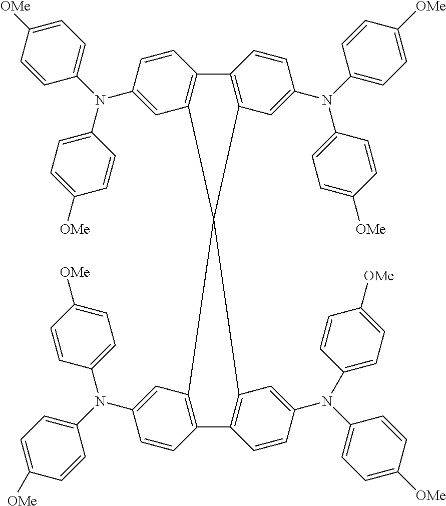 [SMILES: COc1ccc(N(c2ccc(OC)cc2)c2ccc3c(c2)C2(c4cc(N(c5ccc(OC)cc5)c5ccc(OC)cc5)ccc4-3)c3cc(N(c4ccc(OC)cc4)c4ccc(OC)cc4)ccc3-c3ccc(N(c4ccc(OC)cc4)c4ccc(OC)cc4)cc32)cc1]

Alternatively or additionally, it is also possible to use other p-semiconducting compounds, especially low molecular weight and/or oligomeric and/or polymeric p-semiconducting compounds.

In an alternative embodiment, the low molecular weight organic p-type semiconductor comprises one or more compounds of the above-mentioned general formula I, for which reference may be made, for example, to PCT application number PCT/EP2010/051826. The p-type semiconductor may comprise the at least one compound of the above-mentioned general formula I additionally or alternatively to the spiro compound described above.

The term “alkyl” or “alkyl group” or “alkyl radical” as used in the context of the present invention is understood to mean substituted or unsubstituted C₁-C₂₀-alkyl radicals in general. Preference is given to C₁- to C₁₀-alkyl radicals, particular preference to C₁- to C₈-alkyl radicals. The alkyl radicals may be either straight-chain or branched. In addition, the alkyl radicals may be substituted by one or more substituents selected from the group consisting of C₁-C₂₀-alkoxy, halogen, preferably F, and C₆-C₃₀-aryl which may in turn be substituted or unsubstituted. Examples of suitable alkyl groups are methyl, ethyl, propyl, butyl, pentyl, hexyl, heptyl and octyl, and also isopropyl, isobutyl, isopentyl, sec-butyl, tert-butyl, neopentyl, 3,3-dimethylbutyl, 2-ethylhexyl, and also derivatives of the alkyl groups mentioned substituted by C₆-C₂₀-aryl, C₁-C₂₀-alkoxy and/or halogen, especially F, for example CF₃.

The term “aryl” or “aryl group” or “aryl radical” as used in the context of the present invention is understood to mean optionally substituted C₆-C₃₀-aryl radicals which are derived from monocyclic, bicyclic, tricyclic or else multicyclic aromatic rings, where the aromatic rings do not comprise any ring heteroatoms. The aryl radical preferably comprises 5- and/or 6-membered aromatic rings. When the aryls are not monocyclic systems, in the case of the term “aryl” for the second ring, the saturated form (perhydro form) or the partly unsaturated form (for example the dihydro form or tetrahydro form), provided the particular forms are known and stable, is also possible. The term “aryl” in the context of the present invention thus comprises, for example, also bicyclic or tricyclic radicals in which either both or all three radicals are aromatic, and also bicyclic or tricyclic radicals in which only one ring is aromatic, and also tricyclic radicals in which two rings are aromatic. Examples of aryl are: phenyl, naphthyl, indanyl, 1,2-dihydronaphthenyl, 1,4-dihydronaphthenyl, fluorenyl, indenyl, anthracenyl, phenanthrenyl or 1,2,3,4-tetrahydronaphthyl. Particular preference is given to C₆-C₁₀-aryl radicals, for example phenyl or naphthyl, very particular preference to C₆-aryl radicals, for example phenyl. In addition, the term “aryl” also comprises ring systems comprising at least two monocyclic, bicyclic or multicyclic aromatic rings joined to one another via single or double bonds. One example is that of biphenyl groups.

The term “heteroaryl” or “heteroaryl group” or “heteroaryl radical” as used in the context of the present invention is understood to mean optionally substituted 5- or 6-membered aromatic rings and multicyclic rings, for example bicyclic and tricyclic compounds having at least one heteroatom in at least one ring. The heteroaryls in the context of the invention preferably comprise 5 to 30 ring atoms. They may be monocyclic, bicyclic or tricyclic, and some can be derived from the aforementioned aryl by replacing at least one carbon atom in the aryl base skeleton with a heteroatom. Preferred heteroatoms are N, O and S. The hetaryl radicals more preferably have 5 to 13 ring atoms. The base skeleton of the heteroaryl radicals is especially preferably selected from systems such as pyridine and five-membered heteroaromatics such as thiophene, pyrrole, imidazole or furan. These base skeletons may optionally be fused to one or two six-membered aromatic radicals. In addition, the term “heteroaryl” also comprises ring systems comprising at least two monocyclic, bicyclic or multicyclic aromatic rings joined to one another via single or double bonds, where at least one ring comprises a heteroatom. When the heteroaryls are not monocyclic systems, in the case of the term “heteroaryl” for at least one ring, the saturated form (perhydro form) or the partly unsaturated form (for example the dihydro form or tetrahydro form), provided the particular forms are known and stable, is also possible. The term “heteroaryl” in the context of the present invention thus comprises, for example, also bicyclic or tricyclic radicals in which either both or all three radicals are aromatic, and also bicyclic or tricyclic radicals in which only one ring is aromatic, and also tricyclic radicals in which two rings are aromatic, where at least one of the rings, i.e. at least one aromatic or one nonaromatic ring, has a heteroatom. Suitable fused heteroaromatics are, for example, carbazolyl, benzimidazolyl, benzofuryl, dibenzofuryl or dibenzothiophenyl. The base skeleton may be substituted at one, more than one or all substitutable positions, suitable substituents being the same as have already been specified under the definition of C₆-C₃₀-aryl. However, the hetaryl radicals are preferably unsubstituted. Suitable hetaryl radicals are, for example, pyridin-2-yl, pyridin-3-yl, pyridin-4-yl, thiophen-2-yl, thiophen-3-yl, pyrrol-2-yl, pyrrol-3-yl, furan-2-yl, furan-3-yl and imidazol-2-yl and the corresponding benzofused radicals, especially carbazolyl, benzimidazolyl, benzofuryl, dibenzofuryl or dibenzothiophenyl.

In the context of the invention, the term “optionally substituted” refers to radicals in which at least one hydrogen radical of an alkyl group, aryl group or heteroaryl group has been replaced by a substituent. With regard to the type of this substituent, preference is given to alkyl radicals, for example methyl, ethyl, propyl, butyl, pentyl, hexyl, heptyl and octyl, and also isopropyl, isobutyl, isopentyl, sec-butyl, tert-butyl, neopentyl, 3,3-dimethylbutyl and 2-ethylhexyl, aryl radicals, for example C₆-C₁₀-aryl radicals, especially phenyl or naphthyl, most preferably C₆-aryl radicals, for example phenyl, and hetaryl radicals, for example pyridin-2-yl, pyridin-3-yl, pyridin-4-yl, thiophen-2-yl, thiophen-3-yl, pyrrol-2-yl, pyrrol-3-yl, furan-2-yl, furan-3-yl and imidazol-2-yl, and also the corresponding benzofused radicals, especially carbazolyl, benzimidazolyl, benzofuryl, dibenzofuryl or dibenzothiophenyl. Further examples include the following substituents: alkenyl, alkynyl, halogen, hydroxyl.

The degree of substitution here may vary from monosubstitution up to the maximum number of possible substituents.

Preferred compounds of the formula I for use in accordance with the invention are notable in that at least two of the R¹, R² and R³ radicals are para-OR and/or —NR₂ substituents. The at least two radicals here may be only —OR radicals, only —NR₂ radicals, or at least one —OR and at least one —NR₂ radical.

Particularly preferred compounds of the formula I for use in accordance with the invention are notable in that at least four of the R¹, R² and R³ radicals are para-OR and/or —NR₂ substituents. The at least four radicals here may be only —OR radicals, only —NR₂ radicals or a mixture of —OR and —NR₂ radicals.

Very particularly preferred compounds of the formula I for use in accordance with the invention are notable in that all of the R¹, R² and R³ radicals are para-OR and/or —NR₂ substituents. They may be only —OR radicals, only —NR₂ radicals or a mixture of —OR and —NR₂ radicals.

In all cases, the two R in the —NR₂ radicals may be different from one another, but they are preferably the same.

Preferably, A¹, A² and A³ are each independently selected from the group consisting of

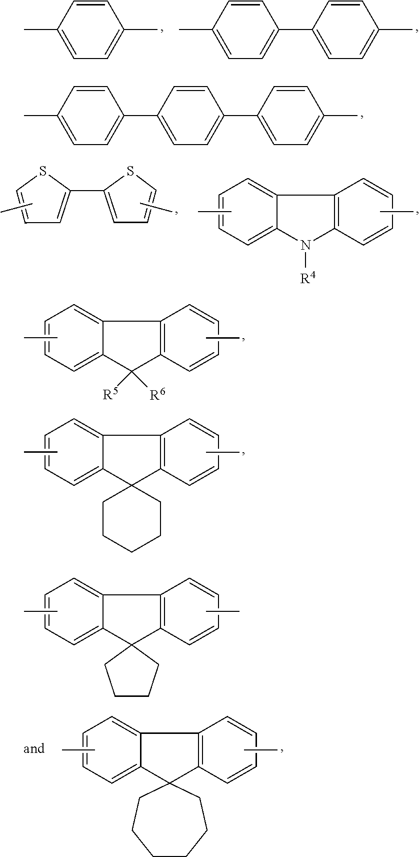

In which
m is an integer from 1 to 18,
R⁴ is alkyl, aryl or heteroaryl, where R⁴ is preferably an aryl radical, more preferably a phenyl radical,
R⁵, R⁶ are each independently H, alkyl, aryl or heteroaryl,
   where the aromatic and heteroaromatic rings of the structures shown may optionally have further substitution. The degree of substitution of the aromatic and heteroaromatic rings here may vary from monosubstitution up to the maximum number of possible substituents.

Preferred substituents in the case of further substitution of the aromatic and heteroaromatic rings include the substituents already mentioned above for the one, two or three optionally substituted aromatic or heteroaromatic groups.

Preferably, the aromatic and heteroaromatic rings of the structures shown do not have further substitution.

More preferably, A¹, A² and A³ are each independently

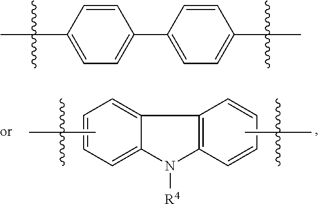

more preferably

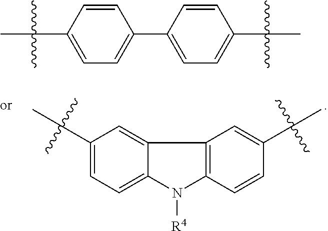

More preferably, the at least one compound of the formula (I) has one of the following structures

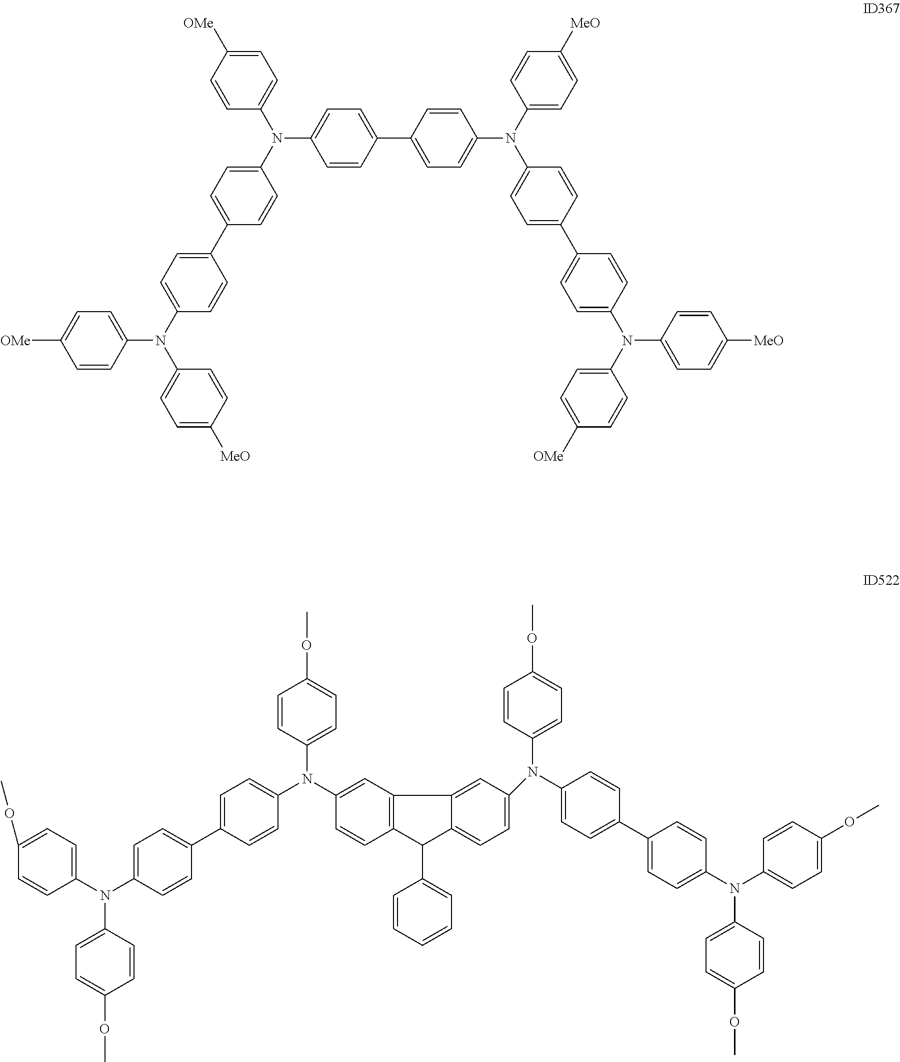

In an alternative embodiment, the organic p-type semiconductor comprises a compound of the type ID322 having the following structure:

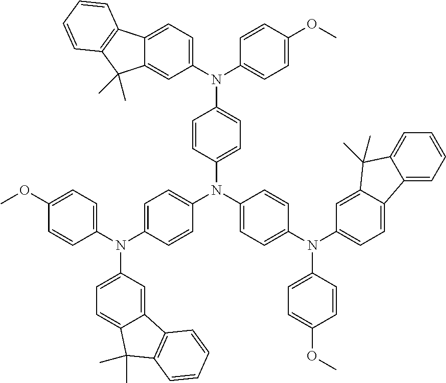 [SMILES: COc1ccc(N(c2ccc(N(c3ccc(N(c4ccc(OC)cc4)c4ccc5c(c4)C(C)(C)c4ccccc4-5)cc3)c3ccc(N(c4ccc(OC)cc4)c4ccc5c(c4)C(C)(C)c4ccccc4-5)cc3)cc2)c2ccc3c(c2)-c2ccccc2C3(C)C)cc1]

The compounds for use in accordance with the invention can be prepared by customary methods of organic synthesis known to those skilled in the art. References to relevant (patent) literature can additionally be found in the synthesis examples adduced below.

d) Second Electrode

The second electrode may be a bottom electrode facing the substrate or else a top electrode facing away from the substrate. As outlined above, the second electrode may be fully or partially transparent or else, may be intransparent. As used herein, the term partially transparent refers to the fact that the second electrode may comprise transparent regions and intransparent regions.

One or more materials of the following group of materials may be used: at least one metallic material, preferably a metallic material selected from the group consisting of aluminum, silver, platinum, gold; at least one nonmetallic inorganic material, preferably LiF; at least one organic conductive material, preferably at least one electrically conductive polymer and, more preferably, at least one transparent electrically conductive polymer.

The second electrode may comprise at least one metal electrode, wherein one or more metals in pure form or as a mixture/alloy, such as especially aluminum or silver may be used.

Additionally or alternatively, nonmetallic materials may be used, such as inorganic materials and/or organic materials, both alone and in combination with metal electrodes. As an example, the use of inorganic/organic mixed electrodes or multilayer electrodes is possible, for example the use of LiF/Al electrodes. Additionally or alternatively, conductive polymers may be used. Thus, the second electrode of the optical sensor preferably may comprise one or more conductive polymers.

Thus, as an example, the second electrode may comprise one or more electrically conductive polymers, in combination with one or more layers of a metal. Preferably, the at least one electrically conductive polymer is a transparent electrically conductive polymer. This combination allows for providing very thin and, thus, transparent metal layers, by still providing sufficient electrical conductivity in order to render the second electrode both transparent and highly electrically conductive. Thus, as an example, the one or more metal layers, each or in combination, may have a thickness of less than 50 nm, preferably less than 40 nm or even less than 30 nm.

As an example, one or more electrically conductive polymers may be used, selected from the group consisting of: polyanaline (PANI) and/or its chemical relatives; a polythiophene and/or its chemical relatives, such as poly(3-hexylthiophene) (P3HT) and/or PEDOT:PSS (poly(3,4-ethylenedioxythiophene) poly(styrenesulfonate)). Additionally or alternatively, one or more of the conductive polymers as disclosed in EP2507286 A2, EP2205657 A1 or EP2220141 A1. For further exemplary embodiments, reference may be made to U.S. provisional application No. 61/739,173 or U.S. provisional application No. 61/708,058, the full content of all of which is herewith included by reference.

In addition or alternatively, inorganic conductive materials may be used, such as inorganic conductive carbon materials, such as carbon materials selected from the group consisting of: graphite, graphene, carbon nano-tubes, carbon nano-wires.

In addition, it is also possible to use electrode designs in which the quantum efficiency of the components is increased by virtue of the photons being forced, by means of appropriate reflections, to pass through the absorbing layers at least twice. Such layer structures are also referred to as “concentrators” and are likewise described, for example, in WO 02/101838 (especially pages 23-24).

The at least one second electrode of the optical sensor may be a single electrode or may comprise a plurality of partial electrodes. Thus, a single second electrode may be used, or more complex setups, such as split electrodes.

Further, the at least one second electrode of the at least one optical sensor, which specifically may be or may comprise at least one longitudinal optical sensor and/or at least one transversal optical sensor, preferably may fully or partially be transparent. Thus, specifically, the at least one second electrode may comprise one, two or more electrodes, such as one electrode or two or more partial electrodes, and optionally at least one additional electrode material contacting the electrode or the two or more partial electrodes.

Further, the second electrode may fully or partially be intransparent. Specifically, the two or more partial electrodes may be intransparent. It may be especially preferable to make the final electrode intransparent, such as the electrode facing away from the object and/or the last electrode of a stack of optical sensors. Consequently, this last electrode can then be optimized to convert all remaining light into a sensor signal. Herein, the “final” electrode may be the electrode of the at least one optical sensor facing away from the object. Generally, intransparent electrodes are more efficient than transparent electrodes.

Thus, it is generally beneficial to reduce the number of transparent sensors and/or the number of transparent electrodes to a minimum. In this context, as an example, reference may be made to the potential setups of the at least one longitudinal optical sensor and/or to the at least one transversal optical sensor as shown in WO2014/097181 A1. Other setups, however, are feasible.

The optical detector, the detector system, the method, the human-machine interface, the entertainment device, the tracking system, the camera and the uses of the optical detector provide a large number of advantages over known devices, methods and uses of this type.

Further embodiments relate to a beam path of the light beam or a part thereof within the optical detector. As used herein and as used in the following, a “beam path” generally is a path along which a light beam or a part thereof may propagate. Thus, generally, the light beam within the optical detector may travel along a single beam path. The single beam path may be a straight single beam path or may be a beam path having one or more deflections, such as a folded beam path, a branched beam path, a rectangular beam path or a Z-shaped beam path. Alternatively, two or more beam paths may be present within the optical detector. Thus, the light beam entering the optical detector may be split into two or more partial light beams, each of the partial light beams following one or more partial beam paths. Each of the partial beam paths, independently, may be a straight partial beam path or, as outlined above, a partial beam path having one or more deflections, such as a folded partial beam path, a rectangular partial beam path or a Z-shaped partial beam path. Generally, any type of combination of various types of beam paths is feasible, as the skilled person will recognize. Thus, at least two partial beam paths may be present, forming, in total, a W-shaped setup.

By splitting the beam path into two or more partial beam paths, the elements of the optical detector may be distributed over the two or more partial beam paths. Thus, at least one optical sensor, such as at least one large-area optical sensor and/or at least one stack of large-area optical sensors, such as one or more optical sensors having the above-mentioned FiP-effect, may be located in a first partial beam path. At least one additional optical sensor, such as an intransparent optical sensor, e.g. an image sensor such as a CCD sensor and/or a CMOS sensor may be located in a second partial beam path. Further, the at least one focus-tunable lens may be located in one or more of the partial beam paths and/or may be located in a common beam path before splitting the common beam path into two or more partial beam paths. Various setups are feasible. Further, the light beam and/or the partial light beam may travel along the beam path or the partial beam path in a unidirectional fashion, such as only once or in a single travel fashion. Alternatively, the light beam or the partial light beam may travel along the beam path or the partial beam path repeatedly, such as in ring-shaped setups, and/or in a bidirectional fashion, such as in a setup in which the light beam or the partial light beam is reflected by one or more reflective elements, in order to travel back along the same beam path or partial beam path. The at feast one reflector element may be or may comprise the focus-tunable lens itself. Similarly, for splitting the beam path into two or more partial beam paths, a spatial light modulator itself or, alternatively, other types of reflective elements may be used.

By using two or more partial beam paths within the optical detector and/or by having the light beam or the partial light beam travelling along the beam path or the partial beam path repeatedly or in a bidirectional fashion, various setups of the optical detector are feasible, which allow for a high flexibility of the setup of the optical detector. Thus, the functionalities of the optical detector may be split and/or distributed over different partial beam paths. Thus, a first partial beam path may be dedicated to a z-detection of an object, such as by using one or more optical sensors having the above-mentioned FiP-effect, and a second beam path may be used for imaging, such as by providing one or more image sensors such as one or more CCD chips or CMOS chips for imaging. Thus, within one, more than one or all of the partial beam paths, independent or dependent coordinate systems may be defined, wherein one or more coordinates of the object may be determined within these coordinate systems. Since the general setup of the optical detector is known, the coordinate systems may be correlated, and a simple coordinate transformation may be used for combining the coordinates in a common coordinate system of the optical detector.

As outlined above, additionally or alternatively, the optical detector may contain at least one beam-splitting element adapted for dividing the beam path of the light beam into at least two partial beam paths. The beam-splitting element may be embodied in various ways and/or by using combinations of beam-splitting elements. Thus, as an example, the beam-splitting element may comprise at least one element selected from the group consisting of: a beam-splitting prism, a grating, a semitransparent mirror, a dichroitic mirror, a spatial light modulator. Combinations of the named elements and/or other elements are feasible. As outlined above, the elements of the optical detector may be distributed over the beam paths, before and/or after splitting the beam path. Thus, as an example, at least one optical sensor may be located in each of the partial beam paths. Thus, e.g., at least one stack of optical sensors, such as at least one stack of large-area optical sensors and, more preferably, at least one stack of optical sensors having the above-mentioned FiP-effect, may be located in at least one of the partial beam paths, such as in a first one of the partial beam paths. Additionally or alternatively, at least one intransparent optical sensor may be located in at least one of the partial beam paths, such as in at least a second one of the partial beam paths. Thus, as an example, at least one inorganic optical sensor may be located in a second partial beam path, such as an inorganic semiconductor optical sensor, such as an image sensor and/or a camera chip, more preferably a CCD chip and/or a CMOS chip, wherein both monochrome chips and/or multi-chrome or full-color chips may be used. Thus, as outlined above, the first partial beam path, by using the stack of optical sensors, may be used for detecting the z-coordinate of the object, and the second partial beam path may be used for imaging, such as by using the image sensor, specifically the camera chip.

In case one or more intransparent optical sensors are used, such as in one or more of the partial beam paths, such as in the second partial beam path, the intransparent optical sensor preferably may be or may comprise a pixelated optical sensor, preferably an inorganic pixelated optical sensor and more preferably a camera chip, and most preferably at least one of a CCD chip and CMOS chip. However, other embodiments are feasible, and combinations of pixelated and non-pixelated intransparent optical sensors in one or more of the partial optical beam paths are feasible.

Therein, linear or non-linear setups of the optical detector may be feasible. Thus, as outlined above, W-shaped setups, Z-shaped setups or other setups are feasible. As opposed to a linear setup, a non-linear setup such as a setup having two or more partial beam paths, such as a branched setup and/or a W-setup, may allow for individually optimizing the setups of the partial beam paths. Thus, in case the imaging function by the at least one image sensor and the function of the z-detection are separated in separate partial beam paths, an independent optimization of these partial beam paths and the elements disposed therein is feasible. Thus, as an example, different types of optical sensors such as transparent solar cells may be used in the partial beam path adapted for z-detection, since transparency is less important as in the case in which the same light beam has to be used for imaging by the imaging detector. Thus, combinations with various types of cameras are feasible. As an example, thicker stacks of optical detectors may be used, allowing for a more accurate z-information. Consequently, even in case the stack of optical sensors should be out of focus, a detection of the z-position of the object is feasible.

Further, one or more additional elements may be located in one or more of the partial beam paths. As an example, one or more optical shutters may be disposed within one or more of the partial beam paths. Thus, one or more shutters may be located between the focus-tunable lens and the stack of optical sensors and/or the intransparent optical sensor such as the image sensor. The shutters of the partial beam paths may be used and/or actuated independently. Thus, as an example, one or more image sensors, specifically one or more imaging chips such as CCD chips and/or CMOS chips, and the large-area optical sensor and/or the stack of large area optical sensors generally may exhibit different types of optimum light responses. In a linear arrangement, only one additional shutter may be possible, such as between the large-area optical sensor or stack of large-area optical sensors and the image sensor. In a split setup having two or more partial beam paths, such as in the above-mentioned W-setup, one or more shutters may be placed in front of the stack of optical sensors and/or in front of the image sensor. Thereby, optimum light intensities for both types of sensors may be feasible.

Additionally or alternatively, one or more lenses may be disposed within one or more of the partial beam paths. Thus, one or more lenses may be located between the focus-tunable lens and the stack of optical sensors. Thus, as an example, by using the one or more lenses in one or more or all of the partial beam paths, a beam shaping may take place for the respective partial beams path or partial beam paths comprising the at least one lens. Thus, the image sensor, specifically the CCD or CMOS sensor, may be adapted to take a 2D picture, whereas the at least one optical sensor such as the optical sensor stack may be adapted to measure a z-coordinate or depth of the object. The focus or the beam shaping in these partial beam paths, which generally may be determined by the respective lenses of these partial beam paths, does not necessarily have to be identical. Thus, the beam properties of the partial light beams propagating along the partial beam paths may be optimized individually, such as for imaging, xy-detection or z-detection.

Further embodiments generally refer to the at least one optical sensor. Generally, for potential embodiments of the at least one optical sensor, as outlined above, reference may be made to one or more of the prior art documents listed above, such as to WO 2012/110924 A1 and/or to WO 2014/097181 A1. Thus, as outlined above, the at least one optical sensor may comprise at least one longitudinal optical sensor and/or at least one transversal optical sensor, as described e.g. In WO 2014/097181 A1. Specifically, the at least one optical sensor may be or may comprise at least one organic photodetector, such as at least one organic solar cell, more preferably a dye-sensitized solar cell, further preferably a solid dye sensitized solar cell, having a layer setup comprising at least one first electrode, at least one n-semiconducting metal oxide, at least one dye, at least one p-semiconducting organic material, preferably a solid p-semiconducting organic material, and at least one second electrode. For potential embodiments of this layer setup, reference may be made to one or more of the above-mentioned prior art documents.

The at least one optical sensor may be or may comprise at least one large-area optical sensor, having a single optically sensitive sensor area. Still, additionally or alternatively, the at least one optical sensor may as well be or may comprise at least one pixelated optical sensor, having two or more sensitive sensor areas, i.e. two or more sensor pixels. Thus, the at least one optical sensor may comprise a sensor matrix having two or more sensor pixels.

As outlined above, the at least one optical sensor may be or may comprise at least one intransparent optical sensor. Additionally or alternatively, the at least one optical sensor may be or may comprise at least one transparent or semitransparent optical sensor. Generally, however, in case one or more pixelated transparent optical sensors are used, in many devices known in the art, the combination of transparency and pixelation imposes some technical challenges. Thus, generally, optical sensors known in the art both contain sensitive areas and appropriate driving electronics. Still, in this context, the problem of generating transparent electronics generally remains unsolved.

As it turned out in the context of the present invention, it may be preferable to split an active area of the at least one optical sensor into an array of 2×N sensor pixels, with N being an integer, wherein, preferably, N 1, such as N=1, N=2, N=3, N=4 or an integer >4. Thus, generally, the at least one optical sensor may comprise a matrix of sensor pixels having 2×N sensor pixels, with N being an integer. The matrix, as an example, may form two rows of sensor pixels, wherein, as an example, the sensor pixels of a first row are electrically contacted from a first side of the optical sensor and wherein the sensor pixels of a second row are electrically contacted from a second side of the optical sensor opposing the first side. In a further embodiment, the first and last pixels of the two rows of N pixels may further be split up into pixels that are electrically contacted from the third and fourth side of the sensor. As an example, this would lead to a setup of 2×M+2×N pixels. Further embodiments are feasible.

In case two or more optical sensors are comprised in the optical detector, one, two or more optical sensors may comprise the above-mentioned array of sensor pixels. Thus, in case a plurality of optical sensors is provided, one optical sensor, more than one optical sensor or even all optical sensors may be pixelated optical sensors. Alternatively, one optical sensor, more than one optical sensor or even all optical sensors may be non-pixelated optical sensors, i.e. large area optical sensors.

In case the above-mentioned setup of the optical sensor is used, including at least one optical sensor having a layer setup comprising at least one first electrode, at least one n-semiconducting metal oxide, at least one dye, at least one p-semiconducting organic material, preferably a solid p-semiconducting organic material, and at least one second electrode, the use of a matrix of sensor pixels is specifically advantageous. As outlined above, these types of devices specifically may exhibit the FiP-effect.

In these devices, such as FiP-devices, a 2×N-array of sensor pixels is very well suited. Thus, generally, at least one first, transparent electrode and at least one second electrode, with one or more layers sandwiched in between, a pixelation into two or more sensor pixels specifically may be achieved by splitting one or both of the first electrode and the second electrode into an array of electrodes. As an example, for the transparent electrode, such as a transparent electrode comprising fluorinated tin oxide and/or another transparent conductive oxide, preferably disposed on a transparent substrate, a pixelation may easily be achieved by appropriate patterning techniques, such as patterning by using lithography and/or laser patterning. Thereby, the electrodes may easily be split into an area of partial electrodes, wherein each partial electrode forms a pixel electrode of a sensor pixel of the array of sensor pixels. The remaining layers, as well as optionally the second electrode, may remain unpatterned, or may, alternatively, be patterned as well. In case a split transparent conductive oxide such as fluorinated tin oxide is used, in conjunction with unpatterned further layers, cross conductivities in the remaining layers may generally be neglected, at least for dye-sensitized solar cells. Thus, generally, a crosstalk between the sensor pixels may be neglected. Each sensor pixel may comprise a single counter electrode, such as a single silver electrode.

Using at least one optical sensor having an array of sensor pixels, specifically a 2×N array, provides several advantages within the present invention, i.e. within one or more of the devices disclosed by the present invention. Thus, firstly, using the array may improve the signal quality. The modulator device of the optical detector may modulate each pixel of the optical sensor, such as with a distinct modulation frequency, thereby e.g. modulating each depth area with a distinct frequency. At high frequencies, however, the signal of the at least one optical sensor, such as the at least one FiP-sensor, generally decreases, thereby leading to a low signal strength. Therefore, generally, only a limited number of modulation frequencies may be used in the modulator device. If the optical sensor, however, is split up into sensor pixels, the number of possible depth points that can be detected may be multiplied with the number of pixels. Thus, as an example, two pixels may result in a doubling of the number of modulation frequencies which may be detected and, thus, may result in a doubling of the number of pixels which may be modulated and/or may result in a doubling of the number of depth points.

Further, as opposed to a conventional camera, the shape of the pixels is not relevant for the appearance of the picture. Thus, generally, the shape and/or size of the sensor pixels may be chosen with no or little constraints, thereby allowing for choosing an appropriate design of the array of sensor pixels.

Further, the sensor pixels generally may be chosen rather small. The frequency range which may generally be detected by a sensor pixel is typically increased by decreasing the size of the sensor pixel. The frequency range typically improves, when smaller sensors or sensor pixels are used. In a small sensor pixel, more frequencies may be detected as compared to a large sensor pixel. Consequently, by using smaller sensor pixels, a larger number of depth points may be detected as compared to using large pixels.

Summarizing the above-mentioned findings, the following embodiments are preferred within the present invention:

### Embodiment 1

An optical detector, comprising:
at least one optical sensor adapted to detect a light beam and to generate at least one sensor signal, wherein the optical sensor has at least one sensor region, wherein the sensor signal of the optical sensor is dependent on an illumination of the sensor region by the light beam, wherein the sensor signal, given the same total power of the illumination, is dependent on a width of the light beam in the sensor region;
at least one focus-tunable lens located in at least one beam path of the light beam, the focus-tunable lens being adapted to modify a focal position of the light beam in a controlled fashion;
at least one focus-modulation device adapted to provide at least one focus-modulating signal to the focus-tunable lens, thereby modulating the focal position;
at least one imaging device being adapted to record an image; and
at least one evaluation device, the evaluation device being adapted to evaluate the sensor signal and, depending on the sensor signal, to effect a recording of the image by the imaging device.

### Embodiment 2

The optical detector according to the preceding embodiment, wherein the focus-tunable lens comprises at least one transparent shapeable material.

### Embodiment 3

The optical detector according to the preceding embodiment, wherein the shapeable material is selected from the group consisting of a transparent liquid and a transparent organic material, preferably a polymer, more preferably an electroactive polymer.

### Embodiment 4

The optical detector according to any one of the two preceding embodiments, wherein the focus-tunable lens further comprises at least one actuator for shaping at least one interface of the shapeable material.

### Embodiment 5

The optical detector according to the preceding embodiment, wherein the actuator is selected from the group consisting of a liquid actuator for controlling an amount of liquid in a lens zone of the focus-tunable lens or an electrical actuator adapted for electrically changing the shape of the interface of the shapeable material.

### Embodiment 6

The optical detector according to any one of the preceding embodiments, wherein the focus-tunable lens comprises at least one liquid and at least two electrodes, wherein the shape of at least one interface of the liquid is changeable by applying one or both of a voltage or a current to the electrodes, preferably by electro-wetting.

### Embodiment 7

The optical detector according to any one of the preceding embodiments, wherein the sensor signal of the optical sensor is further dependent on a modulation frequency of the light beam.

### Embodiment 8

The optical detector according to any one of the preceding embodiments, wherein the focus-modulation device is adapted to provide a periodic focus-modulating signal.

### Embodiment 9

The optical detector according to the preceding embodiment, wherein the periodic focus-modulating signal is a sinusoidal signal, a square signal, or a triangular signal.

### Embodiment 10

The optical detector according to any one of the preceding embodiments, wherein the evaluation device is adapted to detect one or both of local maxima or local minima in the sensor signal.

### Embodiment 11

The optical detector according to the preceding embodiment, wherein the evaluation device is adapted to compare the local maxima and/or local minima to an internal clock signal.

### Embodiment 12

The optical detector according to any one of the two preceding embodiments, wherein the evaluation device is adapted to detect the phase shift difference between the local maxima and/or the local minima.

### Embodiment 13

The optical detector according to any one of the three preceding embodiments, wherein the evaluation device is adapted to derive at least one item of information on a longitudinal position of at least one object from which the light beam propagates towards the optical detector by evaluating one or both of the local maxima or local minima.

### Embodiment 14

The optical detector according to any one of the preceding embodiments, wherein the evaluation device is adapted to perform a phase-sensitive evaluation of the sensor signal.

### Embodiment 15

The optical detector according to the preceding embodiment, wherein the phase-sensitive evaluation comprises one or both of determining a position of one or both of local maxima or local minima in the sensor signal or a lock-in detection.

### Embodiment 16

The optical detector according to any one of the preceding embodiments, wherein the evaluation device is adapted to generate at least one item of information on a longitudinal position of at least one object from which the light beam propagates towards the optical detector by evaluating the sensor signal.

### Embodiment 17

The optical detector according to the preceding embodiment, wherein the evaluation device is adapted to use at least one predetermined or determinable relationship between the longitudinal position and the sensor signal.

### Embodiment 18

The optical detector according to any one of the preceding embodiments, wherein the optical detector further comprises at least one transversal optical sensor, the transversal optical sensor being adapted to determine one or more of a transversal position of the light beam, a transversal position of an object from which the light beam propagates towards the optical detector or a transversal position of a light spot generated by the light beam, the transversal position being a position in at least one dimension perpendicular to an optical axis of the optical detector, the transversal optical sensor being adapted to generate at least one transversal sensor signal.

### Embodiment 19

The optical detector according to the preceding embodiment, wherein the evaluation device is further adapted to generate at least one item of information on a transversal position of the object by evaluating the transversal sensor signal.

### Embodiment 20

The optical detector according to any one of the two preceding embodiments, wherein the transversal optical sensor is a photo detector having at least one first electrode, at least one second electrode and at least one photovoltaic material, wherein the photovoltaic material is embedded in between the first electrode and the second electrode, wherein the photovoltaic material is adapted to generate electric charges in response to an illumination of the photovoltaic material with light, wherein the second electrode is a split electrode having at least two partial electrodes, wherein the transversal optical sensor has a sensor region, wherein the at least one transversal sensor signal indicates a position of the light beam in the sensor region.

### Embodiment 21

The optical detector according to the preceding embodiment, wherein electrical currents through the partial electrodes are dependent on a position of the light beam in the sensor region, wherein the transversal optical sensor is adapted to generate the transversal sensor signal in accordance with the electrical currents through the partial electrodes.

### Embodiment 22

The optical detector according to the preceding embodiment, wherein the detector is adapted to derive the information on the transversal position of the object from at least one ratio of the currents through the partial electrodes.

### Embodiment 23

The optical detector according to any of the three preceding embodiments, wherein the photo detector is a dye-sensitized solar cell.

### Embodiment 24

The optical detector according to any of the four preceding embodiments, wherein the first electrode at least partially is made of at least one transparent conductive oxide, wherein the second electrode at least partially is made of an electrically conductive polymer, preferably a transparent electrically conductive polymer.

### Embodiment 25

The optical detector according to any one of the preceding embodiments, wherein the at least one optical sensor comprises a stack of at least two optical sensors.

### Embodiment 26

The optical detector according to the preceding embodiment, wherein at least one of the optical sensors of the stack is an at least partially transparent optical sensor.

### Embodiment 27

The optical detector according to any one of the preceding embodiments, wherein the imaging device comprises a plurality of light-sensitive pixels.

### Embodiment 28

The optical detector according to any one of the preceding embodiments, wherein the optical sensor constitutes the at least one imaging device.

### Embodiment 29

The optical detector according to the preceding embodiment, wherein the imaging device comprises an inorganic image sensor.

### Embodiment 30

The optical detector according to the preceding embodiment, wherein the imaging device comprises at least one of a CCD device or a CMOS device.

### Embodiment 31

The optical detector according to any of the two preceding embodiments, wherein the image sensor comprises a matrix of image pixels.

### Embodiment 32

The optical detector according to any one of the three preceding embodiments, wherein the image sensor may be employed as a transversal optical sensor being adapted to determine one or more of a transversal position of the light beam, a transversal position of an object from which the light beam propagates towards the optical detector or a transversal position of a light spot generated by the light beam, the transversal position being a position in at least one dimension perpendicular an optical axis of the optical detector, the transversal optical sensor being adapted to generate at least one transversal sensor signal.

### Embodiment 33

The optical detector according to any one of the four preceding embodiments, wherein the evaluation device is further adapted to generate at least one item of information on a transversal position of the object by evaluating the transversal sensor signal.

### Embodiment 34

The optical detector according to any one of the four preceding embodiments, wherein the optical sensor is a pixelated optical sensor comprising an array of sensor pixels.

### Embodiment 35

The optical detector according to the preceding embodiment, wherein the image sensor has a first pixel resolution, wherein the pixelated optical sensor has a second pixel resolution, wherein the first pixel resolution equals or exceeds the second pixel resolution.

### Embodiment 36

The optical detector according to the preceding embodiment, wherein, for the sensor pixel, a pixel matrix of at least 4×4 image pixels, preferably of at least 16×16 image pixels, more preferably of at least 64×64 image pixels, is comprised.

### Embodiment 37

The optical detector according to any one of the preceding seven embodiments, wherein the optical sensor and the image sensor constitute a hybrid sensor.

### Embodiment 38

The optical detector according to any one of the two preceding embodiments, wherein the optical sensor and the image sensor in the hybrid sensor are arranged in a vicinity with respect to each other.

### Embodiment 39

The optical detector according to the preceding embodiment, wherein the optical sensor or a part thereof and the image sensor or a part thereof touch each other.

### Embodiment 40

The optical detector according to any one of the three preceding embodiments, wherein the optical sensor and the image sensor in the hybrid sensor are arranged in a manner that the light beam first impinges on the optical sensor before impinging on the image sensor

### Embodiment 41

The optical detector according to any one of the four preceding embodiments, wherein the pixelated optical sensor and the image sensor in the hybrid sensor are electrically connected.

### Embodiment 42

The optical detector according to the preceding embodiment, wherein the optical sensor and the image sensor are electrically connected by using a bonding technique, in particular one or more of wire bonding, direct bonding, ball bonding, or adhesive bonding.

### Embodiment 43

The optical detector according to any one of the two preceding embodiments, wherein the sensor pixel of the pixelated optical sensor is electrically connected to a top contact provided by the image pixel of the image sensor.

### Embodiment 44

The optical detector according to any one of the preceding embodiments, wherein the optical sensor comprises at least two electrodes and at least one photovoltaic material embedded in between the at least two electrodes.

### Embodiment 45

The optical detector according to any one of the preceding embodiments, wherein the optical sensor comprises at least one organic semiconductor detector having at least one organic material, preferably an organic solar cell and particularly preferably a dye solar cell or dye-sensitized solar cell, in particular a solid dye solar cell or a solid dye-sensitized solar cell.

### Embodiment 46

The optical detector according to the preceding embodiment, wherein the optical sensor comprises at least one first electrode, at least one n-semiconducting metal oxide, at least one dye, at least one p-semiconducting organic material, preferably a solid p-semiconducting organic material, and at least one second electrode.

### Embodiment 47

The optical detector according to the preceding embodiment, wherein both the first electrode and the second electrode are transparent.

### Embodiment 48

The optical detector according to any of the preceding embodiments, furthermore comprising at least one transfer device, wherein the transfer device is designed to feed light emerging from the object to the transversal optical sensor and the longitudinal optical sensor.

### Embodiment 49

The optical detector according to the preceding embodiment, wherein the at least one focus-tunable lens is fully or partially part of the transfer device.

### Embodiment 50

The optical detector according to any one of the preceding embodiments, wherein the at least one optical sensor comprises at least one large-area optical sensor.

### Embodiment 51

The optical detector according to any one of the sixteen preceding embodiments, wherein the optical detector contains at least one beam-splitting element adapted for dividing at least one beam path of the light beam into at least two partial beam paths.

### Embodiment 52

The optical detector according to the preceding embodiment, wherein the beam-splitting element comprises the spatial light modulator.

### Embodiment 53

The optical detector according to the preceding embodiment, wherein the at least one optical sensor is located in at least one of the partial beam paths.

### Embodiment 54

The optical detector according to any one of the two preceding embodiments, wherein the at least one imaging device is located in at least one of the partial beam paths.

### Embodiment 55

The optical detector according to the preceding embodiment, wherein the optical sensor and the imaging device are located at different partial beam paths.

### Embodiment 56

A detector system for determining a position of at least one object, the detector system comprising at least one optical detector according to any one of the preceding embodiments, the detector system further comprising at least one beacon device adapted to direct at least one light beam towards the optical detector, wherein the beacon device is at least one of attachable to the object, holdable by the object and integratable into the object.

### Embodiment 57

A human-machine interface for exchanging at least one item of information between a user and a machine, the human-machine interface comprising at least one optical detector according to any one of the preceding embodiments referring to an optical detector.

### Embodiment 58

The human-machine interface according to the preceding embodiment, wherein the human-machine interface comprises at least one detector system according to any one of the preceding claims referring to a detector system, wherein the at feast one beacon device is adapted to be at least one of directly or indirectly attached to the user and held by the user, wherein the human-machine interface is designed to determine at least one position of the user by means of the detector system, wherein the human-machine interface is designed to assign to the position at least one item of information.

### Embodiment 59

An entertainment device for carrying out at least one entertainment function, wherein the entertainment device comprises at least one human-machine interface according to the preceding embodiment, wherein the entertainment device is designed to enable at least one item of information to be input by a player by means of the human-machine interface, wherein the entertainment device is designed to vary the entertainment function in accordance with the information.

### Embodiment 60

A tracking system for tracking a position of at least one movable object, the tracking system comprising at least one optical detector according to any one of the preceding embodiments referring to an optical detector and/or at least one detector system according to any of the preceding claims referring to a detector system, the tracking system further comprising at least one track controller, wherein the track controller is adapted to track a series of positions of the object at specific points in time.

### Embodiment 61

A camera for imaging at least one object, the camera comprising at least one optical detector according to any one of the preceding embodiments referring to an optical detector.

### Embodiment 62

A method of optical detection, specifically for determining a position of at least one object, the method comprising the following steps:
detecting at least one light beam by using at least one optical sensor and generating at least one sensor signal, wherein the optical sensor has at least one sensor region, wherein the sensor signal of the optical sensor is dependent on an illumination of the sensor region by the light beam, wherein the sensor signal, given the same total power of the illumination, is dependent on a width of the light beam in the sensor region;
modifying a focal position of the light beam in a controlled fashion by using at least one focus-tunable lens located in a beam path of the light beam;
providing at least one focus-modulating signal to the focus-tunable lens by using at least one focus-modulation device, thereby modulating the focal position;
recording at least one image by using at least one imaging device; and
evaluating the sensor signal by using at least one evaluation device and, depending on the sensor signal, effecting a recording of the image by the imaging device.

### Embodiment 63

The method according to the preceding embodiment, wherein providing the focus-modulating signal comprises providing a periodic focus-modulating signal, preferably a sinusoidal signal, a square signal, or a triangular signal.

### Embodiment 64

The method according to any one of the preceding method embodiments, wherein evaluating the sensor signal comprises detecting one or both of local maxima or local minima in the sensor signal.

### Embodiment 65

The method according to the preceding method embodiment, wherein evaluating the sensor signal further comprises providing at least one item of information on a longitudinal position of at least one object from which the light beam propagates towards the optical detector by evaluating one or both of the local maxima or local minima.

### Embodiment 66

The method according to any one of the preceding method embodiments, wherein evaluating the sensor signal further comprises performing a phase-sensitive evaluation of the sensor signal.

### Embodiment 67

The method according to the preceding method embodiment, wherein the phase-sensitive evaluation comprises one or both of determining a position of one or both of local maxima or local minima in the sensor signal or a lock-in detection.

### Embodiment 68

The method according to any one of the preceding method embodiments, wherein evaluating the sensor signal further comprises generating at least one item of information on a longitudinal position of at least one object from which the light beam propagates towards the optical detector by evaluating the sensor signal.

### Embodiment 69

The method according to the preceding method embodiment, wherein generating the at least one item of information on the longitudinal position of the at least one object makes use of a predetermined or determinable relationship between the longitudinal position and the sensor signal.

### Embodiment 70

The method according to any one of the preceding method embodiments, wherein the method further comprises generating at least one transversal sensor signal by using at least one transversal optical sensor, the transversal optical sensor being adapted to determine a transversal position of the light beam, the transversal position being a position in at least one dimension perpendicular to an optical axis of the detector, wherein the method further comprises generating at least one item of information on a transversal position of the object by evaluating the transversal sensor signal.

### Embodiment 71

The method according to any one of the preceding method embodiments, wherein the method comprises using the optical detector according to any one of the preceding embodiments referring to an optical detector.

### Embodiment 72

A use of the optical detector according to any one of the preceding embodiments relating to an optical detector, for a purpose of use, selected from the group consisting of: a position measurement in traffic technology; an entertainment application; a security application; a human-machine interface application; a tracking application; a photography application; an imaging application or camera application; a mapping application for generating maps of at least one space; a mobile application; a webcam; a computer peripheral device; a gaming application; a camera or video application; a security application; a surveillance application; an automotive application; a transport application; a medical application; a sports application; a machine vision application; a vehicle application; an airplane application; a ship application; a spacecraft application; a building application; a construction application; a cartography application; a manufacturing application; a quality control application; a use in combination with at least one time-of-flight detector; an application in a local positioning system; an application in a global positioning system; an application in a landmark-based positioning system; an application in an indoor navigation system; an application in an outdoor navigation system; an application in a household application; a robot application; an application in an automatic door opener; an application in a light communication system.

### BRIEF DESCRIPTION OF THE FIGURES

Further optional details and features of the invention are evident from the description of preferred exemplary embodiments which follows in conjunction with the dependent claims. In this context, the particular features may be implemented alone or in any reasonable combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

In the Figures:

FIG. 1 shows a first embodiment of an optical detector according to the present invention, comprising a focus-tunable lens and an optical sensor which, simultaneously, constitutes an imaging device;

FIG. 2 shows an exemplary embodiment of a modulation of a focal length of the focus tunable-lens and a corresponding sensor signal of one of the optical sensors in the embodiment shown in FIG. 1;

FIG. 3 shows a further embodiment of an optical detector and a camera according to the present invention, comprising a focus-tunable lens, an optical sensor, a beam-splitting device and a separate imaging device;

FIG. 4 shows a preferred embodiment of a hybrid sensor comprising an optical sensor and an image sensor according to the present invention;

FIG. 5 shows a particular embodiment according to the present invention, wherein an electrical connection to a sensor pixel of the optical sensor is provided by a top contact of an image pixel of the image sensor; and

FIG. 6 shows an exemplary embodiment of an optical detector, a detector system, a human-machine interface, an entertainment device, a tracking system and a camera according to the present invention.

### EXEMPLARY EMBODIMENTS

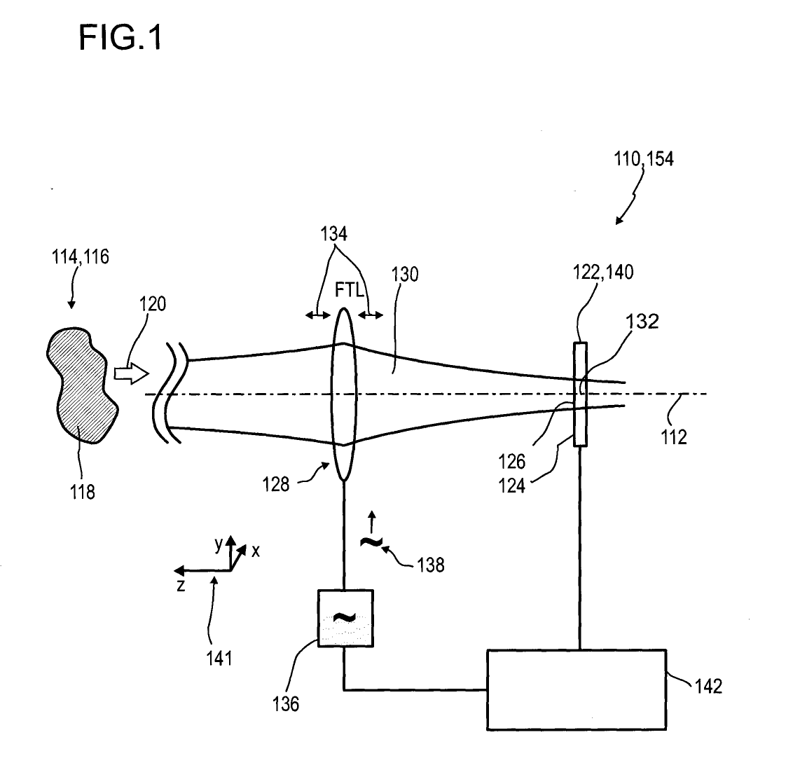

In FIG. 1, a first exemplary embodiment of an optical detector 110 according to the present invention is shown in a highly schematic cross sectional view, in a plane parallel to an optical axis 112 of the optical detector 110. The optical detector 110 may be used for detecting a scene 114 or a part thereof, wherein the scene 114 refers to a surrounding 116 of the optical detector 110, wherein an image of the scene 114 or the part thereof may be taken. The at least one image of the scene 114 or the part thereof may comprise a single image or a progressive sequence of images, such as a video or video clip. In this particular example, the scene simply comprises an object 118. The object 118 may be adapted for emitting and/or for reflecting one or more light beams 120 towards the optical detector 110.

The optical detector 110 comprises at least one optical sensor 122, which is embodied as a FiP sensor, i.e. as optical sensor 122 has a sensor region 124 which may be illuminated by the light beam 120, thereby creating a light spot 126 in the sensor region 124. The FiP sensor 122 is further adapted to generate at least one sensor signal, wherein the sensor signal, given the same total power of illumination, is dependent on the width of the light beam 120, such as on the diameter or The equivalent diameter of the light spot 126, in the sensor region 124.

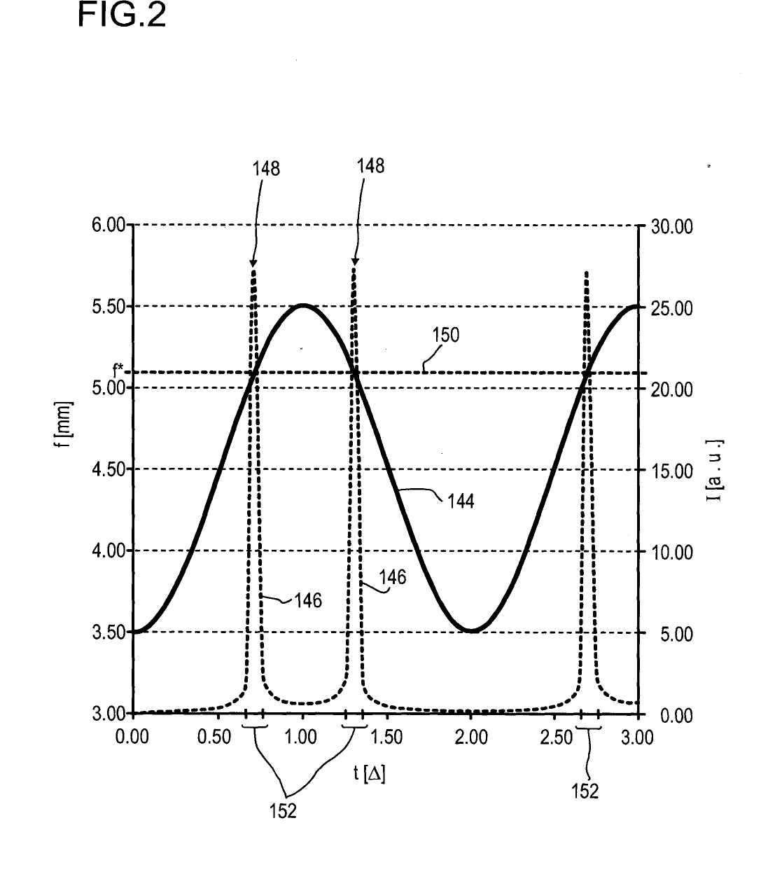

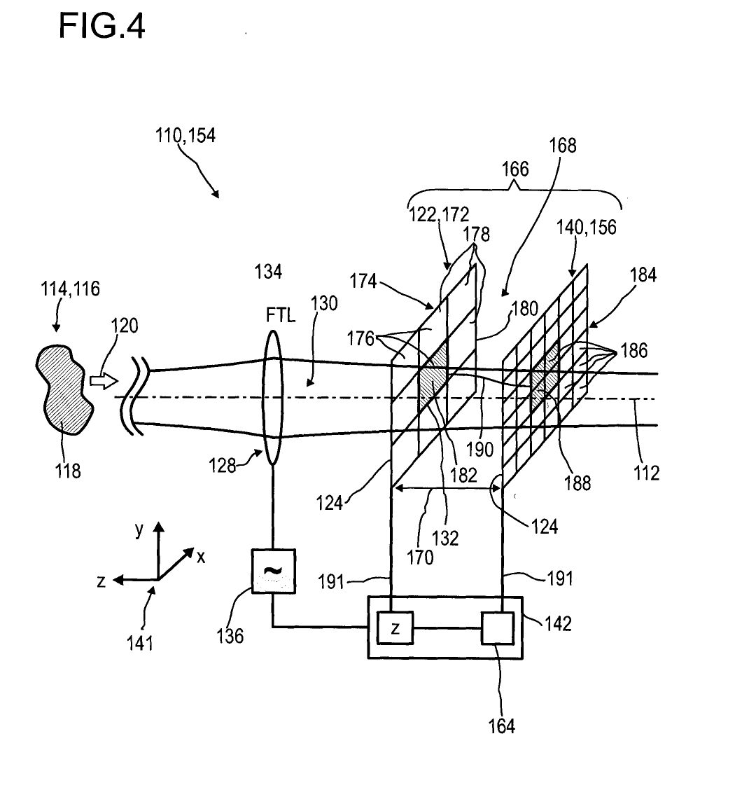

For further details regarding potential setups of the HP sensor 122, reference may be made to e.g. WO 2012/110924 A1 or US 2012/0206336 A1, e.g. to the embodiment shown in FIG. 2 and the corresponding description, and/or to WO 2014/097181 A1 or US 2014/0291480 A1, e.g. the longitudinal optical sensor shown in FIGS. 4A to 4C and the corresponding description. It shall be noted, however, that other embodiments of the optical sensor 122, specifically the FiP sensor, are feasible, such as by using one or more of the embodiments described in detail above.

The optical detector 110 further comprises at least one focus-tunable lens 128, also referred to as an FTL, located in a beam path 130 of the light beam 120, such that, preferably, the light beam 120 passes the focus-tunable lens 128 before reaching the at least one optical sensor 122. Herein, the focus-tunable lens 128 is adapted to modify a focal position 132 of the light beam 120, i.e. is adapted to change its own focal length, in a controlled fashion. The focal length modulation, in the exemplary embodiment shown in FIG. 1, is symbolically depicted by reference number 134. As an example, at least one commercially available focus-tunable lens 128 may be used, such as at least one electrically tunable lens. It shall be noted, however, that other types of focus-tunable lenses 128 may be used in addition or alternatively.

The optical detector 110 further comprises at least one focus-modulation device 136 connected to the at least one focus-tunable lens 128. The at least one focus-modulation device 136 is adapted to provide at least one focus-modulating signal, in FIG. 1 symbolically depicted by reference number 138, to the at least one focus-tunable lens 130. The focus-modulation device 136 may be a unit being separate from the focus-tunable lens 128 and/or may fully or partially be integrated into the focus-tunable lens 128. As an example, the focus-modulating signal 138, which preferably may be an electric signal, may be a periodic signal, more preferably a sinusoidal or rectangular periodic signal. The signal transmission to the focus-tunable lens 128 may take place in a wire-bound or even in a wireless fashion. As an example, the focus-modulation device 136 may be or may comprise a signal generator, such as an electronic oscillator generating an electronic signal, such as a periodic signal. In addition, one or more amplifiers may be present in order to amplify the focus-modulating signal 136.

The optical detector 110 further comprises at least one imaging device 140 which is adapted to record an image as captured by the optical detector 110. Generally, the imaging device 140 refers to an arbitrary device comprising at least one light-sensitive element which may be time and/or spatially resolving and, thus, adapted to record spatially resolved optical information, in one, two, or three dimensions. In the particular example as schematically depicted in FIG. 1, the optical sensor 122 is used in a manner that the optical sensor 122 actually constitutes the imaging device 140, i.e. that the imaging device 140 is identical with the optical sensor 122.

Since the optical sensor 122, as already described above, generates the sensor signal which is, given the same total power of illumination, dependent on the width of the light beam 120, such as on the diameter or the equivalent diameter of the light spot 126, in the sensor region 124, the sensor signal of the optical sensor 122 may be employed here as a value of an optical quantity to be used for the imaging device 140 in order to obtain the image in a space-resolved manner, i.e. with regard to at least one spatial coordinate, preferably to two or three spatial coordinates. Thus, for example, a coordinate system 142 may be used, as symbolically depicted in FIG. 1, with a z-axis parallel to the optical axis 112 of the optical detector 110.

In this particular example, the optical sensor 122 which exhibits the above-described FiP-effect may be developed in different manners. In a first alternative, the sensor region 124 of optical sensor 122 may, preferably, be a uniform sensor surface such that the optical sensor 122 may also be denominated a “large-area optical sensor”. As a result, in this particular embodiment the imaging device 140 may only be able to provide the image in a space-resolved manner with respect to one spatial coordinate, which here is the depth of the scene 114.

However, in order to provide the image in a space-resolved manner with respect to more than one spatial coordinate, which here is at least one transversal coordinate in addition to the depth of the scene 114, in a second alternative, the optical sensor 122 which is used as the imaging device 140 may be a combined optical sensor, wherein the combined optical sensor comprises both a longitudinal optical sensor which exhibits the FiP effect and a transversal optical sensor which is adapted to record at least one transversal coordinate with regard to the image. For further details regarding potential setups of the combined optical sensor, reference may be made, for example, to WO 2014/097181 A1 or to the so far unpublished European patent application number 14172520.0 dated Jun. 16, 2014. Herein, the optical sensor 122 is designed as a photo detector which has a uniform sensor surface and at least one pair of electrodes, wherein at least one of the electrodes, preferably, is a split electrode comprising at least two partial electrodes. Accordingly, a corresponding transversal sensor signal is generated in accordance with the electrical currents through the partial electrodes, wherein the information on the transversal position is, preferably, derived from at least one ratio of the currents through the partial electrodes. Thus, the optical sensor 122 is adapted to provide both planar information in combination with depth information wherein both kinds of information simultaneously regard to the recorded scene 114 or the recorded part thereof.

The optical detector 110 further comprises at least one evaluation device 142. The evaluation device 142, as an example, may be connected to the at least one optical sensor 122, in order to receive sensor signals from the at least one optical sensor 122. As described above, the sensor signals as received from the optical sensor 122 comprise longitudinal optical sensor signals but may, depending on the setup of the optical sensor 122, further comprise transversal sensor signals. As depicted in FIG. 1, the evaluation device 142 may, additionally, be connected to the at least one focus-modulation device 136, which may be fully or partially be integrated into the focus-tunable lens 128. Alternatively or in addition, the focus-modulation device 136 may fully or partially be integrated into the evaluation device 142. As an example, the evaluation device 142 may comprise one or more computers, such as one or more processors, and/or one or more application-specific integrated circuits (ASICs).

In general, as disclosed e.g. In one or more of WO 2012/110924 A1, US 2012/0206336 A1, WO 2014/097181 A1 or US 2014/0291480 A1, the setup as shown in FIG. 1, at least one item of information on a longitudinal position of the scene 114 or a part thereof may be determined. By evaluating the sensor signals of the at least one optical sensor 122, a longitudinal coordinate of the scene 114, such as a z-coordinate, may be determined. For this purpose, a known or determinable relationship between the at least one sensor signal and the z-coordinate may be used. For exemplary embodiments, reference may be made to the above-mentioned prior art documents. Further, by employing more than one optical sensor 122 in form of a stack, ambiguities in the evaluation of the sensor signals may be resolved. Furthermore, by using a combined optical sensor, the x-coordinate and y-coordinates with regard to the recorded scene 114 or the recorded part thereof may also be determined.

Still, this setup imposes some technical challenges, specifically with regard to the setup of the optical design and with regard to the evaluation of the sensor signals. By modulating the focal length of the at least one focus-tunable lens 128, a significant improvement in the precision of the measurement and a significant reduction of the complexity of the optical set up of the optical sensor 110 may be achieved. Thus, as outlined e.g. In one or more of the above-mentioned prior art documents WO 2012/110924 A1, US 2012/0206336 A1, WO 2014/097181 A1 or US 2014/0291480 A1, a FiP-sensor can inherently determine whether an object is in focus or not. When changing the focal length of the FTL 128, a FiP-sensor shows a local maximum and/or a local minimum in the FiP current, whenever an object is in focus. This effect is shown in FIG. 2. Therein, on the horizontal axis, the time is given in seconds. On the left vertical axis, the focal length f of the at least one focus-tunable lens 128 is given in millimeters, wherein the graph of the focal length is denoted by reference number 144. On the right vertical axis, an exemplary sensor signal of the optical sensor 122 in the setup of FIG. 1 is shown, denoted by I, given in arbitrary units (a.u.). The corresponding curve is denoted by reference number 146. The focal length 146 is oscillating periodically so that the focus is changed from a minimum focal length (in this exemplary embodiment 3.50 mm, other minimum focal lengths may be used) to a maximum focal length (in this exemplary embodiment 5.50 mm, other maximum focal lengths may be used) and back. As an example, a sinusoidal change of the focal length may be used, which turned out to be an efficient type of a signal for modulating the focal length. It shall be noted, however, that other types of signals, preferably periodic signals, may be used for modulating the focal length. By changing the amplitude and the offset of the focus, different focus levels can be analyzed. For example, an object in the front can be analyzed in detail using a short focal length, while an object in the back of a scene captured by the optical detector 110 may be analyzed, such as simultaneously.

As can be seen in the curves in FIG. 2, sensor signal 146 may exhibit a sharp maximum 148 whenever the scene 114 or a part thereof from which the light beam 120 emerges is in focus with the FiP sensor 122 generating the sensor signal 146. These sharp maxima 148 always occur at a specific focal length which, in FIG. 2, is denoted by reference number 150 which indicates an object-in-focus-line.

Consequently, the modulation shown in FIG. 2 provides a fast and efficient way of determining the maxima 148 in the sensor signal 146. By analyzing the sensor signal 146, the position of the maxima 148 (or, in a similar set up, of corresponding minima) may be determined. Consequently, the evaluation device 142 may be adapted to determine at least one longitudinal coordinate of the recorded scene 114 or the respective part thereof. It shall be noted, however, that other correlations between the sensor signal 146 and the at feast one item of information regarding the longitudinal coordinate the recorded scene 114 or the respective part thereof may be used. Summarizing, however, the at least one optical sensor 122 may function as a longitudinal optical sensor, and may be used for determining at least one item of information on a longitudinal position of the scene 114.

The advantages of the setup as shown in FIG. 1 as compared to setups using lenses having a fixed focal length are evident. Thus, as can be seen in the curves in FIG. 2, the maxima in the sensor signal 146 are rather sharp. Consequently, when using a stack of optical sensors 122, as described elsewhere, the distance between the optical sensors 122 has to be rather low in order to achieve a high resolution and in order to prove a resolution of the distance measurement. With the modulating setup shown in FIG. 1, contrarily, these technical constraints are lowered, and the at least one optical sensor 122 may be spaced further apart. As show in FIG. 1, even a single optical sensor 122 is sufficient, since, by using the focus-tunable lens 128, the optical sensor 122 can always be brought in focus during the focus-modulation, at least within a certain range of distances of the scene 114. Consequently, the at least one focus-tunable lens 128, which may be a single focus-tunable lens or at least one focus-tunable lens being comprised in a more complex setup of optical lenses, significantly may reduce the complexity of the optical system of the optical detector 110.

Based on this particular background, the evaluation device 142 which is, as described above, adapted to evaluate the sensor signal is, according to the present invention, further adapted to trigger a recording of the image by the imaging device depending on a value of the evaluated sensor signal. In particular, the evaluation device 142 may, thus, be adapted to evaluate the sensor signal in a manner that the recording of the image by the imaging device 140 is effected as long as the value of the sensor signal indicates that the focal position 132 of the light beam 120 coincides with the location of the imaging device 140, such as that the image may only be recorded by the imaging device 140 in a time interval 152 in which the evaluation device 142 has determined that the scene 114 to be recorded or the respective part thereof is in the focal point 128 or within a tolerance range with respect to the focal point 128. Using this kind of evaluation device 142 in combination with the focus-tunable lens 128 and the FiP sensor 122, a flexible focus camera 154 can be provided, which may be configured to record an image wherein all the objects 118 in the scene 114 are in focus independent of their respective focal points 128.

The setup of the optical detector 110 shown in FIG. 1 may be modified and/or improved in various ways. Thus, the components of the optical detector 110 may fully or partially be integrated into one or more housings which are not shown in FIG. 1. As an example, the at least one focus-tunable lens 128 and the one or more optical sensors 122 may be integrated into a tubular housing. Further, the focus-modulation device 136, the imaging device 140 and/or the evaluation device 142 may also fully or partially be integrated into the same or a different housing. Further, as outlined above, the at least one optical detector 110 may comprise additional optical components and/or may, additionally, comprise optical sensors which may or may not exhibit the above-mentioned FiP effect. As will be outlined in further detail below, one or separate imaging devices 140 may be integrated which may, preferably, be distinct from the optical sensor 122, such as one or more image sensors, preferably a CCD device or a CMOS device, or which may constitute a hybrid sensor. Further, the setup shown in FIG. 1 is a linear setup of the beam path 130. It shall be noted, however, that other setups are feasible, such as setups with a bent optical path, comprising one or more reflective elements and/or setups in which the beam path 130 is split into two or more partial beam paths, such as by using one or more beam-splitting elements. Various other modifications which do not deviate from the general principle shown in FIG. 1 are feasible.

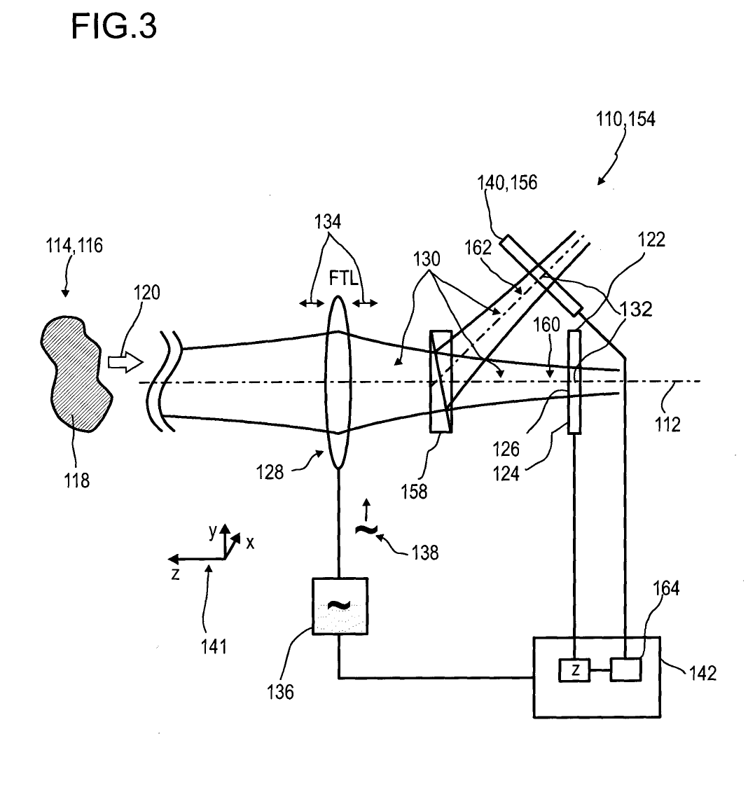

In FIG. 3, a further embodiment of the optical detector 110 is shown in a similar view like in FIG. 1, wherein the optical detector 110 comprises a modified setup comprising modifications of the embodiment in FIG. 1, which may be realized in an isolated fashion or in combination. The optical detector 110 may be embodied as a camera 154, as in the embodiment shown in FIG. 1, or may be part of a camera 154. Again, as in FIG. 1, the optical detector 110 comprises the optical sensor 122 exhibiting the above-mentioned FiP effect, wherein the optical sensor 122, as in FIG. 1, may be used as the device for determining when the scene 114 to be recorded or the respective part thereof, such as the object 118, may be in focus. For the details of the optical detector 110 concerning these properties reference might be made to FIGS. 1 and 2 as well as the corresponding description.

In addition, the optical detector 110 as shown in FIG. 3 may comprise one or more imaging devices 140 which may, preferably, be distinct from the optical sensor 122. As an example, as shown in FIG. 3, the at least one imaging device 140 may be or may comprise at least one image sensor 156, preferably a CCD device or a CMOS device. However, since the optical sensor 122 is already located at the focal position 128 within the beam path 130, the image can, strictly speaking, only be recorded in focus in a case when either the optical sensor 122 itself, as presented in FIG. 1, constitutes the imaging device 140 or when more than one equivalent focal points 128 may be available within the beam path 130. As schematically depicted in FIG. 3, the latter condition may be realized by providing one or more beam-splitting elements 158 which may be placed in the beam path 130. In particular, the beam-splitting element 158 may allow splitting the light beam 130, preferably after traversing the focus-tunable lens 128, into a branched setup comprising at least two separate partial beam paths 160, 162, as exemplary shown in FIG. 3. Generally, however, more than two partial beam paths 160, 162 may be possible by using one or more than one beam-splitting elements 158. By this kind of branched setup, more than one equivalent focal point 128 may be available within the optical detector 110 within the separate partial beam paths 160, 162. Consequently, the respective focal points 128 as generated by using the beam-splitting element 158 may, thus, independently be occupied by the at least one optical sensor 122 and the at least one imaging device 140. As illustrated in FIG. 3, after traversing the focus-tunable lens 128 the light beam 120 impinges on the beam splitter 158 which creates two separate partial beam paths 160, 162, wherein the optical sensor 122 is located on a first partial beam path 160 while the imaging device 140 is be placed on a second partial beam path 162.

Preferably, as depicted in FIG. 3, both the optical sensor 122 and the imaging device 140 may have a connection to the evaluation device 142. Herein, the connection for one or both devices may be wire-bound or wire-less. Thus, as soon as the evaluation device 142 may determine that the sensor signal as provided by the optical sensor 122 may indicate that the object 118 may be in focus, the evaluation device 142 itself or an intermediate device which may be configured to receive instructions from the evaluation device 142 and to forward such instructions to the imaging device 140 may trigger the imaging device 140 to record at least one image of the object 118, such as within the respective time interval 152 in which the object 118 is in the focal point 128 or within a tolerance range with respect to the focal point 128, such as within the depth of field (DOF).

Thus, the exemplary setup as illustrated in FIG. 3 may allow recording one or more images of the object 118 always being in focus. Within this regard, the imaging device 140 may generate one or more images or even a sequence of images, such as a video clip, of a scene 114 captured by the optical detector 110. The image may, as an example, be evaluated by at least one optional image evaluation device 164 which may be part of the evaluation device 140, or, alternatively, which may be embodied as a separate device (not depicted here). The image evaluation device 164, as an example, may comprise a storage device for storing images generated by the imaging device 140. Additionally or alternatively, however, image evaluation device 164 may also be embodied to perform an image analysis and/or an image processing, such as a filtering and/or a detection of certain features within the image. Thus, as an example, a pattern recognition algorithm may be embodied in the image evaluation device 164 and/or any type of device for object recognition. The image evaluation device 164 may, again, be fully or partially integrated with one or more of devices and/or may fully or partially be embodied as a software component, having one or more software-encoded processing steps. The information generated by the image evaluation device 164 may be combined with other information generated by the evaluation device 142, such as the depth information as derived from the sensor signal as provided by the optical sensor 122.

As mentioned above, the setup of the optical detector 110 as shown in FIGS. 1 and 3 may further be modified and/or improved by using different assemblies, in particular with regard to the selection and arrangement of the optical sensor 122 and/or and the imaging device 140. Preferably, one or more transversal optical sensors (not depicted here) may, additionally, be present in the beam path 130, in particular in one of the partial beam paths 160, 162, particularly in order to determine one or more transversal components of the object 118 within the scene 114.

Alternatively or in addition, the optical sensor 122 and the image sensor 156 may constitute a hybrid sensor 166, wherein the hybrid sensor 166 might, particularly, represent an assembly which may simultaneously comprise one or more optical sensors 122, in particular one or more FiP sensors as described above, and one or more inorganic image sensors 156, in particular one or more CCD devices or one or more CMOS devices. Herein, the optical sensor 122 may be used for the purpose as described above, particularly in order to determine the focal position, while the image sensor 156 may be employed as the imaging device.

As schematically depicted in FIG. 4, the hybrid sensor 166 may comprise a spatial arrangement wherein the optical sensor 122 might be located in a direct vicinity of the image sensor 156, i.e. no further optical element may be placed in a volume 168 which may emerge between the optical sensor 122 and the image sensor 156, which are located in a distance 170 with respect to each other. For sake of clarity, the distance 170 between the optical sensor 122 and the image sensor 156 as shown in FIG. 4 and, thus, the volume 168 between the two different types of sensors 122, 156 is depicted in an exaggerated manner while, in practice, the distance 170 and, thus, the volume 168 is kept rather small, particularly in order to keep effort and expenses for providing contacts between the optical sensor 122 and the image sensor 156 low. Further, keeping the distance 170 between the optical sensor 122 and the image sensor 156 low, may, advantageously, result in a feature that both constituents of the hybrid device 166 may still be located within the tolerance range. Consequently, the distance 170 between the optical sensor 122, which may be in focus at the time interval 152, and the image sensor 156 which may be slightly out of focus could still be tolerated with respect to acquiring an acceptably sharp image of the object 118 in the scene 114.

As shown in FIG. 4, the optical sensor 122 and the image sensor in the hybrid sensor 166 are arranged in a stacked manner. Consequently, the incident light beam 120 first impinges on the optical sensor 122 before it attains the image sensor 156. Herein, the sensor region 124 as comprised by both the optical sensor 122 and the image sensor 156 is arranged in a manner perpendicular to the optical axis 112 of the optical detector 110. In order to provide a maximum illumination intensity in the sensor region 124 of the image sensor 156 within this particular setup of the hybrid sensor 166, the optical sensor 122 may be fully or at least partially transparent, thus allowing a maximum transmission of the illumination of the incident light beam 120 through the optical sensor 122. Such a restriction with respect to the transmission of the illumination may, however, not equally be imposed on the image sensor 156. By way of example, a single image sensor 156 as used within the hybrid sensor 166 or a last image sensor 156 in a stack of image sensors 156 as employed within the hybrid sensor 166 may, still, be intransparent. This feature may be advantageous since it may allow using a large range of materials within the respective image sensor 156.

The organic optical sensor 122 in the hybrid device 166 may, still, be a large-area optical sensor having a uniform sensor surface which comprises the sensor region 124 in the same or a similar manner like the optical sensors 122 in the exemplary setups as illustrated in FIGS. 1 and 3. However, it may rather be preferred to employ a partitioned or pixelated optical sensor 172 in the hybrid sensor 166, wherein the sensor region 124 of the pixelated optical sensor 172 may be established completely or at least partially by a pixel array 174 of separate sensor pixels 176. As schematically depicted in the simplified optical detector 110 according to FIG. 4, the array 174 of the pixelated optical sensor 172 comprises 3×3 sensor pixels 176. As already described above, the optical sensors 122 may comprise any arbitrary number of sensor pixels 176 which may be suitable or required for the respective purposes. Within this regard, it may be mentioned that the pixelated optical sensor 172 comprises marginal sensor pixels 178 at the rim 180 of the pixelated optical sensor 172 and, in a case where the array 174 may comprise at least 3×3 sensor pixels 176, at least one non-marginal sensor pixel 182 which is located apart from the rim 180 within the array 174. In order to distinguish the at least one non-marginal sensor pixel 182 from the marginal sensor pixels 178, the non-marginal sensor pixel 182 is depicted in FIG. 4 in a hatched manner.

On the other hand, the inorganic image sensor 156 as further used within the hybrid sensor 166 may, thus, comprise at least one CCD device or at least one CMOS device. In particular, the image sensor 156 may also be employed as a transversal optical sensor, which may be adapted to determine one or more transversal components of the at least one object 118 within the scene 114 in the surroundings 116 of the optical detector 110. Herein, the image sensor 156 may, generally, be shaped in form of a pixel matrix 184 of separate image pixels 186. Similar to the optical sensor 122, the image sensor 156 may comprise an arbitrary number of image pixels 186, such as a number which may especially be suitable or required for the intended purposes. Further, the matrix 184 of image pixels 186 in the image sensor 156 may, generally, comprise the same number of pixels or, preferably as shown in FIG. 4, a higher number of pixels compared to the number of pixels within the array 184 of sensor pixels 176 in the pixelated optical sensor 172. By way of example, for each sensor pixel 176 in the optical sensor 172, the pixel matrix 184 of the adjoining image sensor 156 exhibits a matrix 188 of 4×4 image pixels. However, other numbers are possible, such as 16×16 image pixels, 64×64 image pixels or more. This feature is further illustrated by a hatching of the matrix 188 in the image sensor 156, wherein the matrix 188 comprises those image pixels 186 which are located in the direct vicinity of the non-marginal sensor pixel 182 which is equally depicted in the same hatched manner in FIG. 4. For purposes of comparison, a first pixel resolution may, thus, be attributed to the image sensor 156, while a second pixel resolution may be attributed to the pixelated optical sensor 172. As can be derived from the exemplary setup in FIG. 4, the first pixel resolution, accordingly, exceeds the second pixel resolution.

As already mentioned above, the pixelated optical sensor 172 comprises the marginal sensor pixels 178 at the rim 180 of the pixelated optical sensor 122 and the non-marginal sensor pixels 182 located apart from the rim 180 within the array 174. However, since it may be preferable to directly place the pixelated optical sensor 172 on top of the image sensor 156, a problem which concerns a providing of electrical contacts to the non-marginal sensor pixels 182 within the pixel array 174 may occur. Whereas electrical contacts may directly be attached to each of the easily accessible marginal sensor pixels 178 of the pixelated optical sensor 172, the problem relating to the at least one non-marginal sensor pixel 182, i.e. the sensor pixel 182 which is not located at the readily accessible periphery of the pixelated optical sensor 172, may be solved, according to the present invention, by using an image sensor 156 which comprises one or more of the top contacts (not depicted). As shown in FIG. 4, the non-marginal sensor pixel 182 of the pixelated optical sensor 172 may, thus, be electrically connected to the top contact as provided by at least one of the image pixels 186 within the matrix 188 of the image sensor 156, which is located in the vicinity of the respective optical sensor 122. Herein, the electrical connection is, preferably, provided by using a well-known bonding technique, such as wire bonding, direct bonding, ball bonding, or adhesive bonding. However, other kinds of bonding techniques may be employed. As a result, the bonding technique generates a bond contact 190 between the respective top contact as provided by one or more of the image pixels 186 as comprised within the image sensor 156 and the adjoining non-marginal sensor pixel 182 with in the pixelated optical sensor 172.

The optical detector 110 as schematically depicted in FIG. 4 further comprises the at least one focus-tunable lens 128, the at least one focus-modulating device 136 and the at least one evaluation device 142 as already known from FIGS. 1 and 3. Herein, the at least constituents of the hybrid sensor 166, i.e. the pixelated optical sensor 172 and the image sensor 156, may comprise a connector 191 to the evaluation device 142. As above, the information as generated by the image evaluation device 164 may be combined with other information as generated by the evaluation device 142, such as the depth information as derived from the sensor signal provided by the pixelated optical sensor 172.

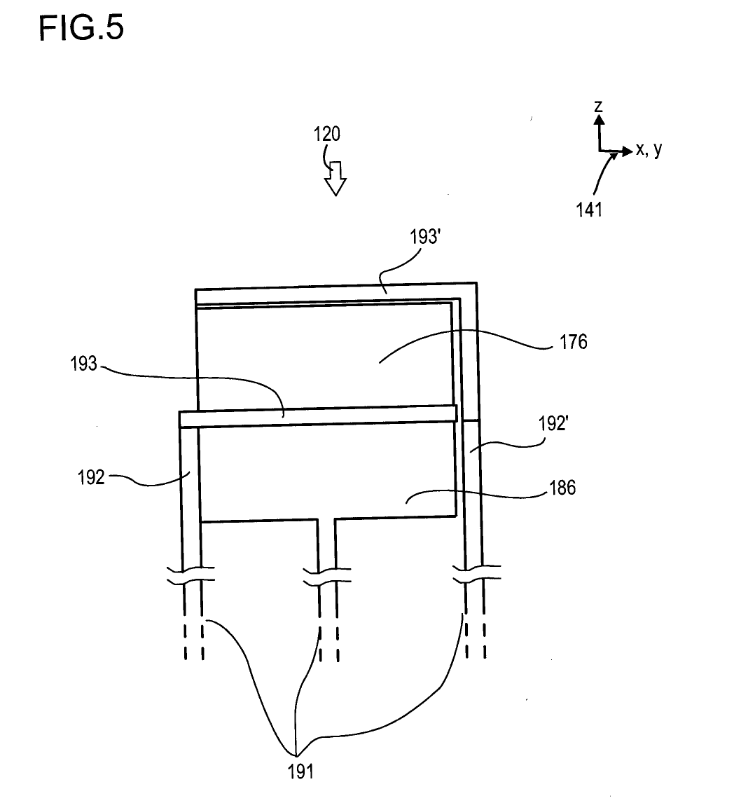

FIG. 5 shows a particular embodiment, wherein the sensor pixels 176 of the pixelated optical sensor 172 may be electrically connected to a top contact 192 as provided by one of the image pixels 186 of the image sensor 156, wherein the pixelated optical sensor 172 and the image sensor 156 are comprised within the hybrid device 166. Within this regard, it may be preferred that the top contact 192 may provide an electrical connection between one of the non-marginal sensor pixels 182 to one of the image pixels 186 as comprised within the matrix 188. However, it may, equally, be feasible to provide the electrical connection to the marginal sensor pixels 178 of the pixelated optical sensor 172 in the same manner.

As schematically depicted in FIG. 5, the exemplarily illustrated image pixel 186 of the image sensor 156 may, in this particular embodiment, comprise two individual top contacts 192, 192′ which might each be located at a side of the image pixel 186, respectively. Directly on top of the image pixel 186 with respect to a direction of the incident light beam 120 a transparent contact 186 might be placed. In this preferred example, the transparent contact 193 may constitute one of a connecting means of the exemplarily illustrated sensor pixel 176 of the pixelated optical sensor 172 while another transparent contact 193′ may be placed on top of the sensor pixel 176. By way of example, the two transparent contacts 193, 193′ as displayed here may each be connected to one of the transparent electrodes of the sensor pixel 176 which may, preferably, be located on the top and the bottom of the respective sensor pixel 176. However, other embodiments within this respect may be feasible. A shown here, each of transparent contacts 193, 193′ may be electrically connected to one of the individual top contacts 192, 192′, wherein the contacts 192, 192′ may be arranged to provide further lead to other connectors, such as to the connectors 191 between the hybrid sensor 166 and the evaluation device 142.

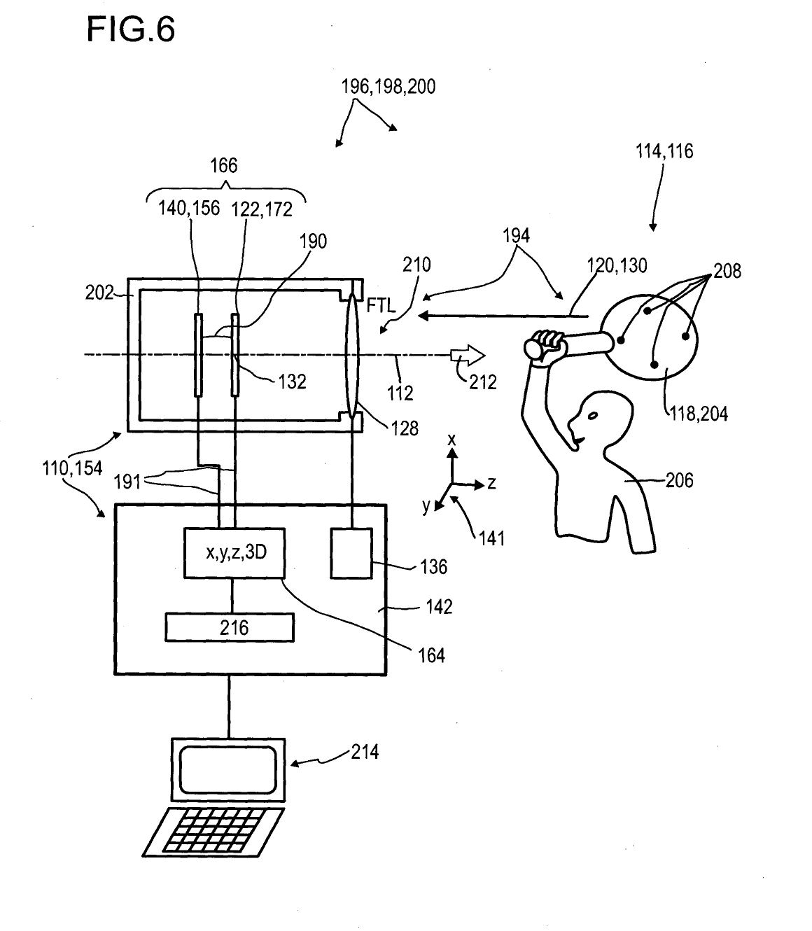

As outlined above, the optical detector 110 and the camera 154 may be used in various devices or systems. Thus, the camera 154 may be used specifically for 3D imaging, and may be made for acquiring standstill images and/or image sequences, such as digital video clips. FIG. 6, as an example, shows a detector system 194, comprising at least one optical detector 110, such as the optical detector 110 as disclosed in one or more of the embodiments shown in FIG. 1 3 or 4. Within this regard, specifically with regard to potential embodiments, reference may be made to the disclosure given above further detail. As an exemplary embodiment, a detector setup similar to the setup shown in FIG. 4 is depicted in FIG. 6. FIG. 6 further shows an exemplary embodiment of a human-machine interface 196, which comprises the at least one detector 110 and/or the at least one detector system 194, and, further, an exemplary embodiment of an entertainment device 198 comprising the human-machine interface 196. FIG. 6 further shows an embodiment of a tracking system 200 adapted for tracking a position of at least one object 118 within the scene 114 in the surroundings 116 of the optical detector 110 and/or the detector system 194.

With regard to the optical detector 110, reference may be made to the disclosure given above or given in further detail below. Basically, all potential embodiments of the detector 110 may also be embodied in the embodiment shown in FIG. 4. The evaluation device 142 may be connected to the at least one hybrid sensor 166, which comprises the at least one optical sensor 122, specifically the at least one pixelated sensor 172, which is located such that the focal position 132 of the incident light beam 120 may be modified by the focus-tunable lens 128 in a manner that the position of the optical sensor 122 may coincide with the focal position 132, and the at least one inorganic image sensor 156 which may be employed as the at least one imaging device 140. Further, again, at least one focus-modulation device 136 and at least one focus-tunable lens 128 are provided, wherein, optionally, the at least one focus-modulation device 136 may fully or partially be integrated into the evaluation device 142, as shown in FIG. 6. For connecting the above-mentioned devices, i.e. the at least one pixelated sensor 172, the at least one inorganic image sensor 156, and the at least one focus-tunable lens 128 to the at least one evaluation device 142, as an example, at least one connector 191 may be provided and/or one or more interfaces, which may be wireless interfaces and/or wire-bound interfaces. Further, connector 191 may comprise one or more drivers and/or one or more measurement devices for generating sensor signals and/or for modifying sensor signals. Further, the evaluation device 142 may fully or partially be integrated into the hybrid sensor 166 and/or into other components of the optical detector 110. The optical detector 110 may further comprise at least one housing 202 which, as an example, may encase one or more of components 172, 156 or 128. The evaluation device 142 may also be enclosed into housing 202 and/or into a separate housing.

In the exemplary embodiment shown in FIG. 6, the object 118 to be detected, as an example, may be designed as an article of sports equipment and/or may form a control element 204, the position and/or orientation of which may be manipulated by a user 206. Thus, generally, in the embodiment shown in FIG. 6 or in any other embodiment of the detector system 194, the human-machine interface 196, the entertainment device 198 or the tracking system 200, the object 118 itself may be part of the named devices and, specifically, may comprise at least one control element 204, specifically at least one control element 204 having one or more beacon devices 208 118, wherein a position and/or orientation of the control element 204 preferably may be manipulated by user 206. As an example, the object 118 may be or may comprise one or more of a bat, a racket, a club or any other article of sports equipment and/or fake sports equipment. Other types of objects 118 are possible. Further, the user 206 himself or herself may be considered as the object 118, the position of which shall be detected. As an example, the user 206 may carry one or more of the beacon devices 208 attached directly or indirectly to his or her body.

The optical detector 110 may be adapted to determine at least one item on a longitudinal position of one or more of the beacon devices 208 and, optionally, at least one item of information regarding a transversal position thereof, and/or at least one other item of information regarding the longitudinal position of the object 118 and, optionally, at feast one item of information regarding a transversal position of the object 118. Additionally, the optical detector 110 may be adapted for identifying colors and/or for imaging the object 118. An opening 210 in the housing 202, which, preferably, may be located concentrically with regard to the optical axis 112 of the detector 110, preferably defines a direction of a view 212 of the optical detector 110.

The optical detector 110 may be adapted for determining a position of the at least one object 118. Additionally, the optical detector 110, specifically has an embodiment including camera 154, may be adapted for acquiring at least one image of the object 118, preferably a 3D-image.

As outlined above, the determination of a position of the object 118 and/or a part thereof by within the scene 114 using the optical detector 110 and/or the detector system 194 may be used for providing a human-machine interface 196, in order to provide at least one item of information to a machine 214. In the embodiments schematically depicted in FIG. 6, the machine 214 may be or may comprise at least one computer and/or a computer system. Other embodiments are feasible. The evaluation device 142 may be a computer and/or may comprise a computer and/or may fully or partially be embodied as a separate device and/or may fully or partially be integrated into the machine 214, particularly the computer. The same holds true for a track controller 216 of the tracking system 200, which may fully or partially form a part of the evaluation device 142 and/or the machine 214.

Similarly, as outlined above, the human-machine interface 196 may form part of the entertainment device 198. Thus, by means of the user 206 functioning as the object 118 and/or by means of the user 206 handling the object 118 and/or the control element 204 functioning as the object 118, the user 206 may input at least one item of information, such as at least one control command, into the machine 214, particularly the computer, thereby varying the entertainment function, such as controlling the course of a computer game.

As outlined above, the optical detector 110 may have a beam path 130, wherein the beam path 130 may be a straight beam path or a tilted beam path, an angulated beam path, a branched beam path, a deflected or split beam path or other types of beam paths. Further, the light beam 120 may propagate along each beam path 130 or partial beam path once or repeatedly, unidirectionally or bidirectionally. Thereby, the components listed above or the optional further components listed in further detail below may fully or partially be located in front of the at least one hybrid sensor 166 and/or behind the at least one hybrid sensor 166 as depicted in FIG. 4 or 6.

### LIST OF REFERENCE NUMBERS

110 Optical detector
112 Optical axis
114 Scene
116 Surroundings
118 Object
120 Light beam
122 Optical sensor, FiP sensor
124 Sensor region
126 Light spot
128 Focus-tunable lens
130 Beam path
132 Focal position
134 Focal length modulation
136 Focus-modulation device
138 Focus-modulating signal
140 Imaging device
141 Coordinate System
142 Evaluation Device
144 Focal Length
146 Sensor Signal
148 Maximum
150 Object-in-focus-line
152 Time interval
154 Camera
156 Image sensor
158 Beam-splitting device, beam splitter
160 First partial beam path
162 Second partial beam path
164 Image evaluation device
166 Hybrid sensor
168 Volume
170 Distance
172 Pixelated optical sensor
174 Pixel array
176 Sensor pixel
178 Marginal sensor pixel
180 Rim
182 Non-marginal sensor pixel
184 Pixel matrix
186 Image pixel
188 Matrix.
190 Bond contact
191 Connector
192, 192′ Top contact
193, 193′ Transparent contact
194 Detector system
196 Human-machine device
198 Entertainment device
200 Tracking system
202 Housing
204 Control element
206 User
208 Beacon device
210 Opening
212 Direction of view
214 Machine
216 Track controller

1. An optical detector, comprising:
at least one optical sensor adapted to detect a light beam and to generate at least one sensor signal, wherein the optical sensor has at least one sensor region, wherein the sensor signal of the optical sensor is dependent on an illumination of the sensor region by the light beam, wherein the sensor signal, given the same total power of the illumination, is dependent on a width of the light beam in the sensor region;
at least one focus-tunable lens located in at least one beam path of the light beam, the focus-tunable lens being adapted to modify a focal position of the light beam in a controlled fashion;
at least one focus-modulation device adapted to provide at least one focus-modulating signal to the focus-tunable lens, thereby modulating the focal position;
at least one imaging device being adapted to record an image; and
at least one evaluation device, the evaluation device being adapted to evaluate the sensor signal and, depending on the sensor signal, to effect a recording of the image by the imaging device.

2. The optical detector according to claim 1, wherein the evaluation device is adapted to evaluate the sensor signal in a manner that the recording of the image by the imaging device is effected as long as the sensor signal indicates that the focal position of the light beam coincides with the location of the imaging device.

3. The optical detector according to claim 1, wherein the optical sensor is a large-area optical sensor or a pixelated optical sensor.

4. The optical detector according to claim 1, wherein the optical sensor constitutes the at least one imaging device.

5. The optical detector according to claim 1, wherein the imaging device comprises an image sensor, preferably a CCD device or a CMOS device, wherein the image sensor comprises a pixel matrix of image pixels.

6. The optical detector according to claim 5, wherein the optical sensor and the image sensor constitute a hybrid sensor, wherein the optical sensor and the image sensor in the hybrid sensor are preferably arranged in a manner that the light beam first impinges on the optical sensor before impinging on the image sensor.

7. The optical detector according to claim 6, wherein the optical sensor is a pixelated optical sensor comprising a pixel array of sensor pixels.

8. The optical detector according to claim 7, wherein the image sensor has a first pixel resolution, wherein the pixelated optical sensor has a second pixel resolution, wherein the first pixel resolution equals or exceeds the second pixel resolution.

9. The optical detector according to claim 7, wherein, for at least one of the sensor pixels, a matrix of at least 4×4 image pixels.

10. The optical detector according to claim 7, wherein at least one of the sensor pixels of the pixelated optical sensor is electrically connected to a top contact provided by at least one of the image pixels of the image sensor.

11. The optical detector according to claim 1, further comprising a beam-splitting device, wherein the beam-splitting device is adapted to divide the light beam into at least two partial beam paths.

12. The optical detector according to claim 11, wherein the optical sensor and the imaging device are located at two different partial beam paths of the light beam.

13. The optical detector according to claim 1, wherein the sensor signal of the optical sensor is further dependent on a modulation frequency of the light beam.

14. The optical detector according to claim 1, wherein the evaluation device is adapted to detect one or both of local maxima or local minima in the sensor signal, wherein the evaluation device is adapted to derive at least one item of information on a longitudinal position of at least one object from which the light beam propagates towards the optical detector by evaluating one or both of the local maxima or local minima.

15. The optical detector according to claim 1, wherein the evaluation device is adapted to perform a phase-sensitive evaluation of the sensor signal.

16. The optical detector according to claim 1, wherein the optical detector further comprises at least one transversal optical sensor, the transversal optical sensor being adapted to determine one or more of a transversal position of the light beam, a transversal position of an object from which the light beam propagates towards the optical detector or a transversal position of a light spot generated by the light beam, the transversal position being a position in at least one dimension perpendicular to an optical axis of the optical detector, the transversal optical sensor being adapted to generate at least one transversal sensor signal.

17. The optical detector according to claim 16, wherein the image sensor constitutes the transversal optical sensor.

18. A detector system for determining a position of at least one object, the detector system comprising at least one optical detector according to claim 1, the detector system further comprising at least one beacon device adapted to direct at least one light beam towards the optical detector, wherein the beacon device is at least one of attachable to the object, holdable by the object and integratable into the object.

19. A human-machine interface for exchanging at least one item of information between a user and a machine, the human-machine interface comprising at least one optical detector according to claim 1.

20. An entertainment device for carrying out at least one entertainment function, wherein the entertainment device comprises at least one human-machine interface according to claim 19, wherein the entertainment device is designed to enable at least one item of information to be input by a player by means of the human-machine interface, wherein the entertainment device is designed to vary the entertainment function in accordance with the information.

21. A tracking system for tracking a position of at least one movable object, the tracking system comprising at least one optical detector according to claim 1, the tracking system further comprising at least one track controller, wherein the track controller is adapted to track a series of positions of the object at specific points in time.

22. A scanning system for determining at least one position of at least one object, the scanning system comprising at least one detector according to claim 1, the scanning system further comprising at least one illumination source adapted to emit at least one light beam configured for an illumination of at least one dot located at at least one surface of the at least one object, wherein the scanning system is designed to generate at least one item of information about the distance between the at least one dot and the scanning system by using the at least one detector.

23. A camera for imaging at least one scene or a part thereof, the camera comprising at least one optical detector according to claim 1.

24. A method of optical detection, the method comprising the following steps:
detecting at least one light beam by using at least one optical sensor and generating at least one sensor signal, wherein the optical sensor has at least one sensor region, wherein the sensor signal of the optical sensor is dependent on an illumination of the sensor region by the light beam, wherein the sensor signal, given the same total power of the illumination, is dependent on a width of the light beam in the sensor region;
modifying a focal position of the light beam in a controlled fashion by using at least one focus-tunable lens located in a beam path of the light beam;
providing at least one focus-modulating signal to the focus-tunable lens (128) by using at least one focus-modulation device, thereby modulating the focal position;
recording at least one image by using at least one imaging device; and
evaluating the sensor signal by using at least one evaluation device and, depending on the sensor signal, effecting a recording of the image by the imaging device.

25. An article, comprising the optical detector of claim 1, wherein the article is adapted to perform a purpose selected from the group consisting of: a position measurement in traffic technology; an entertainment application; a security application; a human-machine interface application; a tracking application; a scanning application; a photography application; an imaging application or camera application; a mapping application for generating maps of at least one space; a mobile application; a webcam; a computer peripheral device; a gaming application; a camera or video application; a security application; a surveillance application; an automotive application; a transport application; a medical application; a sports application; a machine vision application; a vehicle application; an airplane application; a ship application; a spacecraft application; a building application; a construction application; a cartography application; a manufacturing application; a quality control application; a use in combination with at least one time-of-flight detector; an application in a local positioning system; an application in a global positioning system; an application in a landmark-based positioning system; an application in an indoor navigation system; an application in an outdoor navigation system; an application in a household application; a robot application; an application in an automatic door opener; and an application in a light communication system.
